(19) United States
(12) Patent Application Publication
(10) Pub. No.: US 2024/0357974 A1
(43) Pub. Date: Oct. 31, 2024

(54) FLUID-COOLED LED-BASED LIGHTING SYSTEMS HAVING INSPECTION LIGHT SYSTEMS AND METHODS FOR USING SAME

(71) Applicant: Agnetix, Inc., San Diego, CA (US)

(72) Inventors: Nicholas Maderas, Richmond, CA (US); Ihor Lys, La Jolla, CA (US)

(21) Appl. No.: 18/527,621

(22) Filed: Dec. 4, 2023

Related U.S. Application Data
(63) Continuation of application No. PCT/US2022/032392, filed on Jun. 6, 2022.
(60) Provisional application No. 63/197,261, filed on Jun. 4, 2021.

(51) Int. Cl. A01G 7/04; F21S 2/00; F21S 4/28; F21V 15/015; F21V 23/00; F21V 23/04; F21V 29/58; F21Y 113/13; F21Y 115/10

(52) U.S. Cl. CPC A01G 7/045; F21S 2/005; F21S 4/28; F21V 15/015; F21V 23/005; F21V 23/0407; F21V 23/0471; F21V 29/59; F21Y 2113/13; F21Y 2115/10

(57) ABSTRACT

A LED-based lighting fixture for Controlled Environment Horticulture (CEH) includes a module having an inspection light system to facilitate inspection of one or more plants. The inspection light system may emit inspection light to illuminate the plants during the plants' night cycle where the intensity, wavelength, and/or duration of the inspection light may be adjusted to avoid disrupting the plants' night cycle. The lighting fixture provides a mechanical interface to mount the module and an electrical interface to provide electrical power and data communication with the module. The inspection light system may be communicatively coupled to a proximity sensor that activates or deactivates the inspection light system depending on the presence of a grower near the lighting fixture. Additionally, the modules may be deployed in arrays of lighting fixtures and used to convey additional information (notifications, environmental data) to the grower by emitting light at different intensities and/or wavelengths.

### CROSS-REFERENCE TO RELATED APPLICATION(S)

The present application is a bypass continuation of International Application No. PCT/US2022/032392, filed Jun. 6, 2022, entitled “FLUID-COOLED LED-BASED LIGHTING SYSTEMS HAVING INSPECTION LIGHT SYSTEMS AND METHODS FOR USING SAME,” which claims priority to U.S. Provisional Application No. 63/197,261, filed Jun. 4, 2021, entitled “FLUID-COOLED LED-BASED LIGHTING METHODS AND APPARATUS FOR CONTROLLED ENVIRONMENT HORTICULTURE AND INSPECTION OF SAME,” each of which is incorporated by reference herein in their entirety.

### BACKGROUND

Controlled Environment Agriculture (CEA) (also referred to as controlled environment horticulture or CEH) is the process of growing plants in a controlled environment where various environmental parameters are monitored and adjusted to improve the quality and yield of the plants grown. Compared to conventional approaches of plant cultivation, CEA may enable year-round production of plants, insensitivity to variable weather conditions, reduce pests and diseases, and reduce the amount of resources consumed on a per plant basis. A controlled agricultural environment is typically enclosed, at least in part, by a building structure such as a greenhouse, a grow room, or a covered portion of a field in order to provide some degree of control over environmental conditions. One or more artificial lighting systems (also referred to as a “grow light”) are often used in such controlled agricultural environments to supplement and/or replace natural sunlight that may be obstructed by the building structure or insufficient during certain periods of the year (e.g., winter months). Various types of artificial lighting systems may be used including, but not limited to, a high intensity discharge lamp, a light emitting diode (LED), and a fluorescent lamp.

### SUMMARY

The Inventors have recognized and appreciated CEH systems have the potential to provide higher quality and higher yields of crops compared to conventional plant cultivation techniques. However, the Inventors have also recognized conventional CEH systems are typically assembled from disparate lighting, environmental control, and sensing systems, which increase in complexity particularly as the grower seeks to monitor and control more environmental conditions. As a result, conventional CEH systems are often difficult and/or cumbersome to deploy and use and frequently require the grower to purchase a variety of different equipment to operate the CEH system, thus increasing overall costs. Moreover, respective disparate components and their piecemeal integration for CEH rarely (if ever) address energy efficiency considerations.

Conventional CEH systems often include grow lights (also referred to herein as an “artificial lighting system”) to illuminate plants with photosynthetically active radiation (PAR). Depending on the plant species being cultivated, the intensity of the PAR provided by the grow lights may be varied to simulate a day cycle and a night cycle (also referred to herein as light and dark cycles). During a typical night cycle, the grow lights are deactivated and the room is generally blocked off from other light sources (e.g., light entering through a window), thus resulting in a dark environment. If a grower wants to visually inspect their plants during the night cycle, an inspection lighting system separate from the grow lights is typically used to illuminate the environment with light that is less disruptive to the plants' development.

To this end, conventional inspection lighting systems often illuminate the environment with low intensity green light (e.g., light having a wavelength between 500 nm and 550 nm) for short periods of time. Although it is well-established that green light is capable of driving photosynthesis in plants, green light at sufficiently low intensities has a low PAR value and thus may not appreciably disrupt the night cycle of the plants.

The inspection lighting system is generally purchased and installed separately from the artificial lighting system. This not only increases the overall costs and energy usage footprint of the CEH system, but also limits the integration and use of the inspection lighting system together with the artificial lighting system. For instance, conventional inspection light sources are typically configured for retrofit installations while grow lights are often standalone systems. For example, FIG. 18A shows a conventional inspection light in the form of a compact fluorescent light (CFL) bulb that is screwed into a conventional bulb socket. FIG. 18B shows another example of a conventional inspection light in the form of a T5 fluorescent light tube with a conventional 2-pin connector.

As can be seen by these examples, conventional inspection light sources are generally installed using standardized connectors, which can limit their integration with standalone grow light systems. Generally, conventional inspection lighting systems including separate housings with compatible sockets and/or connectors to provide power and/or communication. Thus, the grower needs to provide sufficient infrastructure (e.g., a rail, or shelf) and cabling to support the inspection lighting system. The inspection lighting system may also have its own communication protocols, which may limit the grower's ability to control the grow lights and the inspection lighting system using a single user interface.

In view of the foregoing challenges, the present disclosure is thus directed to various implementations of a fluid-cooled light emitting diode (LED)-based lighting fixture (also referred to hereafter as a “lighting fixture”) for CEH systems with an integrated inspection light (also referred to herein as an “inspection light system”), respective components of the lighting fixture, respective accessories (e.g., modules with an inspection light, multispectral imaging systems), and methods for using the same.

In one aspect, the lighting fixture may be coupled to a fluid cooling system (also referred to hereafter as a “coolant circuit”) that flows fluid coolant through the lighting fixture to capture heat generated by one or more LED modules in the lighting fixture. In this manner, heat generated by the lighting fixture may be removed from the controlled agricultural environment, thus reducing the cooling load and improving energy efficiency. The lighting fixture described herein may be coupled to one or more other lighting fixtures in a daisy-chain configuration where plumbing, electrical power, and communication connections are shared to facilitate the creation of a continuous electrical circuit and coolant circuit. In some implementations, the lighting fixture may be coupled to a hydronics system that utilizes waste heat generated by the lighting fixture (and extracted from the lighting fixture by the coolant circuit) for various applications such as regulating the temperature of the controlled agricultural environment or a space near the controlled agricultural environment. The lighting fixture may also function as an integrated sensor platform by providing electrical power and data communication connections to one or more sensors that may monitor various environment conditions of the controlled agricultural environment.

In one exemplary implementation, a lighting fixture includes a frame (also referred to herein as a “housing”) to mechanically support and house various components of the lighting fixture. A light spine is formed onto the frame with features to mechanically couple and secure the lighting fixture to a support structure disposed in the controlled agricultural environment. The frame includes one or more channels and corresponding coolant pipes that fit into the one or more channels. The coolant pipes are formed from copper and used to flow fluid coolant through the lighting fixture to remove heat. One or more LED modules are disposed on the frame to emit radiation at various wavelengths to stimulate the growth and development of the plants. In some implementations, the LED modules may emit radiation within one or more wavelength bands including, but not limited to, ultraviolet, visible (e.g., red, green, and/or blue), near infrared (NIR), and short-wave infrared (SWIR) radiation. For example, the LED modules may emit photosynthetically active radiation (PAR) for growing plants. In some implementations, each LED module may include arrays of LEDs that emit light at different wavelengths. For example, the LED module may include red LEDs to emit red light (e.g., 660 nm wavelength light), blue LEDS to emit blue light (e.g., 450 nm wavelength light), and/or LEDs with a phosphor configured to emit light having a color temperature ranging between 2700 K to 6000 K (e.g., a white LED that emits white light at a color temperature of 5000 K).

A processor is coupled to the frame to facilitate the operation of the lighting fixture with functions including power conversion, network connectivity, and data processing. One or more electrical power ports are disposed on the frame to supply electrical power from an external source (e.g., a building electrical supply system) to various components of the lighting fixture including the LED modules, the processor, and auxiliary devices coupled to the lighting fixture. One or more communication ports are disposed on the frame to facilitate electrical communication and data transmission.

In some implementations, a coolant pipe may be press-fit or crush-fit into a channel of a frame to improve thermal contact, thereby increasing the amount of heat removed by the fluid coolant flowing through the lighting fixture. The coolant pipe of the lighting fixture may be coupled to another coolant pipe of another lighting fixture using push-to-connecting plumbing fittings. In this manner, multiple lighting fixtures may be coupled to form a continuous coolant circuit. One or more pumps, regulators, and/or valves may be incorporated into the coolant circuit to generate and direct the fluid coolant through the coolant circuit. A heat rejection device, such as a cooling tower, may also be incorporated into the coolant circuit to remove heat from fluid coolant, thus reducing the temperature of the fluid coolant for reuse in the coolant circuit. The coolant circuit may also be used to remove heat from other components in the controlled agricultural environment, such as a dehumidifier.

In some implementations, a coolant circuit having multiple lighting fixtures may be coupled to a hydronics system to recycle waste heat generated by the lighting fixtures and captured by the fluid coolant. The hydronics system may distribute heat to regulate the temperature of at least a portion of the controlled agricultural environment (e.g., a growing area) or another space near the controlled agricultural environment (e.g., a residential building, a cogeneration plant, a factory). The hydronics system may include a fluid storage tank to store fluid coolant and one or more piping subsystems to direct relatively cool fluid coolant and relatively hot fluid coolant through the coolant circuit and/or other spaces. Fluid coolant may also be stored at various temperatures for later distribution and/or to regulate the temperature of the fluid coolant.

In some implementations, a controlled agricultural environment with one or more fluid-cooled LED-based lighting fixtures does not require additional cooling or air-conditioning. In other words, excess heat generated in the environment from a variety of heat sources (e.g., the lighting fixtures, the plants themselves, walls of a building structure constituting the environment, one or more dehumidifiers) is effectively captured by the fluid coolant and removed by a heat rejection device (e.g., a cooling tower) or recycled in a hydronics system. By significantly reducing, or in some instances eliminating, the need for air-conditioning, a significant source of required energy for the controlled agricultural environment is accordingly significantly reduced or eliminated. The energy savings may lead to substantial reductions in energy costs for controlled agricultural environments on a variable energy budget or increase the energy available to grow larger and crops and larger crop yields for controlled agricultural environments on a fixed energy budget. For example, at least a portion of the energy budget formerly used for cooling/air-conditioning may instead be used for additional artificial lighting to provide PAR and thereby promote plant growth for a greater number of plants.

In various implementations, the lighting fixture disclosed herein may include one or more communication and/or auxiliary power ports, for example, to provide auxiliary DC power to one or more auxiliary devices coupled to the port(s). Example of such ports include, but are not limited to, one or more Power over Ethernet (POE) ports and/or one or more Universal Serial Bus (USB) ports to communicatively couple multiple lighting fixtures together and/or support operation of one or more auxiliary devices (e.g., sensors, actuators, or other external electronic devices).

Examples of various sensors that may be coupled to one or more lighting fixtures via one or more of the PoE or USB ports include, but is not limited to, air temperature sensors, near-infrared (NIR) leaf moisture sensors, hyperspectral cameras, finite spectral cameras, IR leaf temperature sensors, relative humidity sensors, and carbon dioxide sensors. Other examples of auxiliary devices that may be coupled to one or more lighting fixtures via PoE or USB ports include, but are not limited to, one or more fans, security cameras, smartphones, and multi-spectral cameras (e.g., to analyze soil moisture, nutrient content, leaves of the plants). In this manner, various auxiliary devices may be particularly distributed in the controlled agricultural environment due to the flexible placement of communication ports on the lighting fixtures.

In some implementations, the lighting fixture may include a module with an inspection light system. The module may be mounted to the frame and disposed adjacent to the LED modules. The inspection light system may help the grower visually inspect the plants (e.g., in the absence of other light in the environment). The inspection light system may also be configured to provide a field of view that covers the plants and, in some instances, the surrounding infrastructure of the grow room to aid the user in navigating the environment.

The inspection light system includes one or more LED sources (sometimes referred to herein as a “LED light source”) that are configured to emit light at sufficiently low intensities and/or sufficiently short periods of time to avoid appreciably disrupting the plants' night cycle. For example, the inspection light system may only be turned on for a set amount of time to reduce undesirable effects on the plants' flowering cycle. In some implementations, the LED sources may each emit green light with a wavelength ranging between 500 nm and 550 nm or, more specifically, between 515 nm and 535 nm. More generally, the LED sources of the inspection light system may emit light in wavelengths bands including, but not limited to ultraviolet radiation (e.g., 310 nm to 400 nm, or 365 nm), blue light, green light, yellow light, orange light, red light (e.g., 660 nm), far-red radiation (e.g., 720 nm to 740 nm, or 730 nm), or any combinations of the foregoing. In some implementations, the inspection light system may include multiple LED sources that emit light at different wavelengths. For example, the LED sources may collectively (or individually) emit white light. The intensity and/or duration may be adjusted to accommodate the plants' sensitivity to different wavelengths of light. For example, LED sources that emit red light (e.g., light at a wavelength of 660 nm) may be turned on for shorter periods of time than LED sources that emit green light.

The LED sources may collectively emit light with a nominal photosynthetic photon flux (PPF) of up to approximately 7 μmol/s or equal to or less than approximately 7 μmol/s. In some implementations, each LED may operate at a forward voltage of 2.8 to 3.6 V and a driving current of 2 A. In some implementations, the module may further include an integrated dimmer circuit to modulate the output intensity of the light. For example, each LED may output light at a nominal intensity (i.e., the intensity of light when the dimmer is not active) and the dimmer may vary the output intensity from 2% of the nominal intensity to 100% of the nominal intensity.

In some implementations, the processor of the lighting fixture may be used to control one or more auxiliary devices and/or process data from the auxiliary devices. The processor may then utilize the data to adjust and control operation of one or more lighting fixtures (e.g., adjusting the PAR output from the lighting fixture) one or more coolant circuits (e.g., adjusting the fluid flow through the coolant circuit including the lighting loop, hydronics loop, and cooling loops), one or more fans, one or more dehumidifiers, or one or more air conditioners in the controlled agricultural environment. In some implementations, various environmental conditions are measured and controlled to provide target vapor pressure deficits in the environment.

In some implementations, the lighting fixture may be used in a leased lighting system where a customer pays a recurring fee to rent and operate one or more lighting fixtures. In one exemplary implementation, the lighting fixture may be communicatively coupled to a license server that controls the amount of time the lighting fixtures operates according to payments by the customer. Encryption keys and a token exchange with a license server may be used operate the leased lighting system for a controlled agricultural environment.

In sum, one example implementation is directed to a fluid-cooled LED-based lighting fixture, comprising: an extruded aluminum frame including at least a first channel, a second channel, and at least one enclosed cavity formed therein, the extruded aluminum frame further including a fin protruding from the frame and having a plurality of holes to facilitate mechanical coupling of the lighting fixture to at least one support structure; at least one LED light source mechanically supported by the extruded aluminum frame; a first copper pipe to carry a fluid coolant to extract heat generated by at least the at least one LED light source during operation of the lighting fixture, wherein the first copper pipe is press-fit into the first channel of the extruded aluminum frame so as to establish a first thermal connection between the first copper pipe and the extruded aluminum frame; a second copper pipe to carry the fluid coolant, wherein the second copper pipe is press-fit into the second channel of the extruded aluminum frame so as to establish a second thermal connection between the second copper pipe and the extruded aluminum frame; control circuitry, disposed in the at least one enclosed cavity of the extruded aluminum frame, to receive AC power and to control the at least one LED light source; and a plurality of ports, electrically coupled to at least some of the control circuitry, to provide DC power to at least one auxiliary device coupled to at least one of the plurality of ports.

Another example implementation is directed to a method for controlling an agricultural environment, the method comprising: A) flowing a fluid coolant in a coolant circuit, wherein the coolant circuit comprises: at least one LED-based lighting fixture from which the fluid coolant extracts fixture-generated heat as the fluid coolant flows in the coolant circuit through the at least one LED-based lighting fixture, and at least one hydronics loop, coupled to the at least one LED-based lighting fixture, to facilitate temperature regulation in at least a portion of the agricultural environment; B) irradiating a plurality of plants with photosynthetically active radiation (PAR) output by at least one LED-based lighting fixture; and C) sensing at least one condition in the agricultural environment via at least one sensor communicatively coupled to the at least one LED-based lighting fixture.

Another example implementation is directed to a method for controlling an agricultural environment, the method comprising: A) flowing a fluid coolant in a coolant circuit, wherein the coolant circuit comprises: at least one LED-based lighting fixture from which the fluid coolant extracts fixture-generated heat as the fluid coolant flows in the coolant circuit through the at least one LED-based lighting fixture, and at least one hydronics loop, coupled to the at least one LED-based lighting fixture, to facilitate temperature regulation in at least a portion of the agricultural environment; B) irradiating a plurality of plants with photosynthetically active radiation (PAR) output by at least one LED-based lighting fixture; C) sensing at least one condition in the agricultural environment via at least one sensor communicatively coupled to the at least one LED-based lighting fixture, wherein the at least one sensor includes least one of: an air temperature sensor; a near infrared (NIR) sensor; a relative humidity sensor; a camera; a carbon dioxide (CO2) sensor; and an infrared (IR) sensor; and D) controlling at least one of 1) the PAR output by the at least one LED lighting fixture and 2) a flow of the fluid coolant in at least one of the at least one LED lighting fixture and the hydronics loop, based at least in part on the at least one sensed condition in C), wherein: the at least one LED-based lighting fixture includes at least a first copper pipe and a second copper pipe forming at least a portion of the coolant circuit; and A) comprises flowing the fluid coolant in opposite directions in the first copper pipe and the second copper pipe, respectively.

This application incorporates by reference U.S. provisional application Ser. No. 62/550,379 filed on Aug. 25, 2017, U.S. provisional application Ser. No. 62/635,499 filed on Feb. 26, 2018, U.S. non-provisional application Ser. No. 16/114,008, filed on Aug. 27, 2018, U.S. provisional application Ser. No. 62/660,720 filed on Apr. 20, 2018, U.S. non-provisional application Ser. No. 16/390,501 filed on Apr. 22, 2019, U.S. provisional application Ser. No. 62/667,217 filed on May 4, 2018, U.S. provisional application Ser. No. 62/684,641 filed on Jun. 13, 2018, U.S. non-provisional application Ser. No. 16/404,192 filed on May 6, 2019, U.S. provisional application Ser. No. 62/760,572 filed on Nov. 13, 2018, U.S. non-provisional application Ser. No. 17/083,461 filed on Oct. 29, 2020, U.S. provisional application Ser. No. 62/946,407 filed on Dec. 10, 2019, U.S. provisional application Ser. No. 63/141,453 filed on Jan. 25, 2021, International PCT application PCT/US2020/064382 filed on Dec. 10, 2020, U.S. provisional application Ser. No. 62/947,538 filed on Dec. 12, 2019, and International PCT application PCT/US2020/064837 filed on Dec. 14, 2020.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is an illustration of a conventional controlled agricultural environment where one or more HPS lamps are used.

FIG. 2 is an illustration of a conventional controlled agricultural environment where one or more conventional LED-based lighting fixtures are used.

FIG. 3 is an illustration of a controlled agricultural environment where one or more fluid-cooled LED-based lighting fixtures are retrofit into a pre-existing environment, according to some implementations of the disclosure.

FIG. 4 is an illustration of a controlled agricultural environment where one or more fluid-cooled LED-based lighting fixtures are coupled to a hydronics system, according to some implementations of the disclosure.

FIG. 5 is a block diagram of a lighting fixture, according to some implementations of the disclosure.

FIG. 6A is a circuit diagram detailing a first half of an exemplary LED module of a lighting fixture, according to some implementations of the disclosure.

FIG. 6B is a circuit diagram detailing the second half of the exemplary LED module of FIG. 6B.

FIG. 7A shows a bottom, front perspective view of a lighting fixture, according to some implementations of the disclosure.

FIG. 7B shows front, bottom, left side, and right side views of the lighting fixture of FIG. 7A.

FIG. 7C shows a cross-sectional view of the lighting fixture of FIG. 7B along the plane A-A.

FIG. 7D-1 shows various views of a lighting fixture including one or more onboard cameras and wireless communications functionality, according to some implementations of the disclosure.

FIG. 7D-2 shows several views of the lighting fixture of FIG. 7D-1.

FIG. 7E shows a bottom, front, left perspective view of an exemplary lighting fixture with a multispectral imaging system, according to some implementations of the disclosure.

FIG. 7F shows a top, front, left perspective view of the lighting fixture of FIG. 7E.

FIG. 7G shows a bottom, rear, right perspective view of the lighting fixture of FIG. 7E.

FIG. 7H shows a top view of the lighting fixture of FIG. 7E.

FIG. 7I shows a bottom view of the lighting fixture of FIG. 7E.

FIG. 7J shows a front view of the lighting fixture of FIG. 7E.

FIG. 7K shows a rear view of the lighting fixture of FIG. 7E.

FIG. 7L shows a right view of the lighting fixture of FIG. 7E.

FIG. 7M shows a left view of the lighting fixture of FIG. 7E.

FIG. 7N shows a front cross-sectional view of the lighting fixture of FIG. 7E where the cross-section plane bisects the lighting fixture.

FIG. 7O shows a magnified view of the lighting fixture of FIG. 7N.

FIG. 7P shows a right cross-sectional view of the lighting fixture of FIG. 7E where the cross-section plane intersects the multispectral imaging system.

FIG. 7Q shows the spectral absorbance of various plant-related compounds.

FIG. 8A shows a photograph of an exemplary multispectral imaging system, according to some implementations of the disclosure.

FIG. 8B shows a top, front, left perspective view of the imaging system of FIG. 8A.

FIG. 8C shows a bottom, rear, right perspective view of the imaging system of FIG. 8A.

FIG. 8D shows a top view of the imaging system of FIG. 8A.

FIG. 8E shows a bottom view of the imaging system of FIG. 8A.

FIG. 8F shows a front view of the imaging system of FIG. 8A.

FIG. 8G shows a rear view of the imaging system of FIG. 8A.

FIG. 8H shows a right view of the imaging system of FIG. 8A.

FIG. 8I shows a left view of the imaging system of FIG. 8A.

FIG. 8J shows a top, front, left perspective view of the imaging system of FIG. 8A without the housing.

FIG. 8K shows a bottom, rear, right perspective view of the imaging system of FIG. 8I.

FIG. 8L shows a top view of the imaging system of FIG. 8I.

FIG. 8M shows a bottom view of the imaging system of FIG. 8I.

FIG. 8N shows a front view of the imaging system of FIG. 8I.

FIG. 8O shows a rear view of the imaging system of FIG. 8I.

FIG. 8P shows a right view of the imaging system of FIG. 8I.

FIG. 8Q shows a left view of the imaging system of FIG. 8I.

FIG. 9A shows a circuit diagram of a 365 nm ultraviolet (UV) light emitting diode (LED).

FIG. 9B shows a circuit diagram of a 450 nm royal blue visible LED.

FIG. 9C shows a circuit diagram of a 530 nm green visible LED.

FIG. 9D shows a circuit diagram of a 630 nm hyper red visible LED.

FIG. 9E shows a circuit diagram of a 660 nm HE photo red LED.

FIG. 9F shows a circuit diagram of a 730 nm far red LED.

FIG. 9G shows a circuit diagram of a 860 nm infrared LED.

FIG. 9H shows a circuit diagram of a 950 nm deep infrared LED.

FIG. 9I shows a circuit diagram of a first extra channel.

FIG. 9J shows a circuit diagram of a second extra channel.

FIG. 9K shows a circuit diagram of a Lepton 3.5 socket.

FIG. 9L shows a circuit diagram of an infrared thermometer.

FIG. 9M shows a circuit diagram of a VL53L1X time-of-flight proximity sensor.

FIG. 9N shows a circuit diagram of a RT8020 pulse-width-modulated (PWM) converter.

FIG. 9O-1 shows a first portion of a circuit diagram of a digital signal converter.

FIG. 9O-2 shows a second portion of the circuit diagram of FIG. 9O-1.

FIG. 10A shows a top perspective view of a first lighting fixture coupled to a second lighting fixture and a support structure, according to some implementations of the disclosure.

FIG. 10B shows a perspective view of a controlled agricultural environment showing multiple rows of fluid-cooled LED-based lighting fixtures coupled together forming a continuous electrical and coolant circuit, according to some implementations of the disclosure.

FIG. 11A shows an exemplary hydronics system including a fluid storage tank and multiple piping subsystems such as a lighting loop, a heating loop, and a cooling loop, according to some implementations of the disclosure.

FIG. 11B shows a portion of an exemplary hydronics system coupled to a lighting fixture and a growing area, according to some implementations of the disclosure.

FIG. 11C shows a controlled agricultural environment where one or more fluid-cooled LED-based lighting fixtures are disposed in a vertically-stacked multiple-level growing area and coupled to a hydronics system, according to some implementations of the disclosure.

FIG. 12 shows a side view of a controlled agricultural environment with a plurality of fluid-cooled LED-based lighting fixtures and a plurality of sensors to facilitate monitoring of environmental conditions, according to some implementation of the disclosure.

FIG. 13A is a block diagram detailing various electronics components of a processor including a control board, a network board, and a single board computer, according to some implementations of the disclosure.

FIG. 13B is a block diagram providing additional detail of the control board of FIG. 13A.

FIG. 13C is a block diagram providing additional detail of the network board of FIG. 13A.

FIG. 14A is a circuit diagram detailing various electronic components of a network board, according to some implementations of the disclosure.

FIG. 14B is an expanded view of the Ethernet switch of FIG. 14A.

FIG. 14C is an expanded view of the PoE port of FIG. 14A.

FIG. 14D is a circuit diagram of the PoE controller of FIG. 14A.

FIG. 15 is a circuit diagram of a single board computer, according to some implementations of the disclosure.

FIG. 16A is a circuit diagram detailing various electrical components of a control board, according to some implementations of the disclosure.

FIG. 16B is a circuit diagram detailing the bias and control power supply of the control board of FIG. 16A.

FIG. 16C is a circuit diagram detailing the DC-DC converter of the control board of FIG. 16A.

FIG. 16D is a circuit diagram detailing the AC line sensor of the control board of FIG. 16A.

FIG. 16E is a circuit diagram detailing the DSP of the control board of FIG. 16A.

FIG. 16F is a circuit diagram detailing the temperature sensor circuitry of the control board of FIG. 16A.

FIG. 16G is a circuit diagram detailing the boost circuit of the control board of FIG. 16A.

FIG. 16H is a circuit diagram further detailing the boost circuit of FIG. 16G.

FIG. 17A is a flow diagram of a contract enforcement method, according to some implementations of the disclosure.

FIG. 17B is a flow diagram of a method to update a license in a leased lighting system, according to some implementations of the disclosure.

FIG. 18A shows a conventional inspection light source in the form of a CFL bulb.

FIG. 18B shows a conventional inspection light source in the form of a T5 fluorescent light tube.

FIG. 19A shows a bottom view of a lighting fixture and an exemplary module installed on the lighting fixture with an inspection light, according to some implementations of the disclosure.

FIG. 19B shows a magnified bottom view of the module of FIG. 19A.

FIG. 20A shows a top perspective view of a circuit board in the module of FIG. 19A.

FIG. 20B shows a bottom perspective view of the circuit board of FIG. 20A.

FIG. 20C shows a top view of the circuit board of FIG. 20A.

FIG. 20D shows a bottom view of the circuit board of FIG. 20A.

FIG. 20E shows a front view of the circuit board of FIG. 20A.

FIG. 21A shows a bottom view of a lighting fixture and another exemplary module installed on the lighting fixture with an inspection light, according to some implementations of the disclosure.

FIG. 21B shows a magnified bottom view of the module of FIG. 21A.

FIG. 22A shows a top perspective view of a circuit board in the module of FIG. 21A.

FIG. 22B shows a bottom perspective view of the circuit board of FIG. 22A.

FIG. 22C shows a top view of the circuit board of FIG. 22A.

FIG. 22D shows a bottom view of the circuit board of FIG. 22A.

FIG. 22E shows a front view of the circuit board of FIG. 22A.

FIG. 23A shows a perspective view of an exemplary CEH system deployed in an environment where each lighting fixture includes a module with an inspection light and the light fixtures are communicatively coupled to a local computing device with an HMI to monitor and control the lighting fixtures.

FIG. 23B shows a perspective view of the CEH system of FIG. 23A where the inspection lights are turned on or off and the output intensity of the inspection light is varied to communicate various conditions to the grower.

FIG. 23C shows an exemplary heat map of the lighting fixtures in the CEH system of FIG. 23B and the conditions corresponding to different output intensities of the inspection light.

FIG. 23D shows a perspective view of the CEH system of FIG. 23A where the inspection lights are turned on or off and the color of the inspection light is varied to communicate various conditions to the grower.

FIG. 23E shows an exemplary heat map of the lighting fixtures in the CEH system of FIG. 23D and the conditions corresponding to different colors of the inspection light.

FIG. 24A shows an exemplary system block diagram of the lighting fixture and the module of either FIG. 19A or 20A.

FIG. 24B shows another exemplary system block diagram of the lighting fixture and the module of either FIG. 19A or 20A with a Universal Protocol Converter (UPC) to control the operation of the LED modules in the lighting fixture and the module.

FIG. 24C shows another exemplary system block diagram of the lighting fixture and the module of either FIG. 19A or 20A with a network board to communicatively couple various components of the lighting fixture and the module together.

FIG. 24D shows another exemplary system block diagram of the lighting fixture and the module of either FIG. 19A or 20A.

FIG. 25A shows a first portion of a circuit diagram corresponding to the module of either FIG. 19A or 20A with the inspection light.

FIG. 25B shows a second portion of the circuit diagram of FIG. 25A.

### DETAILED DESCRIPTION

Following below are more detailed descriptions of various concepts related to, and implementations of, fluid-cooled LED-based lighting methods and apparatus for controlled environment agriculture (also referred to herein as “controlled environment horticulture” or CEH). It should be appreciated that various concepts introduced above and discussed in greater detail below may be implemented in numerous ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive lighting fixtures and modules (e.g., multispectral imaging systems, inspection light systems) are provided, wherein a given example or set of examples showcases one or more particular features of a lighting fixture, cooling system, sensors, and an agricultural system deploying one or more lighting fixtures. It should be appreciated that one or more features discussed in connection with a given example of a frame, LED module, coolant pipe, wireless device, camera, and/or sensor may be employed in other examples of a lighting fixture according to the present disclosure, such that the various features disclosed herein may be readily combined in a given system according to the present disclosure (provided that respective features are not mutually inconsistent).

### Controlled Environment Agriculture

Controlled Environment Agriculture (CEA) (also referred to as controlled environment horticulture or CEH) is the process of growing plants in a controlled environment where various environmental parameters, such as lighting, temperature, humidity, nutrient levels, and carbon dioxide (CO₂) concentrations are monitored and adjusted to improve the quality and yield of the plants. Compared to conventional approaches of plant cultivation, CEA may enable year-round production of plants, insensitivity to variable weather conditions, reduce pests and diseases, and reduce the amount of resources consumed on a per plant basis. Additionally, CEA may support various types of growing systems including, but not limited to soil-based systems and hydroponics systems.

A controlled agricultural environment is typically enclosed, at least in part, by a building structure such as a greenhouse, a grow room, or a covered portion of a field in order to provide some degree of control over environmental conditions. One or more artificial lighting systems are often used in such controlled agricultural environments to supplement and/or replace natural sunlight that may be obstructed by the building structure or insufficient during certain periods of the year (e.g., winter months). The use of an artificial lighting system may also provide yet another measure of control where the intensity and spectral characteristics of the lighting system may be tailored to improve the photosynthetic rates of plants. Various types of artificial lighting systems may be used including, but not limited to, a high intensity discharge lamp, a light emitting diode (LED), and a fluorescent lamp.

Artificial lighting systems, however, generate heat, which when dissipated into the environment may contribute significantly to the cooling load of the controlled agricultural environment. In order to accommodate the higher cooling load and thus maintain the controlled agricultural environment within a desired temperature envelope, the cooling capacity of a cooling system may need to be increased resulting in greater energy consumption. For a controlled agricultural environment on a variable energy budget, greater energy consumption may lead to higher energy costs. Alternatively, for a controlled environment on a fixed energy budget, a larger portion of the energy budget may be consumed by the cooling system, thus reducing the energy and capacity available to support a larger crop size and yield.

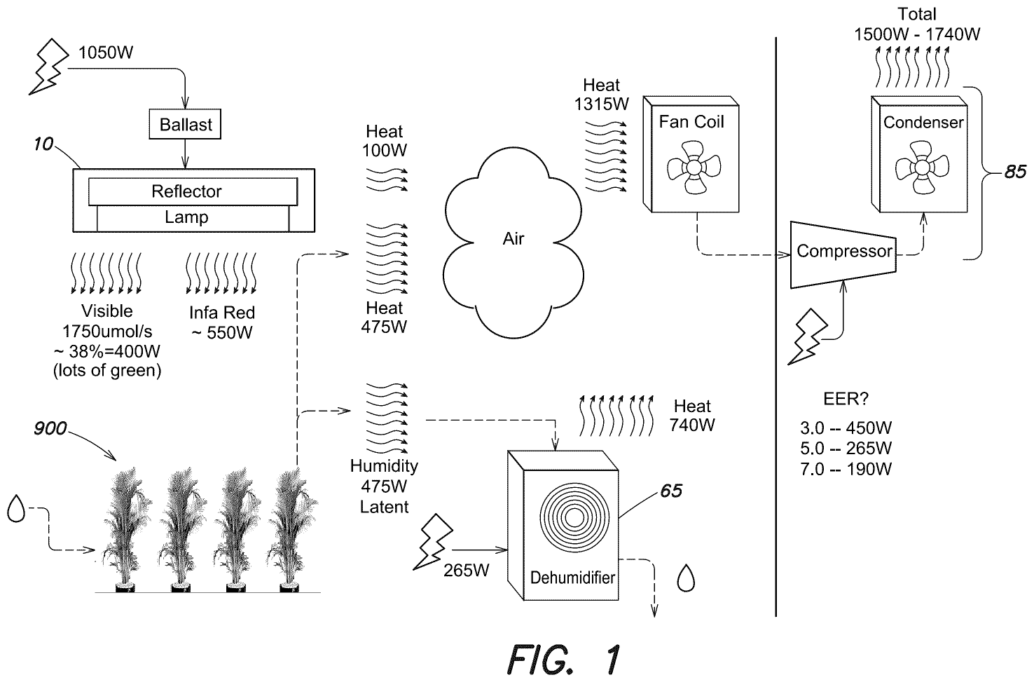

To illustrate the impact excess heat generated by an artificial lighting system may have on energy consumption, FIG. 1 shows a conventional controlled agricultural environment with one or more high pressure sodium (HPS) lamps 10, a particular type of high intensity discharge lamp, which irradiates a plurality of plants 900. The exemplary controlled agricultural environment shown in FIG. 1 further includes a dehumidifier 65 to manage the relative humidity of the environment and an air conditioner 85, which may include a fan coil, compressor, and condenser. Energy consumption by the air conditioner 85 generally depends on (1) the total cooling load of the environment and (2) the energy efficiency ratio (EER) of the air conditioner 85. The EER of an air conditioner is defined as the ratio of the cooling capacity (in Watts) to the input power (in Watts) at a given operating point. The EER was calculated with a 35° C. (95° F.) outside temperature and an inside (return air) temperature of 26.7° C. (80° F.) and 50% relative humidity. A higher EER indicates the air conditioner 85 is more efficient.

As shown in FIG. 1, the HPS lamps 10 may increase the cooling load of the environment by (1) dissipating heat convectively and/or radiatively directly into the environment and (2) increasing the relative humidity of the environment and thus, the power input and resultant heat generated by the dehumidifier 65. The cooling load in this exemplary controlled agricultural environment is about 1315 W. For an EER ranging from 3 to 7, the input power for the air conditioner thus ranges from 450 to 190 W, respectively. Based on the input power to the HPS lamps 10 of 1009 W and the dehumidifier 65 of 265 W, the air conditioner 85 thus consumes about 13% and 26% of the total energy budget, corresponding to an EER of 7 and 3, respectively.

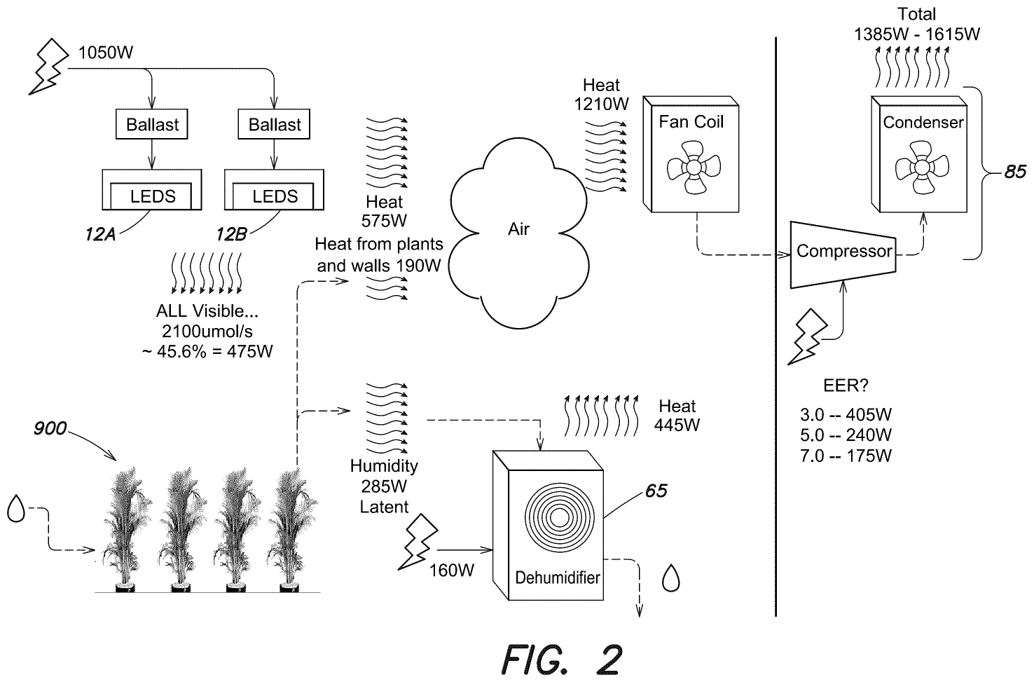

The amount of heat generated may vary depending on the type of lighting system used. However, artificial lighting systems for controlled agricultural environments generally have large power inputs (e.g., greater than 1000 W) in order to sustain a sufficient level of photosynthetically active radiation (PAR). Thus, the heat generated by various types of lighting systems may still constitute a large portion of heat produced within the environment. In another example, FIG. 2 illustrates a conventional controlled agricultural environment where one or more conventional LED-based lighting fixtures 12A and 12B irradiate a plurality of plants 900. In this exemplary controlled agricultural environment, the LED-based lighting fixtures 12A and 12B dissipates heat primarily via convection, which may reduce the power input and heat generated by the dehumidifier 65. In this example, the total cooling load is about 1210 W. For an EER ratio ranging from 3 to 7, the input power for the air conditioner 85 ranges from 405 W to 175 W. Compared to the first example, the use of LED-based lighting fixtures 12A and 12B decreases the total energy budget of the controlled agricultural environment. However, the proportion of energy used by the air conditioner 85 remains similar to the first example at about 13% and 25% for an EER ratio of 7 and 3, respectively. As shown in the two exemplary controlled agricultural environments, artificial lighting systems may generate a substantial amount of heat, which may result in air conditioning systems consuming a significant portion of the total energy budget in a controlled agricultural environment.

The present disclosure is thus directed to a fluid-cooled LED-based lighting fixture. In some implementations, a fluid cooling system may be integrated into the lighting fixture such that a substantial portion of the heat generated by one or more LEDs in the lighting fixture is captured by the fluid cooling system. In this manner, the amount of heat transferred to the environment by the lighting fixture may be substantially reduced, thus decreasing the cooling load and the energy input for any air conditioning systems that may be in the controlled agricultural environment. In some implementations, the fluid cooling system may be coupled to a hydronics system to distribute waste heat from the lighting fixture to control the temperature of the growing area or a separate interior space (e.g., a residential building). In some implementations, two or more lighting fixtures may be connected in series, or “daisy-chained,” where electrical and piping connections are shared to support a continuous electrical circuit and coolant circuit. The lighting fixture may also provide electrical connections to power one or more sensors to monitor various environmental conditions. In this manner, the fluid-cooled LED-based lighting fixture may also function as an integrated sensor platform.

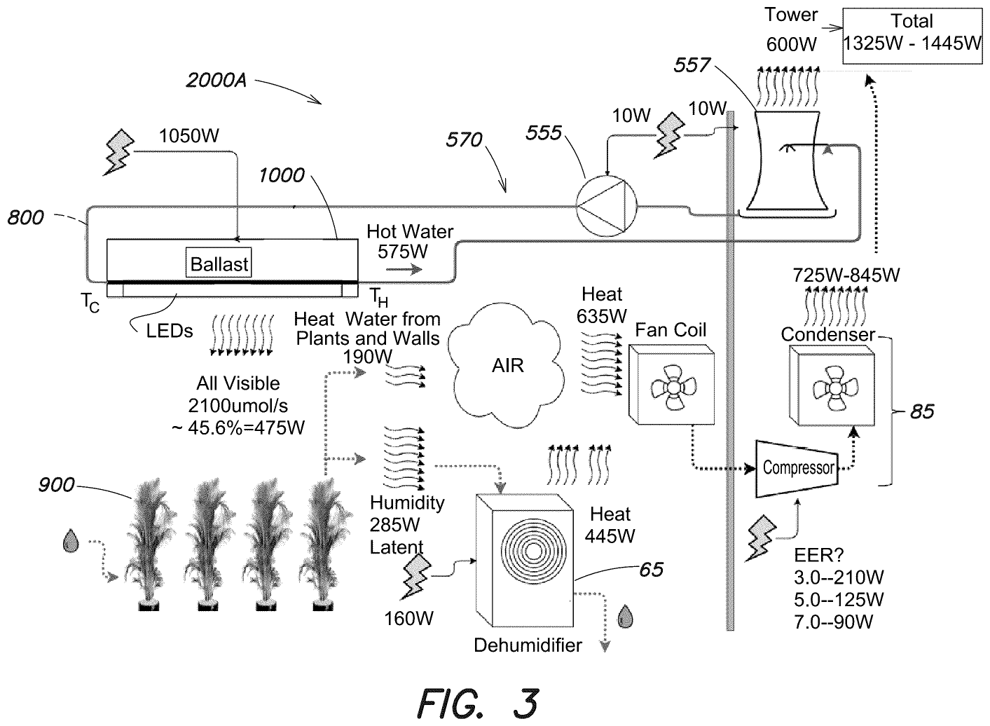

To illustrate the benefits of a fluid-cooled LED-based lighting fixture disclosed herein, FIG. 3 shows an exemplary implementation of a controlled agricultural environment 2000A where a lighting fixture 1000 is retrofit into a pre-existing environment that includes a dehumidifier 65 and an air conditioner 85. While not shown explicitly in FIG. 3, the environment may be constituted, at least in part, by a building structure to house a plurality of plants 900, one or more lighting fixtures 1000, and other equipment. The lighting fixture 1000 is cooled by a fluid coolant 800 that circulates through a coolant circuit 570. Heat carried by the fluid coolant 800 is removed by a cooling tower 557 located outside of the controlled agricultural environment 2000A. The coolant circuit 570 may include one or more pumps, regulators and/or valves 555 to control the flow of the fluid coolant 800 in the coolant circuit 570.

As shown in FIG. 3, the one or more pumps, regulators, and/or valves 555 may produce a flow of fluid coolant 800 that exhibits a relatively colder temperature T_{C} upon entry into the lighting fixture 1000 and a relatively hotter temperature T_{H} upon exit from the lighting fixture 1000. The rise in temperature of the fluid coolant 800 is due, in part, to convective heating of the fluid as it passes through the lighting fixture 1000 due to heat generated from one or more LED modules within the lighting fixture 1000. The fluid coolant 800 may thus be used to capture and transport heat generated by the lighting fixture 1000, which may substantially reduce the cooling load of the environment and the power inputs to the air conditioner 85 and/or the dehumidifier 65. As shown in FIG. 3, the cooling load for the exemplary controlled agricultural environment 2000A is about 635 W, which is approximately 50% the cooling load in the exemplary controlled agricultural environments shown in FIGS. 1 and 2. For an EER ranging from 3 to 7, the input power for the air conditioner thus ranges from 210 W to 90 W, respectively. Based on the input power to the lighting fixture 1000 of 1009 W and the dehumidifier 65 of 160 W, the air conditioner 85 thus consumes about 7% and 15% of the total energy budget, corresponding to an EER of 7 and 3, respectively.

Although a cooling tower 557 is shown in FIG. 3 to facilitate evaporative cooling of the heated fluid coolant exiting the lighting fixture 1000, it should be appreciated that various types of heat rejection devices may be employed in the coolant circuit 570 to remove heat from the fluid coolant 800. Some examples of heat rejection devices include, but are not limited to, various types of evaporative coolers, “free” coolers, chillers, dry coolers, air source coolers, ground source heat exchangers, water source heat exchangers, or any combinations of the foregoing.

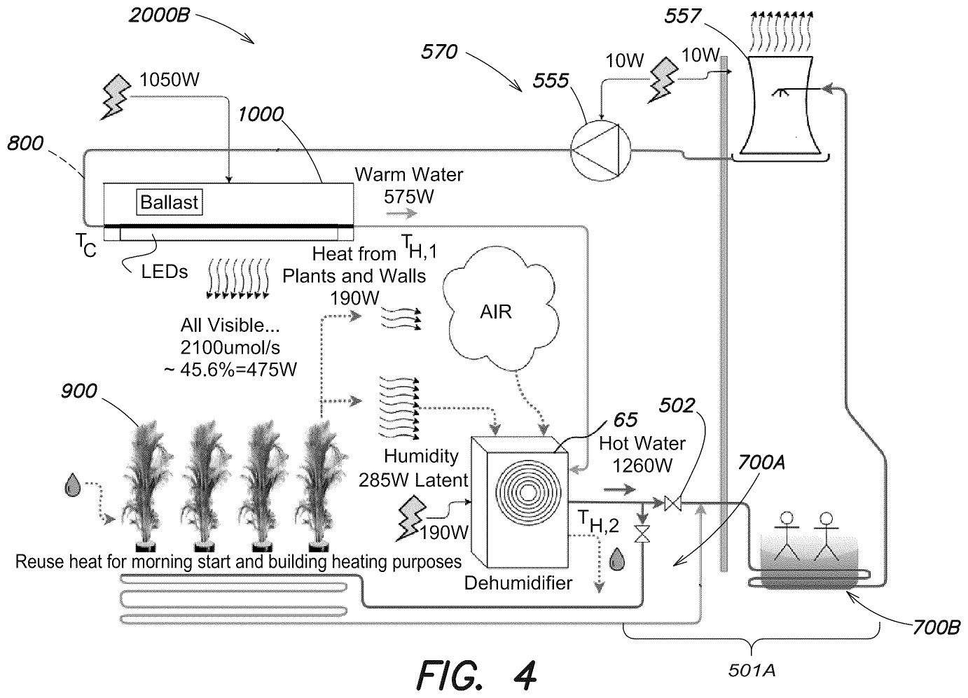

In another example, FIG. 4 shows an exemplary controlled agricultural environment 2000B where a lighting fixture 1000 is coupled to a coolant circuit 570 that directs the fluid coolant 800 to a hydronics system 501 having multiple plumbing subsystems 700A and 700B, which regulate and/or maintain the temperature of various portions of the controlled agricultural environment 2000B and/or space near the controlled agricultural environment 2000B (e.g., a hot pool, the growing area) by utilizing the waste heat generated by the lighting fixture 1000 as a heat source. The coolant circuit 570 may receive heat from the lighting fixture 1000 and other environment sources (e.g., a dehumidifier 65, the ambient air) such that excess heat generated in the environment may be substantially removed, thus further improving the energy savings to operate the controlled agricultural environment 2000B. In some implementations, the cooling load may be sufficiently reduced so as to eliminate the need for any air conditioning systems (i.e., there is no air conditioner fan coil, compressor or condenser).

As shown in FIG. 4, the controlled agricultural environment 2000B may include a dehumidifier 65 to regulate the relative humidity of the environment. The coolant circuit 570 may direct fluid coolant 800 heated by the lighting fixture 1000 into the dehumidifier 65 to further remove heat generated by the dehumidifier 65 in a convective manner similar to the removal of heat from the lighting fixture 1000. The coolant circuit 570 may then direct the fluid coolant 800 to the hydronics systems 700A and 700B, which may be used to heat the plurality of plants 900 and a hot pool, respectively. The coolant circuit 570 may distribute and direct heated fluid coolant 800 in a controlled manner by one or valves 502 before dissipating the remaining heat by the cooling tower 557.

In some implementations, the hydronics system 501 may also be used to regulate the temperature of the ambient environment itself. For example, the hydronics system 501 may be used to heat the controlled agricultural environment 2000B convectively and/or radiatively as the fluid coolant 800 flows through the hydronics system 501. Furthermore, while FIG. 4 shows a coolant circuit 570 passing through the dehumidifier 65, it should be appreciated that in other implementations the coolant circuit 570 need not include the dehumidifier 65, e.g. the coolant need not flow through the humidifier 65.

### An Exemplary Lighting Fixture

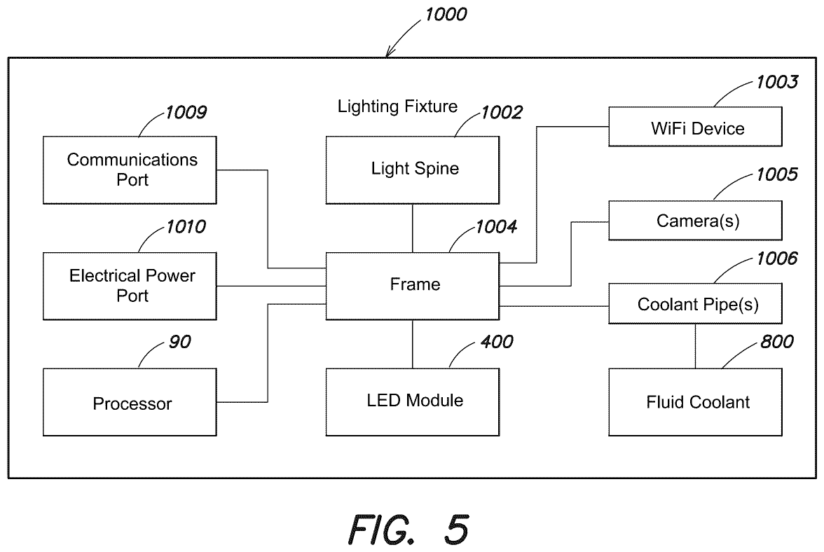

An exemplary implementation of a fluid-cooled LED-based lighting fixture 1000 is shown in FIG. 5. The lighting fixture 1000 may include a frame 1004 to mechanically support and house various components of the lighting fixture 1000. A light spine 1002 may be incorporated onto one or more sides of the frame 1004 with features to mechanically couple and secure the lighting fixture 1000 to a support structure disposed within a controlled agricultural environment. One or more coolant pipes 1006 may be coupled to the frame 1004, where each coolant pipe 1006 may be used to flow a fluid coolant 800 to cool the lighting fixture 1000. One or more LED modules 400 may be disposed on the frame 1004 to emit PAR towards a plurality of plants. A processor 90 may be coupled to the frame 1004 to facilitate the operation of the lighting fixture 1000 including, but not limited to power conversion, network connectivity, and data processing. One or more electrical power ports 1010 may be disposed on the frame 1004 to supply electrical power to various components of the lighting fixture 1000, including, but not limited to the LED modules 400, the processor 90, and other sensors that may be coupled to the lighting fixture 1000. One or more communication ports 1009 may be disposed on the frame 1004 to facilitate electrical communication and data transmission (and in some instances power, e.g., Power over Ethernet as discussed further below). One or more devices 1003 relating to wireless communications (“WiFi 1003;” e.g., wireless antenna, chip set with encryption functionality, etc.) may be disposed on and/or included within the frame 1004 to facilitate wireless communications that may or may not be encrypted to and from the lighting fixture 1000. One or more cameras 1005 and/or other sensing devices (onboard cameras/sensors) also may be disposed on and/or included within the frame 1004 (as opposed to coupled to the electrical power ports and/or the communication ports 1009), to facilitate image acquisition within various spectral regions of interest and/or other sensing functionalities.

The frame 1004 may be a mechanically rigid, hollow structure that forms a substantially enclosed housing. The interior cavity of the frame 1004 may be dimensioned to house a plurality of components in the lighting fixture 1000, such as various electronics in the processor 90. The frame 1004 may include one or more mounting features within the interior cavity to securely couple the plurality components to the frame 1004. For example, the frame 1004 may include one or more slots disposed within the interior cavity of the frame 1004 and arranged so as to mechanically support at least two opposing edges of a printed circuit board. Other mounting features may include, but are not limited to mounting posts and mounting stubs.

One or more removable panels may be included in the frame 1004 to provide access to the interior space. The one or more removable panels may be coupled to a portion of the frame 1004 using various types of coupling mechanisms including, but not limited to screw fasteners, bolt fasteners, clips, and clamps. In some implementations, the frame 1004 may form a sufficiently airtight enclosure or cavity to protect components, e.g., electronics, that may be sensitive to the environmental conditions of the controlled agricultural environment. For example, the controlled agricultural environment may operate at a relative humidity that may cause moisture to condense onto various surfaces of the lighting fixture 1000, causing damage to components including exposed electronics. In instances where the frame 1004 is an airtight enclosure, moisture may be substantially restricted from infiltrating the interior space of the frame 1004 to reduce the likelihood of condensation forming onto components disposed within the frame 1004.

The frame 1004 may also include a recessed portion disposed along at least one side of the frame 1004, e.g., the bottom side, with sidewalls that at least partially surround one or more LED modules 400. The recessed portion may be used to direct light emitted by the one or more LED modules 400 along a preferred direction and angular distribution. For example, the recessed portion may be used to substantially illuminate a growing area containing one or more plants located below the frame 1004. In some implementations, the surface quality and orientation of the interior surfaces of the sidewalls forming the recessed portion may form an integrated reflector to reflect light emitted by the one or more LED modules 400. For example, the interior surfaces of the sidewalls may be polished to reflect light in a substantially specular manner and oriented such that light is reflected towards a preferred direction, e.g., the growing area.

The frame 1004 may also include one or more channels formed along one or more sides of the frame 1004 where each channel may be used to secure a corresponding coolant pipe 1006 to the frame 1004. The cross-sectional shape of the channel may be substantially similar to the cross-sectional shape of the coolant pipe 1006 to facilitate insertion of the coolant pipe 1006 into the channel. The coolant pipe 1006 may be secured to the channel of the frame 1004 using several approaches. For example, the cross-section dimensions of the channel may be equal to or smaller than the cross-sectional dimensions of the coolant pipe 1006 to facilitate a press fit where the coolant pipe 1006 is secured to the channel via friction. In other examples, the coolant pipe 1006 may be clamped to the frame 1004 using one or more clamps, which may include, but are not limited to zip ties and clamps with a worm drive fastener. The clamps may be removable to allow replacement of the coolant pipes 1006. The surface of the one or more channels may also be polished to improve thermal contact with the coolant pipe 1006, thus enabling greater heat dissipation into the fluid coolant 800. In yet other examples, the coolant pipes 1006 may be adhered or bonded to the frame 1004 using various methods including, but not limited to adhesive bonding, welding, and brazing. Thermal interface material may also be disposed between the channel and the coolant pipe to improve thermal contact.

The frame 1004 may also be, at least in part, thermally conducting to transfer heat from the one or more LED modules 400 to the coolant pipe 1006. In particular, a first portion of the frame 1004 disposed between the LED module 400 and the coolant pipe 1006 may be formed from a thermally conducting material with dimensions to (1) reduce the distance between the LED module 400 and the coolant pipe 1006 and (2) increase the lateral cross-sectional area between the LED module 400 and the coolant pipe 1006. In this manner, the thermal resistance between the LED module 400 and the coolant pipe 1006 may be reduced. In some implementations, the frame 1004 may be formed entirely from the thermally conducting material to simplify manufacture and assembly. In some implementations, the first portion of the frame 1004 may be formed from a thermally conducting material while the remainder of the frame 1004 is formed from another material, such as a polymer in order to reduce material costs.

The frame 1004 may be formed from various metals, ceramics, polymers, or composites including, but not limited to, copper, aluminum, stainless steel, carbon steel, polyethylene, acrylic, and porcelain. Depending on the materials used to form the frame 1004, various method of manufacture may be utilized including, but not limited to extrusion, sandcasting, milling, injection molding, and manual molding. For instances where the frame 1004 is assembled form multiple parts, various coupling mechanisms may be used for assembly including, but not limited to snap fits, screw fasteners, bolt fasteners, adhesives, brazing, and welding.

The light spine 1002 may be used to secure the lighting fixture 1000 to a support structure in the controlled agricultural environment. The support structure may be various types of structures including, but not limited to a railing, a suspended platform, a ceiling, and a wall. The light spine 1002 may be a protruding fin formed onto the frame 1004 that includes one or more holes of varying size to accommodate different sizes and types of coupling mechanisms used to secure the lighting fixture 1000 to the support structure. The coupling mechanisms may include, but are not limited to bolt fasteners, screw fasteners, hooks, and shackles. The light spine 1002 may be dimensioned to span the length of the frame 1004, thus providing multiple locations along the frame 1004 to couple the lighting fixture 1000 to the support structure in a stable manner. For example, the light spine 1002 may be disposed on the top side of the frame 1004 with a length that spans the length of the frame 1004. The light spine 1002 may include a plurality of holes where the center axis of each hole is parallel to the top side of the frame 1004. Multiple bolt fasteners may be installed at each end and the center of the light spine 1002 to secure the lighting fixture 1000 to a sidewall of a support structure. Multiple light spines 1002 may also be distributed along the length of the frame 1004 or on multiple sides of the frame 1004 to allow the lighting fixture 1000 to be coupled to different support structures.

As described above, the coolant pipe 1006 may be used to flow fluid coolant 800 to capture heat generated by the LED module 400. The coolant pipe 1006 may be dimensioned to have a length longer than the frame 1004 such that a portion of the coolant pipe 1006 may extend beyond the sides of the frame 1004 to facilitate coupling of the coolant pipe 1006 to a pipe from a coolant circuit, a hydronics system, or another lighting fixture 1000. Various types of coupling mechanisms may be used to couple the coolant pipe 1006 to another pipe including, but not limited to threaded fittings, where the ends of the coolant pipe 1006 have corresponding threads, and bolt fasteners, where the end of the coolant pipe 1006 have a flange that mates to a corresponding flange on another pipe. In a preferred implementation, push-to-connect plumbing fittings may be used as a coupling mechanism where the ends of the coolant pipe 1006 are left bare. In this manner, internal seals and O-rings do not need to be used.

Multiple coolant pipes 1006 may be incorporated into the frame 1004 where each coolant pipe 1006 may be used to flow fluid coolant 800 along the same or opposing directions. For example, the lighting fixture 1000 may include two coolant pipes 1006 disposed on opposing sides of the frame 1004. For a lighting fixture 1000 that supports multiple LED modules 400, an opposing flow configuration (e.g., fluid coolant 800 flows in opposing directions between the two coolant pipes 1006) may more uniformly remove heat from the multiple LED modules 400. In comparison, a same flow configuration will result in more heat removed from the LED module 400 closest to the fluid coolant 800 input and less heat removed from the LED module 400 furthest from the fluid coolant 800 input. Additionally, the opposing flow configuration may more readily facilitate implementation of a closed coolant circuit. For example, the two coolant pipes 1006 may be connected at one end by a plumbing fitting such that fluid coolant 800 entering the lighting fixture 1000 flows through a first coolant pipe 1006 and then a second coolant pipe 1006 serially before exiting the lighting fixture 1000 on the same side.

The coolant pipe 1006 may be formed from various materials including copper, aluminum, and stainless steel. In a preferred implementation, the coolant pipes 1006 may be formed from copper to reduce algae growth, fouling, and corrosion. Thus, by coupling copper coolant pipes 1006 using the push-to-connect plumbing fittings described above, the fluid coolant 800 may pass through a coolant circuit made up of only copper without contacting other materials in the lighting fixture (e.g., an aluminum frame 1004).

The cross-sectional dimensions of the coolant pipe 1006 may vary depending on multiple factors including, but not limited to a desired flow rate, fluid coolant properties (e.g., dynamic viscosity, density), and a desired type of flow. For example, it may be desirable for the fluid coolant to be in a turbulent flow regime, which engenders a higher heat transfer coefficient, thus dissipating more heat from the lighting fixture 1000. In some implementations, the cross-sectional dimensions of the coolant pipe 1006 may be chosen such that a particular Reynold's number, Re, is greater than a desired threshold (e.g., Re>4000 for turbulent flow) for a given pump power and coolant circuit geometry. The interior surface of the coolant pipe 1006 may also be roughened to increase the surface area and the convective heat transfer coefficient. The effective depth and pitch of the interior surface roughness may be chosen so as to not substantially increase pumping requirements (e.g., due to a larger pressure drop) and maintains wettability of the interior surface to the fluid coolant 800 (e.g., remains hydrophilic, oleophilic).

The fluid coolant 800 used to capture and carry heat from the lighting fixture 1000 may be chosen based on several factors. First, it is preferable for the fluid coolant 800 to exhibit a high thermal conductivity and a high specific heat in order to increase heat dissipation from the LED module 400 to the fluid coolant 800. Second, the fluid coolant 800 should remain in a liquid phase within the operating temperature and pressure range of the controlled agricultural environment. For example, the fluid coolant 800 should not freeze or boil as it passes through the lighting fixture 1000, the coolant circuit, the hydronics system, or a cooling tower. Third, the fluid coolant 800 should also be chosen so as not to substantially corrode the coolant pipe 1006. For controlled agricultural environments, the fluid coolant 800 may be various fluids including, but not limited to water, mineral oil, glycol, and mixtures.

The lighting fixture 1000 also may include one or more communication and/or auxiliary power ports, for example, to provide auxiliary DC power to one or more auxiliary devices coupled to the port(s), and/or facilitate communications between the lighting fixture and the one or more auxiliary devices. Example of such ports include, but are not limited to, one or more Power over Ethernet (POE) ports and/or one or more Universal Serial Bus (USB) ports.

For example, the lighting fixture 1000 may include at least one electrical power port 1010 to supply electrical power to various components in the lighting fixture 1000 (e.g., the LED module 400) and/or various components electrically coupled to the lighting fixture 1000 (e.g., other lighting fixtures 1000 or auxiliary sensors). The electrical power port 1010 may receive as input alternating current (AC) power, such as from a building electrical supply system, which may be converted into direct current (DC) power via the processor 90. The processor 90 may include electronics to facilitate conversion between DC and AC power, as will be discussed in greater detail below.

One or more communication ports 1009 may also be used in the lighting fixture 1000 to facilitate data transmission to and from the lighting fixture 1000. For example, the communication port 1009 may be used to remotely control various aspects of the lighting fixture 1000 including, but not limited to adjustments to electrical power (e.g., high voltage and low voltage modes), adjustments to the spectral content of the light emission (e.g., directing more power to blue or red LED elements), and commands to operate auxiliary sensor devices (e.g., frequency of data recording). In another example, the communication port 1009 may be used to send various status and monitoring data to a remote user including, but not limited to electrical power consumption, temperature, and data measured by auxiliary sensor devices. The data received and transmitted by the communication port 1009 may be managed, in part, by the processor 90, as will be discussed in more detail below.

The communication port 1009 may accommodate various types of electrical cabling including, but not limited to universal serial bus (USB) cables and Power over Ethernet (POE) cables. In some implementations, multiple communication ports 1009 including both USB and PoE ports may be used to enable greater flexibility and compatibility with more types of cabling and auxiliary devices. One or more communication ports 1009 may be disposed on one or more sides of the frame 1004. For example, a set of communication ports 1009 may be disposed on opposite sides of the frame 1004 (e.g., left and right sides or front and rear sides) to facilitate connectivity between a plurality of lighting fixtures 1000 in a daisy-chain configuration. Communication ports 1009 may also be disposed on the frame 1004 where auxiliary sensors are likely to be deployed. For example, communication ports 1009 may be disposed on the bottom side of the frame 1004 to provide electrical connection to auxiliary sensors that are used to monitor ambient conditions near the plants located below the lighting fixture 1000. In some implementations, the communication port 1009 may also supply DC power. For example, the lighting fixture 1000 may include a USB port that may electrically power an auxiliary sensor device and receive data measured by the auxiliary sensor device through the same communication port 1009.

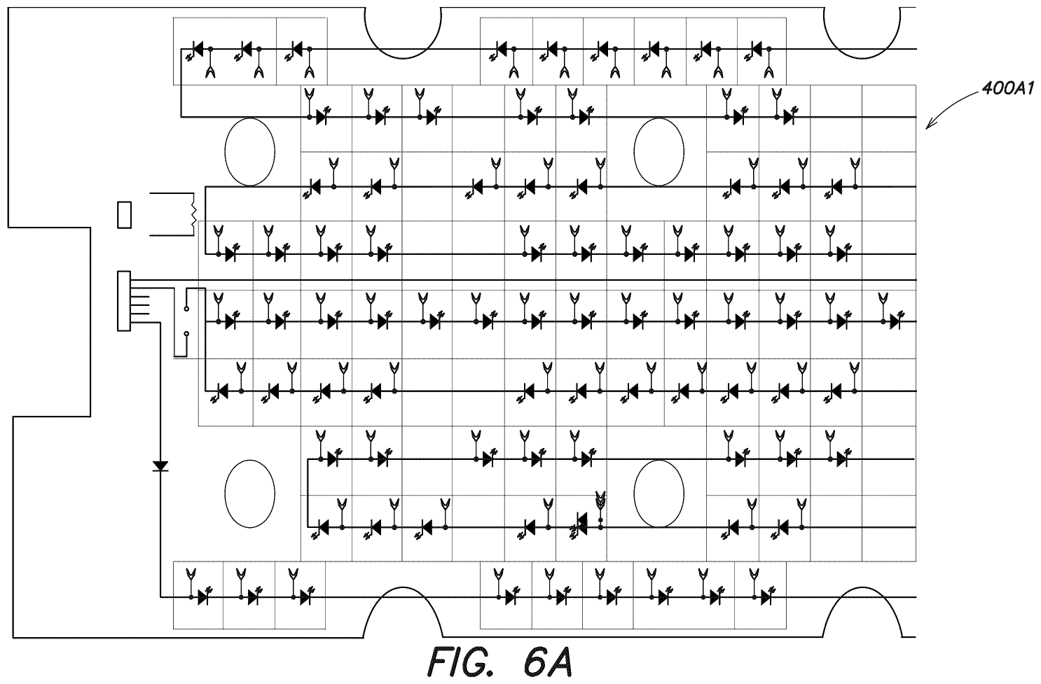

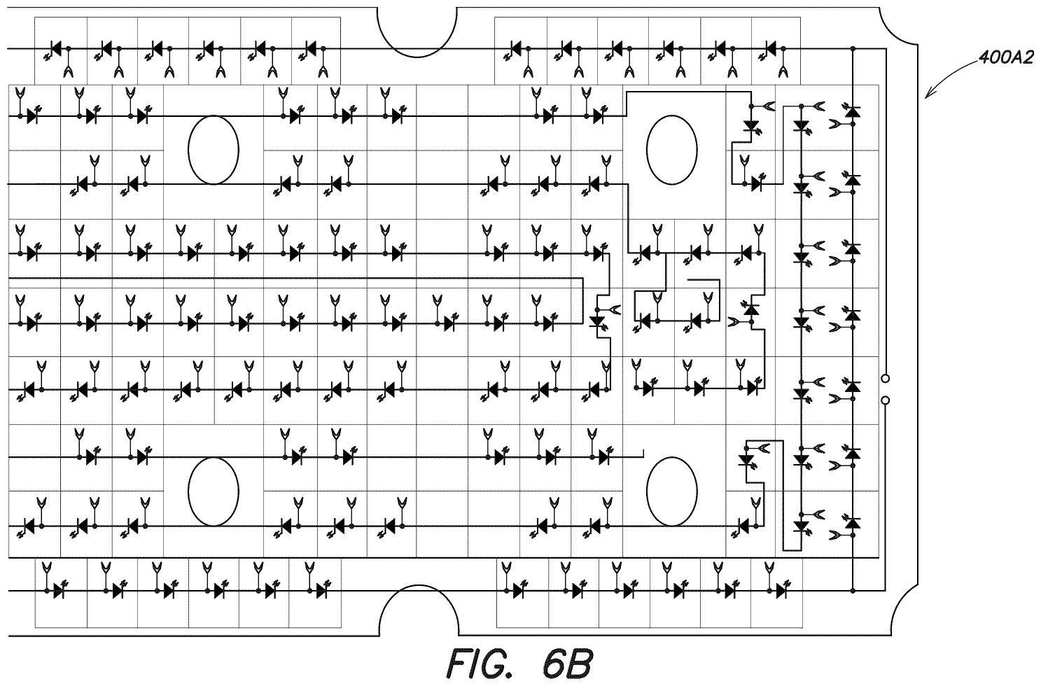

The LED module 400 may include one or more LED elements arranged into an array. The one or more LED elements of the LED module 400 may each emit light at a particular wavelength such that in combination, the LED module 400 irradiates plants with light at multiple wavelengths tailored to improve various aspects related to the growth of plants and operation of the controlled agricultural environment including, but not limited to improving photosynthetic rates of the plants, growth modification, and ultraviolet (UV) sterilization. The one or more LED elements may be assembled onto the frontside of a printed circuit board. An exemplary circuit layout of an LED module 400 according to one inventive implementation is shown in FIGS. 6A and 6B, which illustrates the respective halves 400A1 and 400A2 of the LED module 400A. As shown, the LED module 400A may include multiple LED elements that are distributed across the printed circuit board.

The printed circuit board may be a metal core printed circuit board (MCPCB) to facilitate heat dissipation generated by the one or more LED elements. The LED module 400 may be coupled to the frame 1004 such that the backside of the printed circuit board is in contact with the bottom side of the frame 1004 located in the recessed portion as described above. The LED module 400 may be coupled to the frame 1004 using various coupling mechanisms including, but not limited to screw fasteners, bolt fasteners, clips, and clamps. The coupling mechanism may be adjusted such that a clamping force is applied to the LED module 400, thus improving the thermal contact between the LED module 400 and the frame 1004. Additionally, thermal interface material may also be placed between the LED module 400 and the frame 1004 to improve thermal contact.

In some implementations, the lighting fixture 1000 may also include an optic located on the recessed portion of the frame 1004, which covers the LED module 400. The optic may be used to modify the direction and angular distribution of the light emitted by the LED module 400. For example, a portion of the optic may have a convex surface to focus light emitted from the LED module 400 onto plants located directly below the lighting fixture 1000. The optic may be coupled to the frame 1004 using various coupling mechanisms including, but not limited to screw fasteners, bolt fasteners, clips, and clamps. In some implementations, the optic may form a substantially airtight enclosure around the LED module 400, thus substantially isolating the LED module 400 from the ambient environment in the controlled agricultural environment. Similar to the airtight enclosure that may be formed by the frame 1004, the optic may reduce moisture infiltration, thus reducing the risk of condensation damaging the LED module 400.

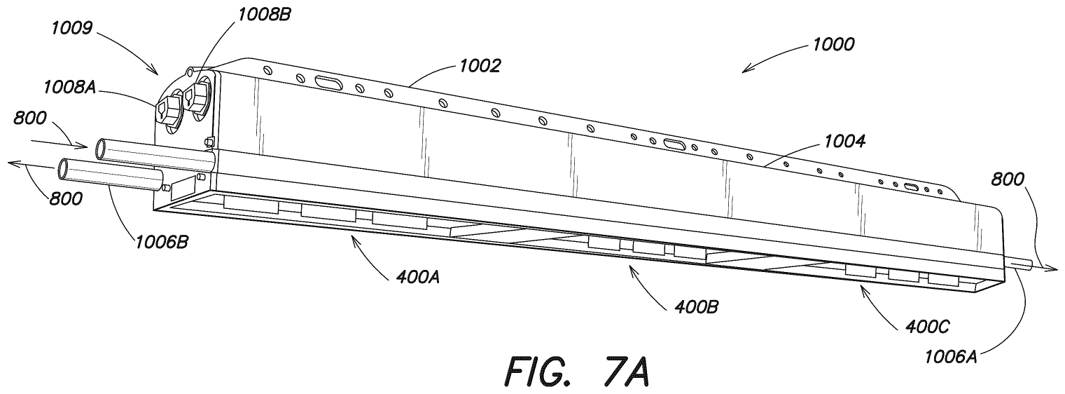

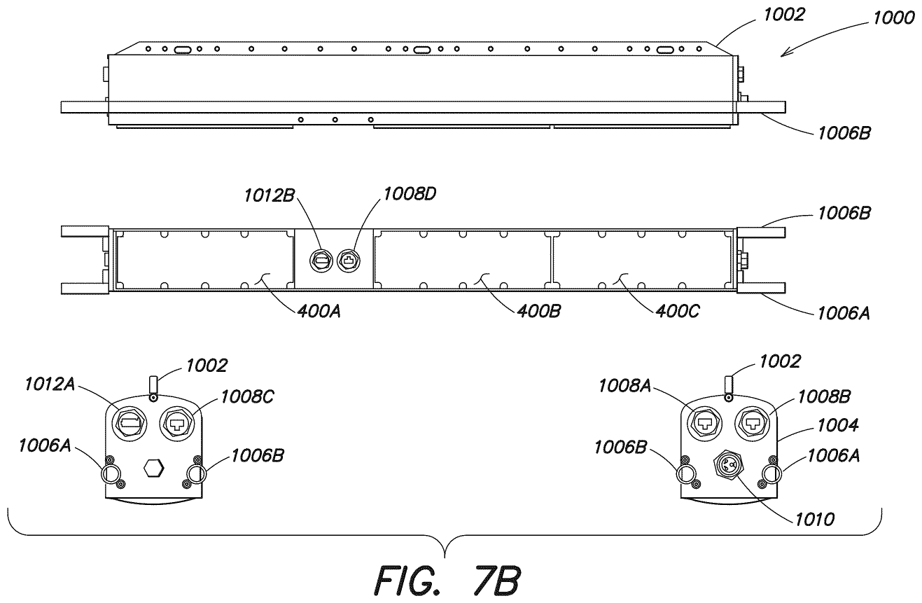

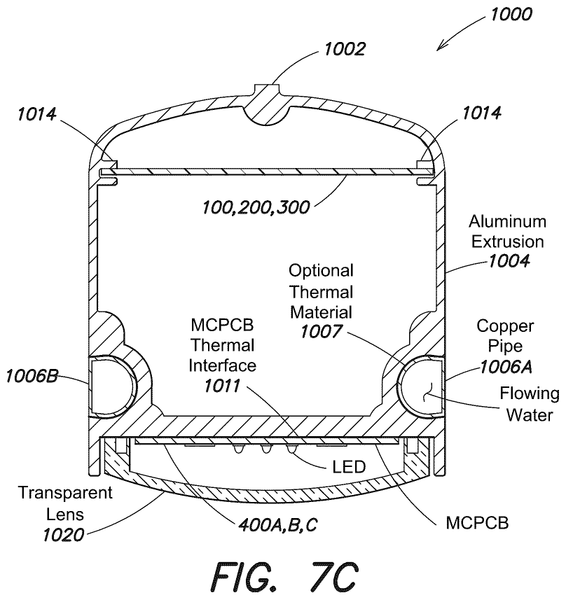

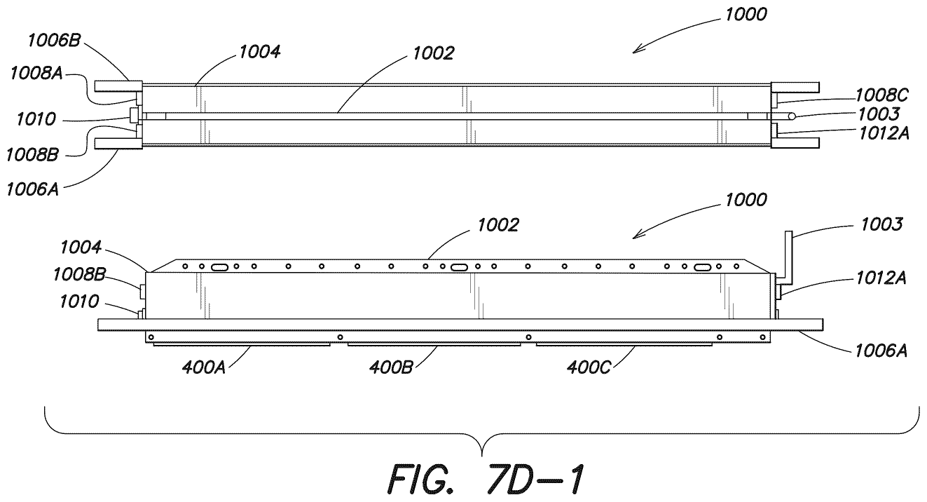

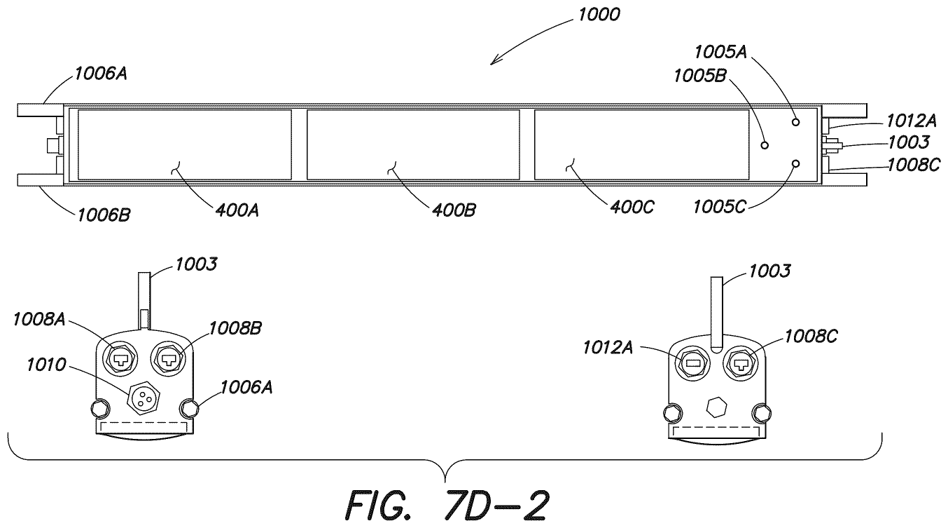

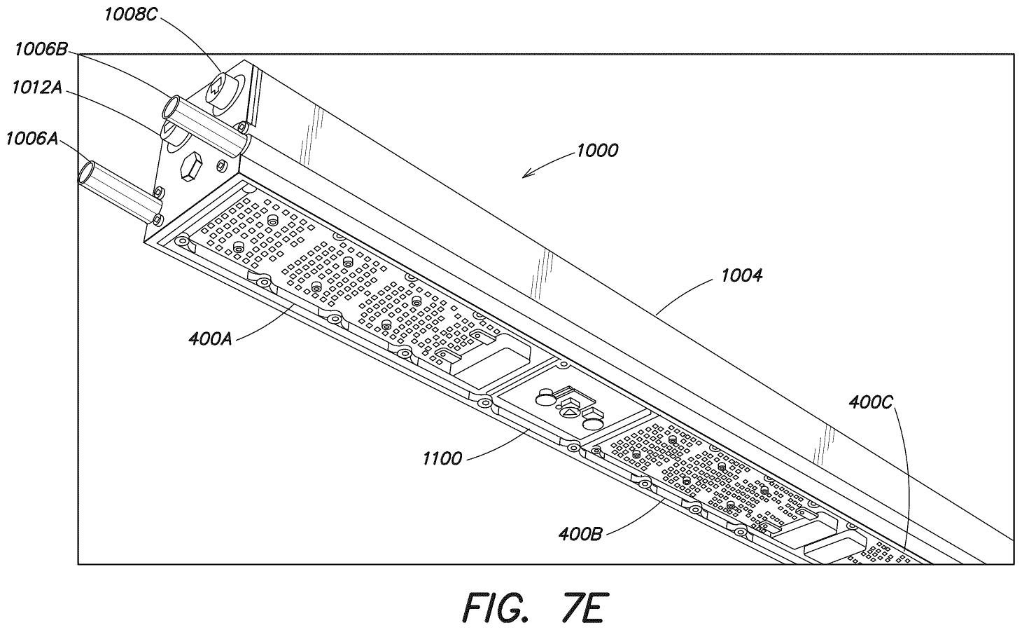

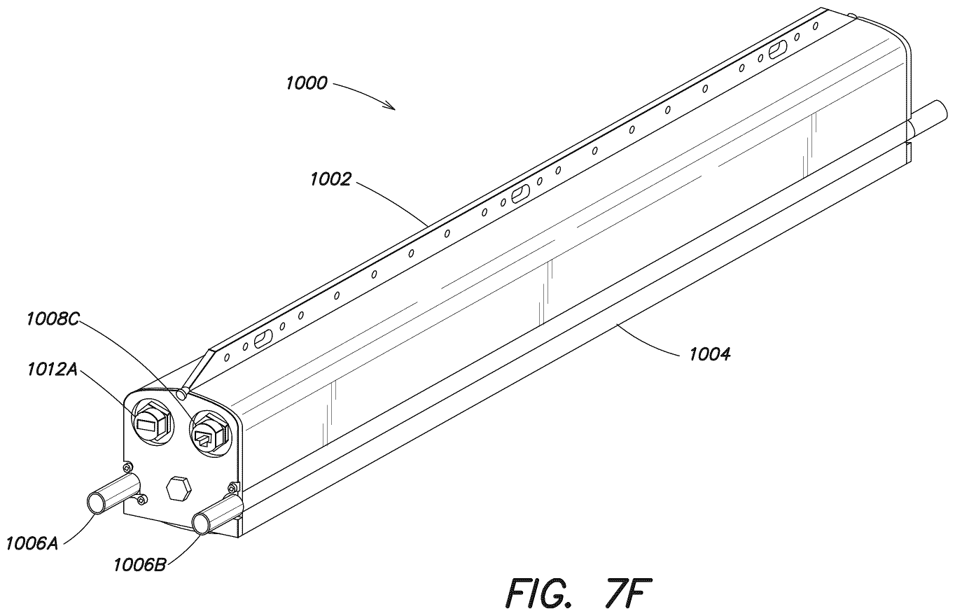

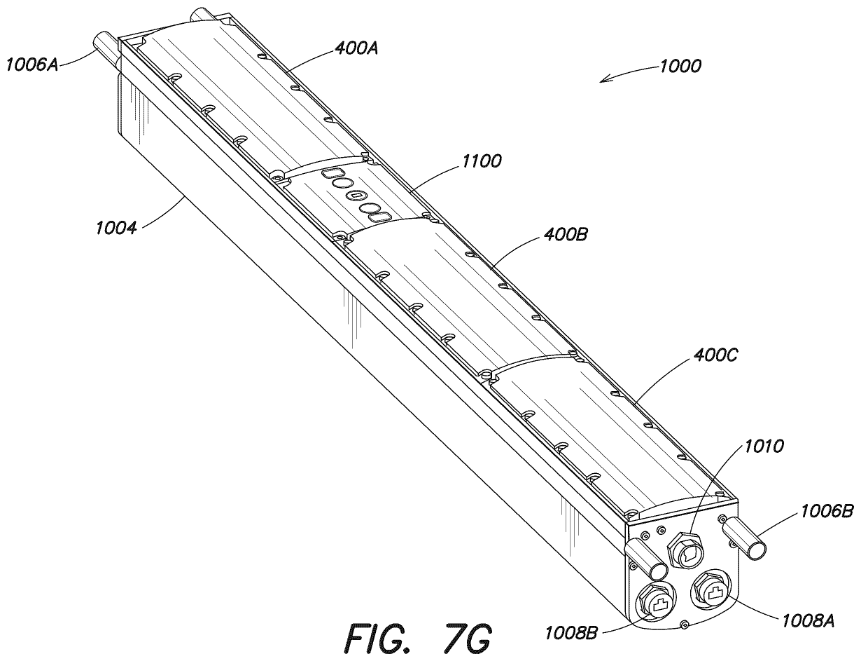

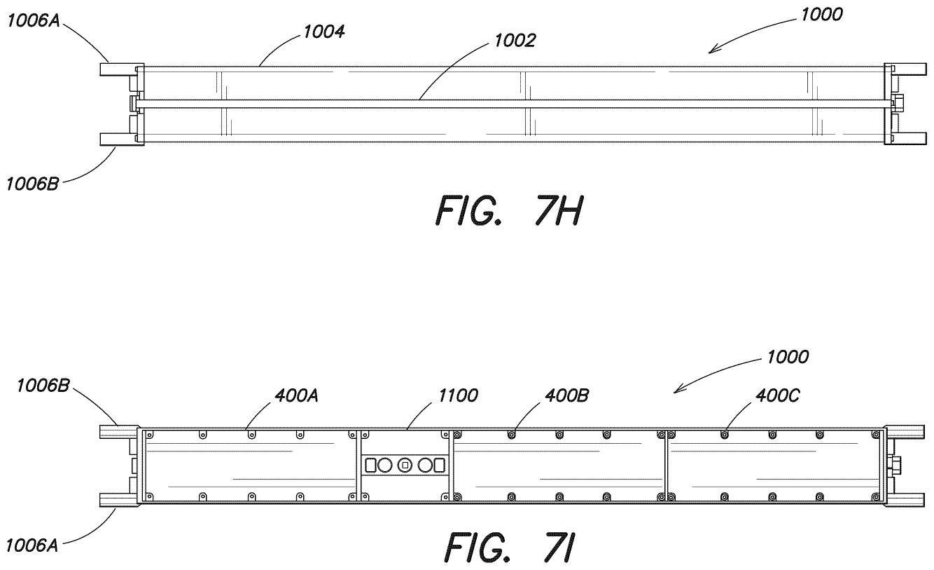

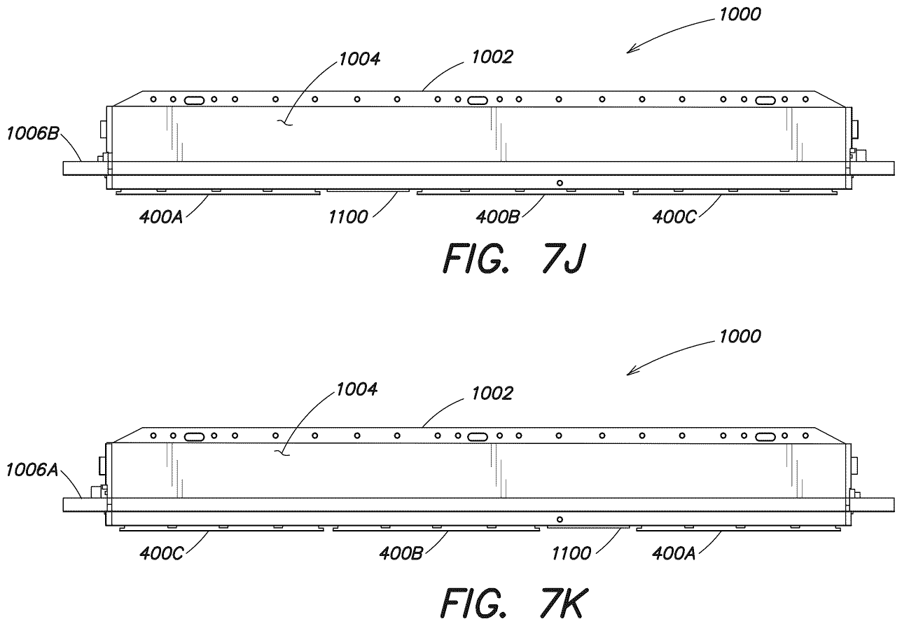

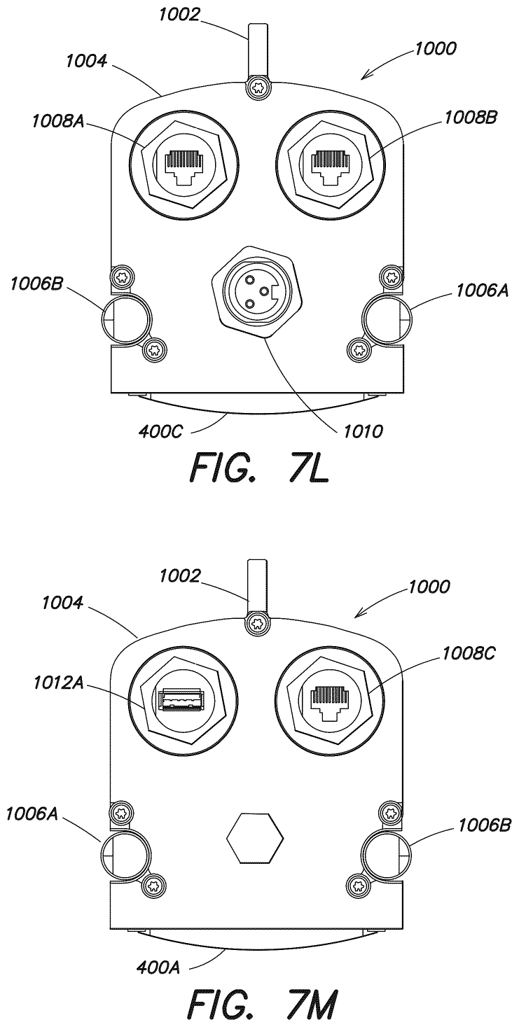

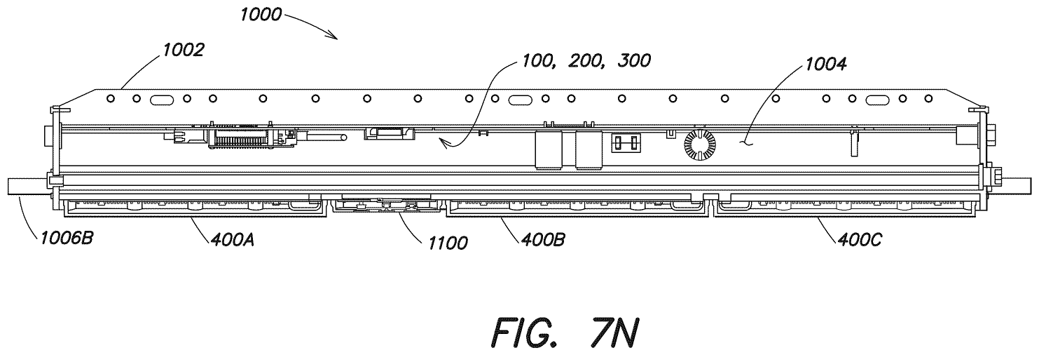

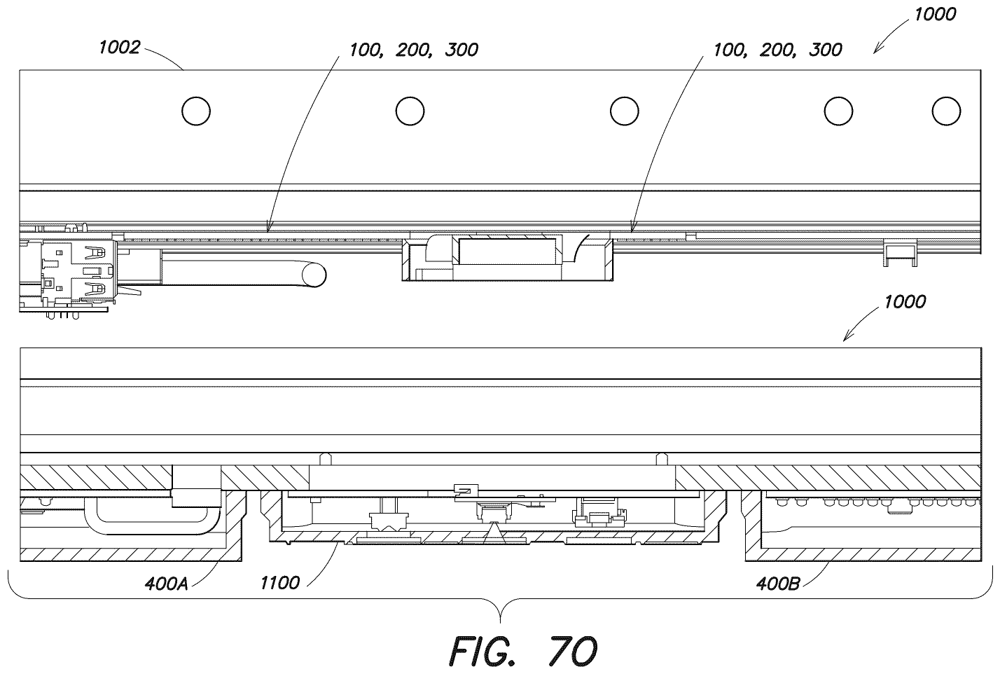

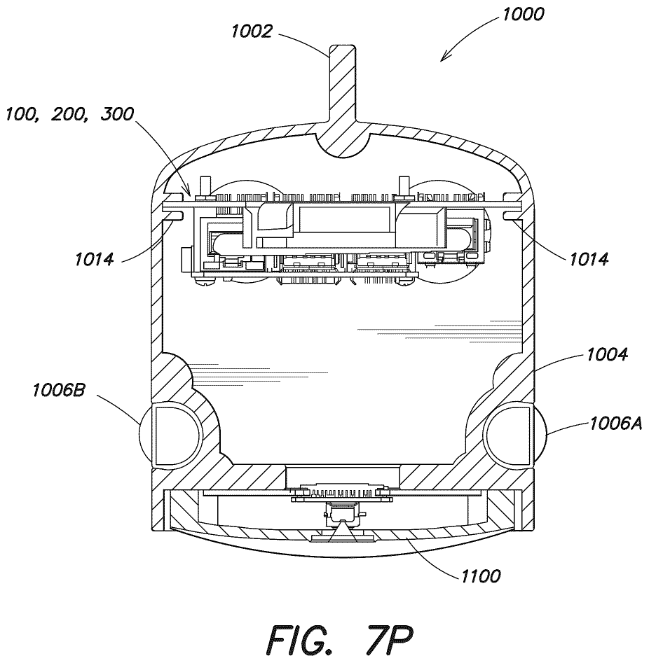

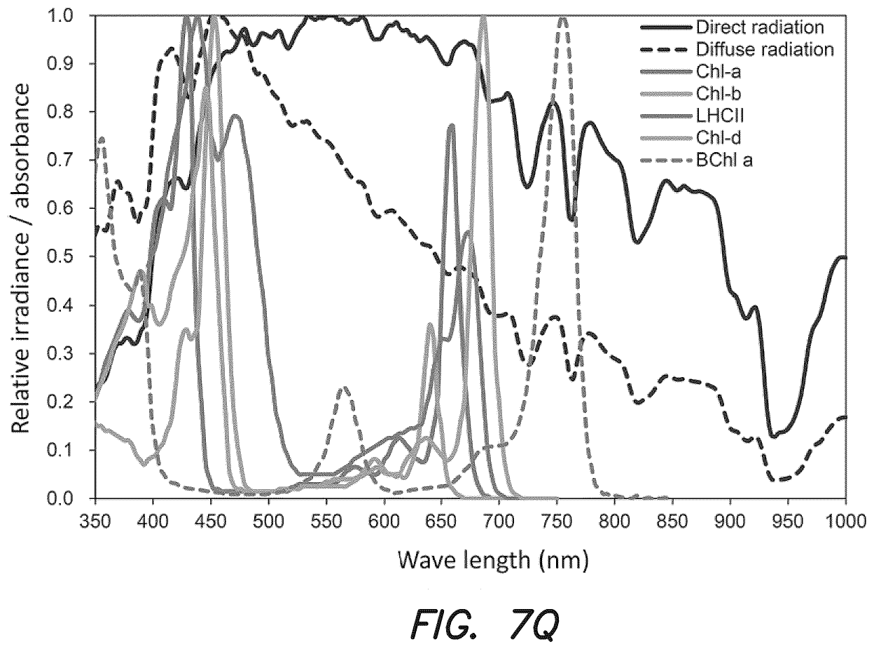

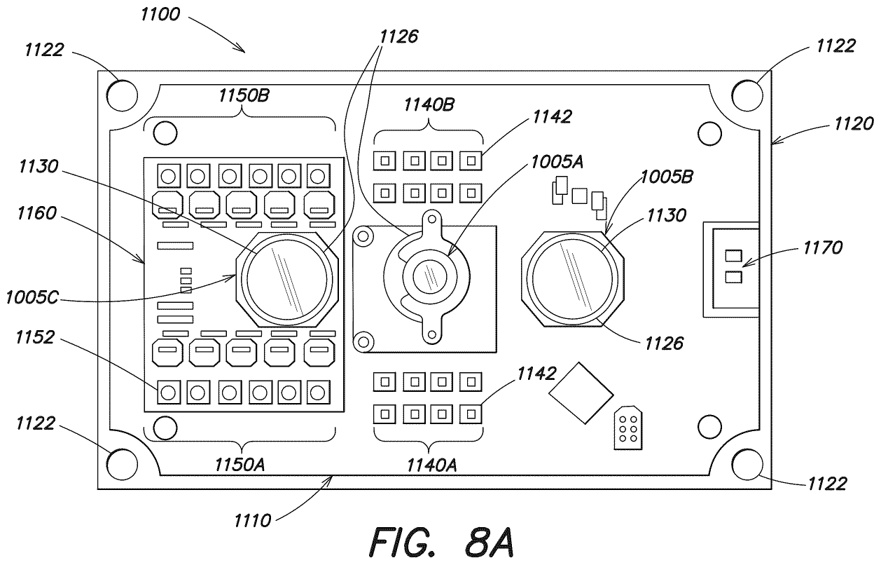

An exemplary lighting fixture 1000 according to one inventive implementation is shown in FIGS. 7A-7C. FIG. 7A shows a bottom perspective view of the lighting fixture 1000 and FIG. 7B shows a front, bottom, left and right side view of the lighting fixture 1000. As shown, the lighting fixture 1000 includes a frame 1004 dimensioned to support three LED modules 400A, 400B, and 400C positioned in a row and disposed on the bottom side of the frame 1004. A light spine 1002 may be formed on the top of the frame 1004 that substantially spans the entire length of the frame 1004. The light spine 1002 may include a plurality of different sized holes to facilitate coupling of the lighting fixture 1000 to a support structure in the controlled agricultural environment. The left and right-side panels of the frame 1004 may be secured by a plurality of screw fasteners and hence, may be removed to allow access into the interior cavity of the frame 1004. The left side panel of the frame 1004 may include two communication ports 1009, e.g., a USB port 1012A and a PoE port 1008C. The right-side panel of the frame 1004 may also include two communication ports 1009, e.g., two PoE ports 1008A and 1008B, as well as an electrical power port 1010. Two communication ports, e.g., a USB port 1012B and a PoE port 1008D, may be disposed on the bottom side of the frame 1004 to facilitate connectivity to auxiliary senor devices that may be used to monitor ambient conditions near the plants. The lighting fixture 1000 also includes two coolant pipes 1006A and 1006B disposed along the front and rear sides of the frame 1004. The frame 1004 may be formed from an aluminum extrusion to include a corresponding pair of channels. The coolant pipes 1006A and 1006B, which may be formed form copper, may be press-fit or crush-fit into the corresponding channels. In this manner, the likelihood that fluid coolant flowing through the coolant pipes 1006A and 1006B contacts the frame 1004 is substantially reduced.

FIG. 7C shows a cross-sectional view of the lighting fixture 1000 where the coolant pipes 1006A and 1006B are shown to be press-fit into the channels of the frame 1004. Thermal interface material 1007 may be disposed between the channels and the coolant pipes 1006A and 1006B to improve thermal contact. The LED modules 400A-400C are disposed substantially in a recessed portion of the bottom side of the frame 1004 and in close proximity to the coolant pipes 1006A and 1006B to facilitate heat dissipation. As shown, a small portion of the frame 1004, which is formed from a thermally conducting material, is present between the coolant pipes 1006A and 1006B and the LED modules 400A-400C. FIG. 7C also shows mounting features 1014 used to support various control circuitry boards 100, 200, and 300, which are collectively referred to hereafter as a processor 90. The mounting features 1014 are a pair of protruding slots disposed along the front and rear sides of the frame 1004, which are dimensioned to support the opposing edges of the processor 90. The processor 90 is positioned above the coolant pipes 1006A and 1006B and LED modules 400A-400C in order to reduce thermal effects due to heat generated by the LED modules 400A-400C. An optic 1020 is also included, which may be coupled to the frame 1004 via a plurality of screw fasteners. The optic 1020 may be a transparent lens with a convex surface used to redirect light emitted by the LED modules 400A-400C along a desired direction and angular distribution. The optic 1020 may also substantially enclose and isolate the LED modules 400A-400C from the surrounding ambient environment.

FIGS. 7D-1 and 7D-2 show various views of another lighting fixture 1000 that includes one or more onboard cameras and/or sensors 1005 and wireless communications devices 1003, according to some implementations of the disclosure. As shown, the camera(s)/sensor(s) 1005 and the wireless device 1003 may be mounted and/or integrated into the frame 1004 of the lighting fixture 1000. The camera(s)/sensor(s) 1005 and/or the wireless device 1003 may be used in combination with or as a substitute for sensors/communication devices coupled to the lighting fixture 1000 as an accessory to the various communication ports (e.g., the PoE ports 1008A-1008D, the USB ports 1012A-1012B). In some implementations, the camera(s)/sensor(s) 1005 and/or the wireless device 1003 may receive electrical power directly from the electrical power port 1010 (e.g., the port 1010 supplies AC power) or indirectly from another device (e.g., the processor 90 supplies DC power).

In some implementations, the frame 1004 may include one or more openings (not shown) to mechanically mount the camera/sensor 1005 and/or the wireless device 1003 (e.g., openings for bolt(s) or screw fastener(s) that align with corresponding openings on a housing or a printed circuit board in the camera(s)/sensor(s) 1005 and/or the wireless device 1003). The one or more openings may also provide an electrical feedthrough for the camera(s)/sensor(s) 1005 and/or the wireless device 1003. For example, the sensing components of the camera(s)/sensor(s) 1005 and/or the transmitter/receiver of the wireless device 1003 may be disposed on the exterior of the frame 1004 and electrically coupled to respective processors disposed inside the cavity of the frame 1004 via one or more wires. In some implementations, the frame 1004 may include an aperture and/or a recessed section to reduce or prevent obstructions to the field of view of the camera(s)/sensor(s) 1005. The frame 1004 may also provide mating features (e.g., a recessed section) for a gasket and/or a seal to protect sensitive components of the camera/sensor 1005 and/or wireless device 1003 (e.g., exposed electronic circuitry) disposed in the cavity of the frame 1004 from the environment.

The wireless communication device(s) 1003 may include one or more WiFi antennas and accompanying electric circuits (e.g., chipsets, processors) to facilitate wireless communication to/from the lighting fixture 1000. In some implementations, the wireless device 1003 may include a transmitter and/or a receiver to communicate with one or more remote devices (e.g., a computer, a server, a tablet, a smartphone). For example, the wireless device 1003 may include a transmitter to transmit various sensory data collected by the camera/sensor 1005 (or another sensor coupled to the PoE ports 1008A-1008D and/or the USB ports 1012A-1012B) to the remote device (e.g., for processing, recording). In another example, the wireless device 1003 may include a receiver to receive a signal from the remote device, which may include a command to adjust the operation of the lighting fixture 1000. Commands may include, but are not limited to, adjusting the light output of the LED module 400 (e.g., total intensity, spectral intensity distribution), the flow of a fluid coolant passing through the coolant pipes 1006A and 1006B (e.g., adjusting a valve to control flow rate), and adjusting the settings of various sensors (e.g., turning on/off the sensor, acquisition rate, operation mode of the sensor).

In some implementations, the electric circuit(s) of the wireless device 1003 may comprise discrete circuit boards (not shown) that are electrically coupled to the respective antennas of the wireless device 1003. The circuit boards, in turn, may be coupled to other circuitry in the lighting fixture 1000 (e.g., processor 90) to facilitate electrical communication between the respective components of the lighting fixture 1000. In some implementations, the wireless device 1003 may be directly coupled to one or more of the communication ports on the lighting fixture 1000 (e.g., the PoE ports 1008A-1008D and/or the USB ports 1012A-1012B) and/or another device (e.g., the camera/sensor 1005).

The wireless device 1003 may generally communicate with other remote devices using various communication protocols including, but not limited to LoRaWAN, WiSun, Zigbee, Bluetooth, 3G, 4G, and 5G. In some implementations, the wireless signals transmitted and/or received by the wireless device 1003 may be encrypted using various encryption protocols may be used including, but not limited to wired equivalent privacy (WEP), Wi-Fi protected access (WPA), WPA version 2 (WPA2), and WPA version 3 (WPA3). In some implementations, the wireless device 1003 may be used instead of the Ethernet cable 160 for data communication to/from the lighting fixture 1000. In this manner, a lighting system that includes multiple lighting fixtures 1000 may utilize respective wireless devices 1003 for communication (e.g., between lighting fixtures 1000, between the lighting fixture 1000 and the remote device), thus simplifying installation by reducing the amount of Ethernet cables 160 used. In some implementations, multiple lighting fixtures 1000 each employing wireless device(s) 1003 may be configured and arranged as a wireless mesh network of lighting fixtures.

The lighting fixture 1000 of FIGS. 7D-1 and 7D-2 may also include one or more cameras, other imaging devices (e.g., a thermal imager), or other sensors (collectively referred to with reference number 1005) disposed in or on (integrated with) the frame 1004 of the lighting fixture 1000. The camera(s)/sensor(s) 1005 may be used to acquire various information about the agricultural environment including, but not limited to imagery (video imagery or still imagery, as well as thermal imagery) of the plants and/or other subjects of interest in the environment around the lighting fixture 1000, lighting conditions, temperature, relative humidity, nutrient levels in the air and/or soil, and carbon dioxide (CO₂) concentrations. Examples of various types of sensors that may be included in the camera(s)/sensor(s) 1005 include, but are not limited to, one or more cameras responsive to radiation in a range of at least visible wavelengths and/or IR wavelengths, an air temperature sensor, a near infrared (NIR) leaf moisture sensor, a relative humidity sensor, a hyperspectral camera, a carbon dioxide sensor, an infrared (IR) leaf temperature sensor, an airflow sensor, and a root zone temperature sensor.

In some implementations, the camera(s)/sensor(s) 1005 may be configured to acquire sensory data proximate to the portion of the plants and/or other subjects of interest in the environment around the lighting fixture 1000 irradiated by the LED source(s) 400. In some example implementations employing multiple cameras/sensors 1005, the multiple cameras/sensors 1005 may be co-located on the frame 1004 of the lighting fixture 1000 (e.g., in sufficient proximity to one another) such that the respective fields of view (FOV) of the cameras and/or sensors are substantially overlapping or substantially the same. In this manner, different types of sensory data may correspond to the same region of the environment, thus enabling a more comprehensive analysis of the environment. In some implementations, the portion of the plants and/or other subjects of interest irradiated by the LED light source(s) 400 of the lighting fixture 1000 may be further subdivided into subregions that are each characterized by corresponding sets of cameras/sensors 1005 disposed on/integrated in the lighting fixture 1000.

In some implementations, the camera(s)/sensor(s) 1005 may include multiple cameras or other imaging devices (e.g., thermal imagers) that facilitate acquisition of images and other information within different spectral bands. For example, the lighting fixture 1000 may include cameras that acquire imagery in various spectral bands including, but not limited to the ultraviolet band (e.g., wavelengths between 10 nm and 400 nm), the visible band (e.g., wavelengths between 400 nm and 700 nm), the near infrared (NIR) band (e.g., wavelengths between 700 nm and 1.4 μm), the mid infrared (MIR) band (e.g., wavelengths between 1.4 μm and 8 μm), and the far infrared (FIR) band (e.g., wavelengths greater than 8 μm).

To this end, FIG. 7D-2 illustrates that one implementation of the lighting fixture 1000 may include three cameras/sensors 1005A, 1005B and 1005C. As show in FIG. 7D-2, the multiple cameras/sensors 1005A, 1005B and 1005C may be integrated with and disposed on the bottom portion of the lighting fixture 1000 adjacent to one or more light sources 400. Although FIG. 7D-2 illustrates three cameras/sensors located on one side of multiple light sources 400 on the bottom portion of the lighting fixture 1000, it should be appreciated that different numbers of cameras/sensors 1005 may be included in the lighting fixture 1000 according to the inventive concepts described herein, and that one or more cameras/sensors may be disposed on or otherwise integrated with the lighting fixture 1000 at various locations and/or positions on the lighting fixture other than those shown in FIG. 7D-2 (and as discussed further below in connection with other example implementations).

In some implementations, the camera(s)/sensor(s) 1005 may include one or more processors (e.g., a Raspberry Pi processor) and one or more of the cameras/sensors may be configured for operation with the one or more of the processors. In one example implementation of the lighting fixture shown in FIG. 7D-2, the lighting fixture 1000 includes a visible camera 1005A, an infrared camera 1005B, and/or an IR single point sensor 1005C. As shown, the multiple cameras/sensors may be co-located on the fixture 1000 proximate to each other (e.g., such that they have overlapping or significantly overlapping fields of view). The cameras/sensors 1005A, 1005B and 1005C may be controlled by one or more processors disposed in the cavity of the frame 1004.

One example of the camera/sensor 1005A includes, but is not limited to, the Raspberry Pi Camera Module v2. The v2 Camera Module has a Sony IMX219 8-megapixel sensor and may be used to acquire high-definition video and/or still photographs. The sensor supports 1080p30, 720p60, and VGA90 video modes in addition to still capture. The sensor attaches to the camera serial interface (CSI) port on the Raspberry Pi via a 15 cm ribbon cable. The camera works with various Raspberry Pi models including, but not limited to the Raspberry Pi 1, 2, and 3. The camera 1005A may be accessed and controlled using the multimedia abstraction layer (MMAL) and video for Linux (V4L) API's. Additionally, numerous third-party software libraries may be used to control the camera 1005A in various software environments (e.g., Python using the Picamera Python library).

One example of the camera/sensor 1005B includes, but is not limited to, the infrared Camera Module v2 (Pi NoIR). The v2 Pi NoIR has a Sony IMX219 8-megapixel sensor, which is the same as the camera used in the Raspberry Pi Camera Module v2 of 100SA. The difference is that the Pi NoIR does not include an infrared filter (NoIR=No Infrared) and is thus able to acquire imagery of at least a portion of the infrared spectrum (e.g., NIR) In some implementations, the Pi NoIR may be used together with a square of blue gel to monitor the health of green plants. Similar to the Pi Cam, the Pi NoIR may with various Raspberry Pi models including, but not limited to the Raspberry Pi 1, 2, and 3. Also, the Pi NoIR camera may also be accessed and controlled in software using the MMAL and V4L API's as well as third-party libraries (e.g., Python using the Picamera Python library).

In some example implementations, the Pi NoIR Camera described above in connection with the camera 1005B may instead serve as the camera/sensor 1005A, such that the camera 1005A may be employed to capture images having spectral content in a range of approximately 356 nanometers through 950 nanometers (including the visible portion of the spectrum and at least a portion of the infrared spectrum, e.g., the NIR). In implementations in which the camera/sensor 1005A includes a broadband camera/sensor such as the Pi NoIR Camera, the camera/sensor 1005B may be a longwave IR thermal imager responsive to wavelengths in a range of from approximately 8 micrometers to approximately 14 micrometers (FIR). One example of such a thermal imager includes, but is not limited to, the FLIR Lepton 3.5 micro thermal imager, which provides 160×120 pixels of calibrated radiometric output.

One example of the IR single point sensor 1005C includes, but is not limited to, the Melexis MLX90614 infrared thermometer for non-contact temperature measurements. An IR sensitive thermopile detector chip and the signal conditioning application-specific integrated circuit (ASIC) are integrated in the same TO-39 can. The MLX90614 also includes a low noise amplifier, 17-bit analog-digital converter (ADC), and a powerful digital signal processor (DSP) unit to achieve a high accuracy and resolution for the thermometer. The thermometer may be factory calibrated with a digital SMBus output providing access to the measured temperature in the complete temperature range(s) with a resolution of 0.02° C. The digital output may be configured to use pulse width modulation (PWM). As a standard, the 10-bit PWM is configured to continuously transmit the measured temperature in range of −20° C. to 120° C., with an output resolution of 0.14° C.

In some implementations, the processor(s) may correspond to the processor 90 (e.g., the camera(s)/sensor(s) 1005 is/are coupled to the same circuitry board used to support the LED light source 400 and the various communication ports). In some implementations, the processor(s) associated with operation of the camera(s)/sensor(s) 1005 may be associated with one or more discrete circuit boards that are electrically coupled to the processor 90. For such cases, the processor 90 may be used to facilitate control of the camera(s)/sensor(s) 1005 via the respective processor(s). For example, the processor(s) may be Pi processor(s), which generally feature a Broadcom system on a chip (SoC) with an integrated advanced RISC machine (ARM)-compatible central processing unit (CPU) and on-chip graphics processing unit (GPU). Secure Digital (SD) cards may be used to store the operating system and program memory in either SD high capacity (SDHC) or MicroSDHC sizes. The boards may have multiple ports (e.g., one to four USB ports). HDMI and composite video may be supported for video output and a standard 3.5 mm tip-ring-sleeve jack for audio output. Lower-level output is provided by a number of GPIO pins, which support common protocols like PC. The B-models have an 8P8C Ethernet port and the Pi 3 and Pi Zero W have on-board Wi-Fi 802.11n and Bluetooth.

In some implementations, the one or more cameras and/or sensors 1005 may be packaged as a separate module for ease of assembly and/or installation in connection with the lighting fixture 1000. Such a camera/sensor module may be mechanically mounted directly to the frame 1004 of the lighting fixture 1000 and electrically coupled to other systems in the lighting fixture 1000 (e.g., a cable or wire connecting the module to the processor 90). In one aspect, a separate module may make it easier to package the cameras/sensors 1005 and protect various components from exposure to water and/or moisture in the environment. In some implementations, multiple modules may be disposed on the frame 1004 where each module may contain one or more cameras/sensors 1005. A module with one set of cameras/sensors 1005 may also be readily replaced with another module with another set of cameras/sensors 1005. In this manner, the lighting fixture 1000 may be modular in design, thus enabling the installation of different modules with different functionalities on to the same frame 1004 during initial assembly of the lighting fixture 1000 and/or post-assembly (to change/update the modules after deployment).

In another exemplary implementation, FIGS. 7E-7P show several views of a lighting fixture 1000 equipped with cameras/sensors 1005 as introduced in the discussion above, in which the cameras/sensors are integrated as a module serving as a multispectral imaging system 1100 (also referred to herein as the “imaging system 1100”). As shown in the figures, in one example implementation the imaging system 1100 may be directly mounted to the frame 1004 between the LED light sources 400A and 400B. The lighting fixture 1000 may also include onboard cooling (e.g., cooling pipes 1006A and 1006B) and various communication ports (PoE ports 1008A-1008C, USB ports 1012A) for data transfer between the lighting fixture 1000 and another device (e.g., another lighting fixture 1000, a remote device, an accessory). As shown in the cross-sectional views of FIGS. 7N-7P, the imaging system 1100 may include electronic circuitry. In some implementations, the imaging system 1100 may be electrically coupled to other components of the lighting fixture 1000 (e.g., control circuitry boards 100, 200, 300) to receive power and/or to transfer data to/from the imaging system 1000.

The imaging system 1100 may be used to characterize the growth and/or health of plants in the environment over time. This may be accomplished, in part, by utilizing the imaging system 1100 by itself or in conjunction with one or more light sources (e.g., LED light sources 400A-400C) to irradiate plants and/or other subjects of interest with different wavelengths of radiation, and measure the spectral optical properties of the plants and/or other subjects of interest in their surroundings (e.g., in the environment of the lighting fixture 1000) over time, in response to irradiation at different wavelengths. The foregoing process may be referred to as “kinetic finite absorbance and reflectance spectroscopy,” in which different finite spectra images and/or other information are collected for plants and/or other subjects of interest in response to irradiation at particular wavelengths, as a function of time, and then the acquired images/collected information are analyzed to determine physical changes in the plants and/or other subjects of interest.

As discussed further below, in one example implementation the imaging system 1100 may include one or more relatively narrow band or essentially monochromatic irradiators (e.g., also referred to herein as “flashes”). These irradiators may be controlled to provide irradiation (a “flash”) of one or more plants and/or other subjects of interest while one or more of the cameras/sensors of the imaging system 1100 are operated to acquire an image and/or other information regarding the subject of interest irradiated by the relatively narrowband or essentially monochromatic flash.

The spectral optical properties of plants, as measured by the imaging system 1100, may be used to detect and quantify various chemical compounds related to plant development. For example, FIG. 7Q shows the spectral absorptive properties of various types of chlorophyll compounds. As shown, the various chemical compounds exhibit different absorption peaks, which may be used to identify and distinguish between the compounds. The presence of these compounds may vary between different plant species. For a particular plant species, the amount of these compounds relative to a nominal baseline, as measured by the imaging system 1100, may provide valuable information on various aspects of the plant's development including, but not limited to, the stage of development, prospective crop yield, appearance, nutritional composition, structural integrity, flowering, and pollination.

In one example, the light source may illuminate the plants with substantially broadband light (e.g., a white light source). In this case, the imaging system 1100 may include a spectrometer (e.g., an onboard monochromator) that measures the spectral reflective properties of the plants by separating the spectral components of the broadband light reflected by the plants. In another example, the light source may illuminate the plants with substantially monochromatic light at a particular wavelength and the imaging system 1100 may measure the amount of light reflected by the plants (e.g., a single point measurement, an image of the plants) at that wavelength. The emission wavelength of the light source may be tunable. Thus, the imaging system 1100 may acquire the spectral reflective properties of the plants at different wavelengths by adjusting the wavelength of light illuminating the plants. For this case, the imaging system 1100 may acquire the spectral properties of the plants without the use of a filter.

The data collected by the imaging system 1100 may be used to monitor the development of the plants and/or to provide feedback to adjust other components of the lighting fixture 1000 (e.g., the total intensity or spectral intensity of the light emitted by the LED light sources 400) in order to improve the health and growth of the plants. For example, if the imaging system 1100 detects damage to the plants caused by pests, the lighting fixture 1000 may be adjusted to illuminate the plants with more UV light as a form of repellant. In another example, the imaging system 1100 may acquire data over time to assess changes to the plant during a typical day/night cycle (e.g., blooming for short day/long day plants). This information may be used to alter when the plant blooms by adjusting the lighting fixture 1000 to illuminate the plants with more/less near infrared light (e.g., 730 nm light). In this manner, plants may be grown at a faster rate.

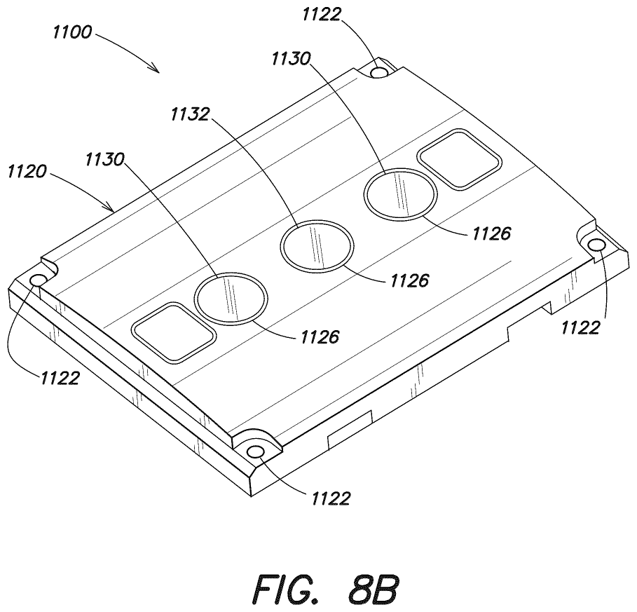

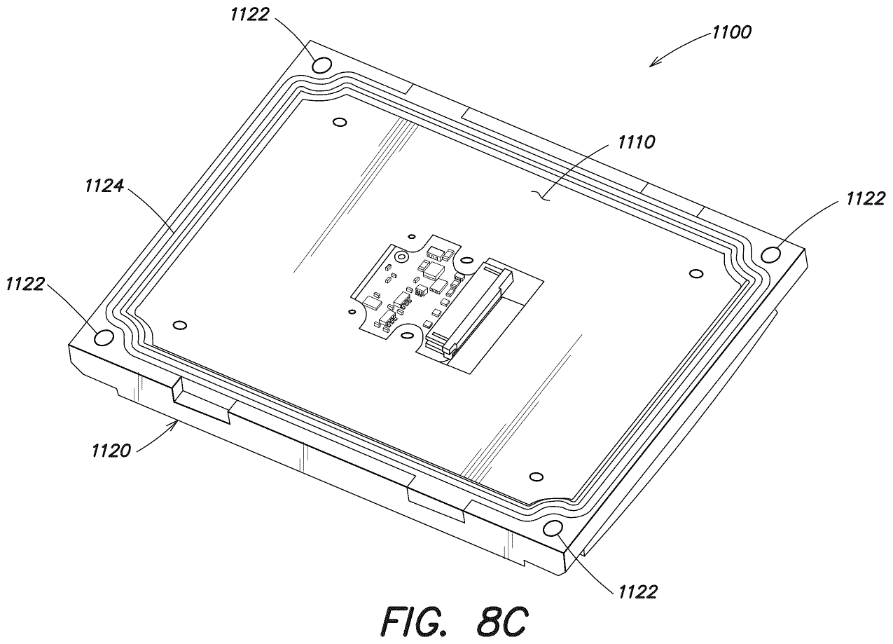

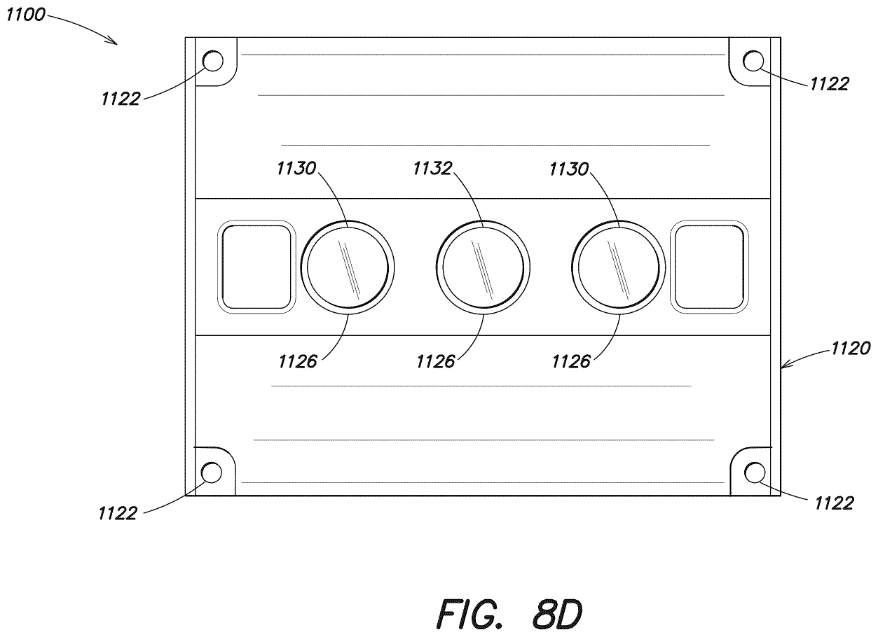

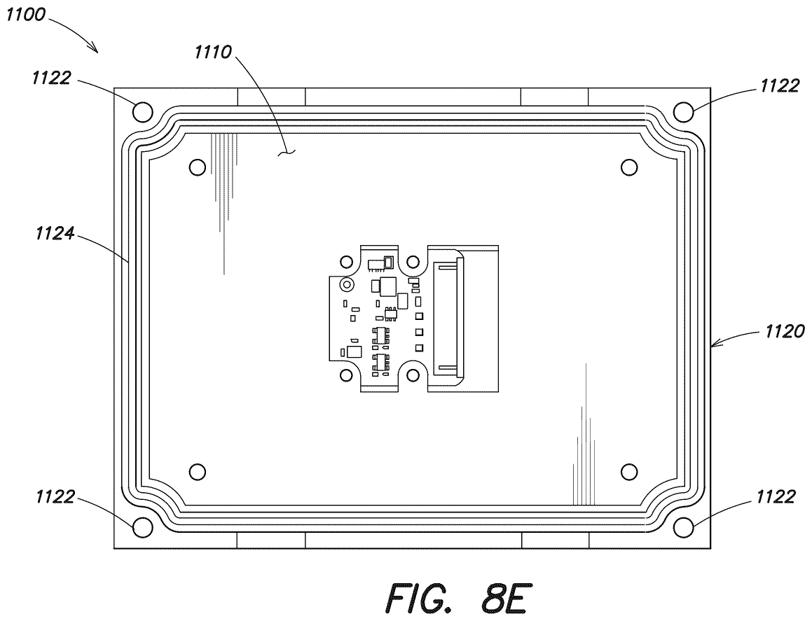

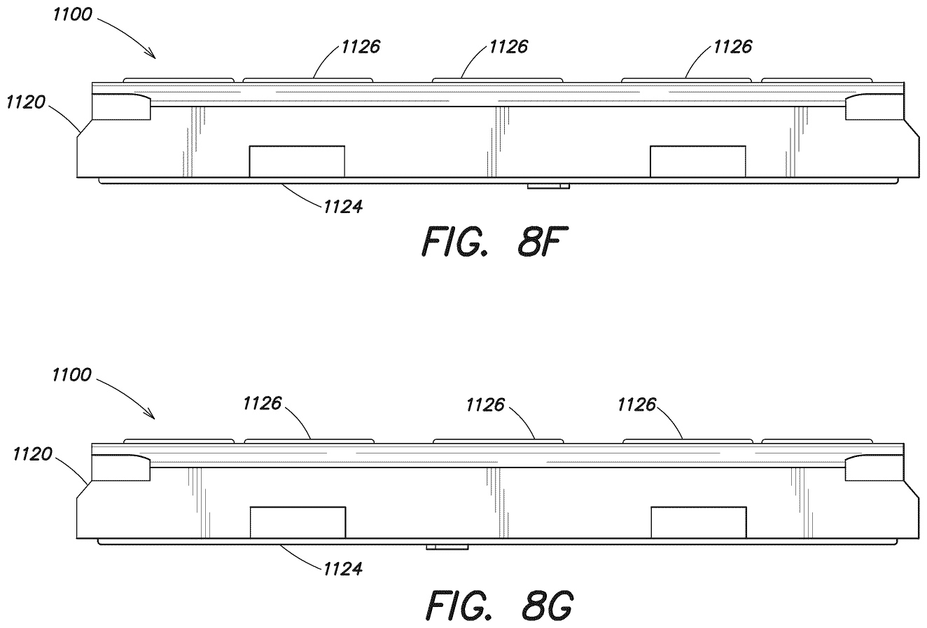

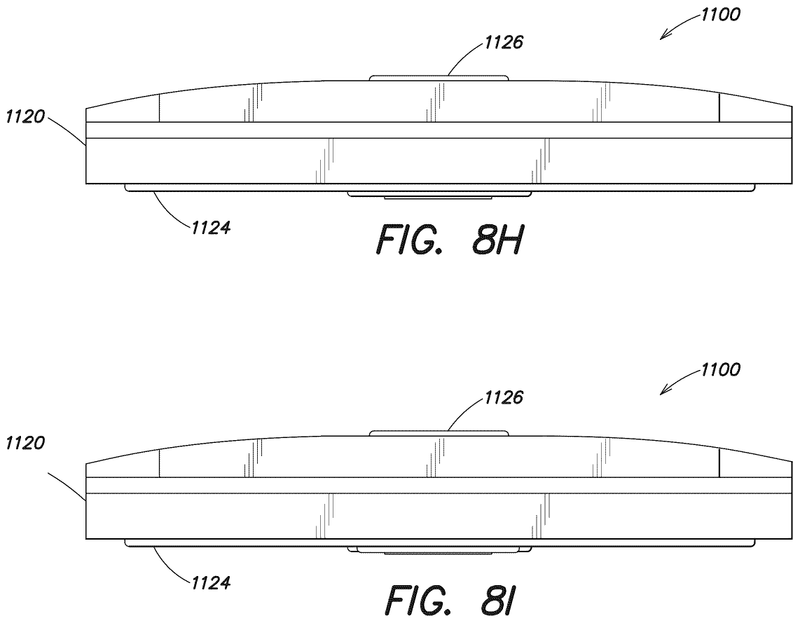

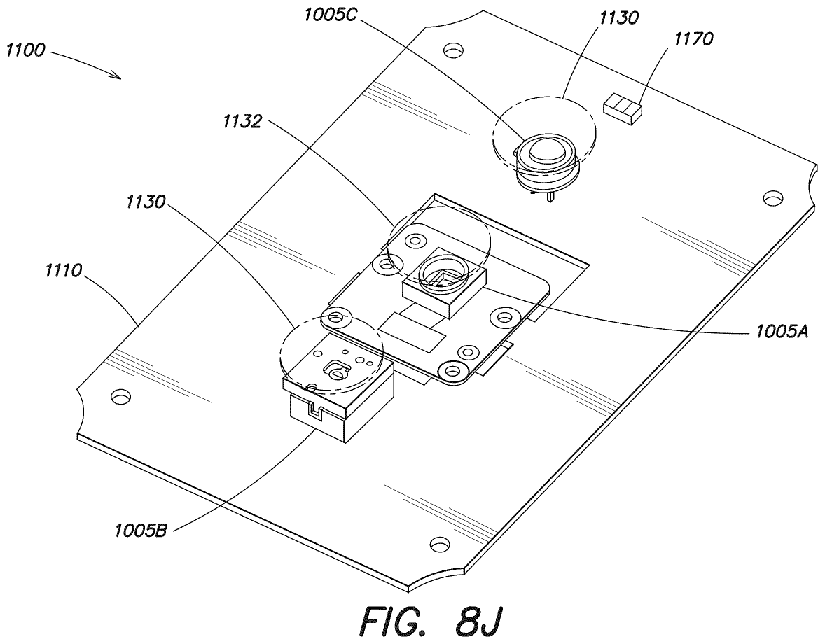

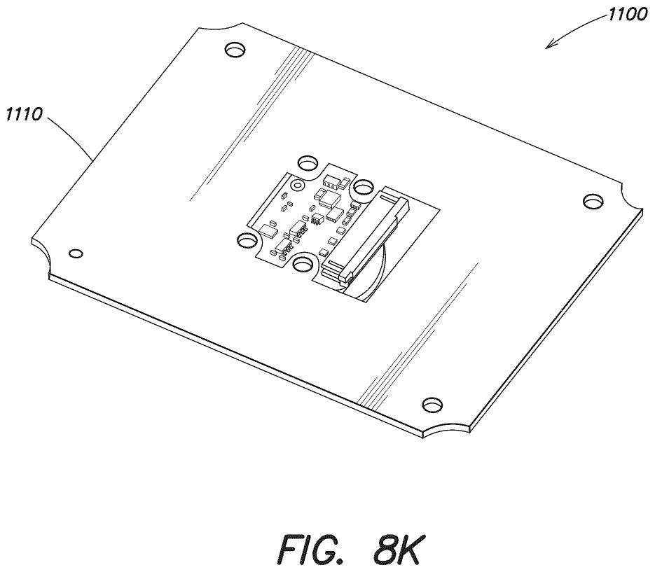

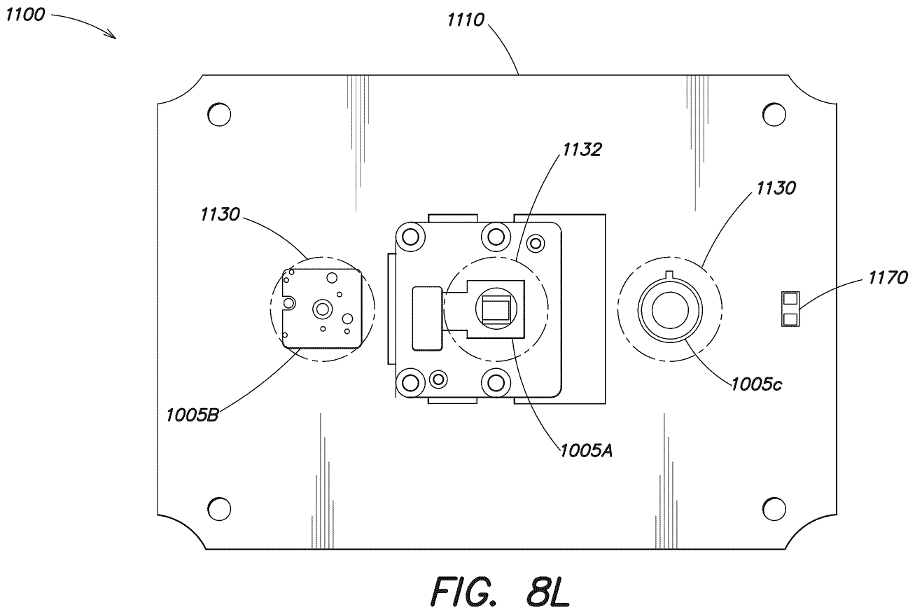

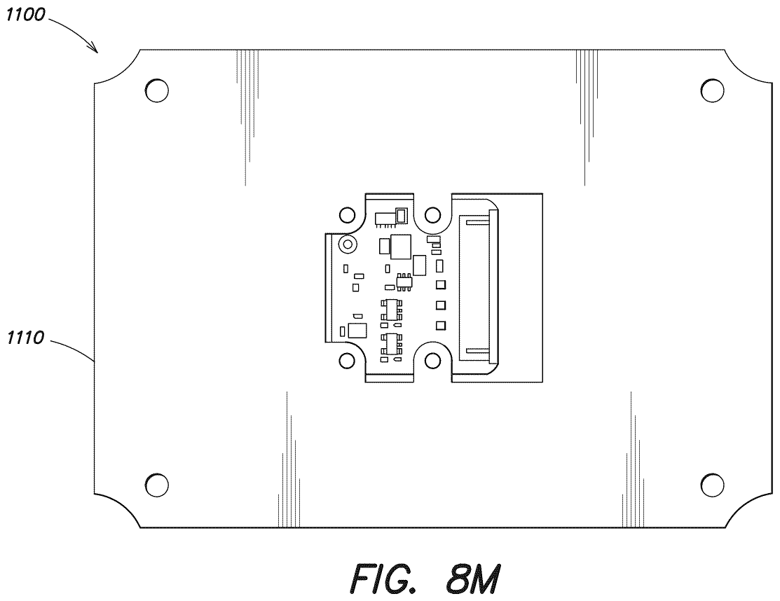

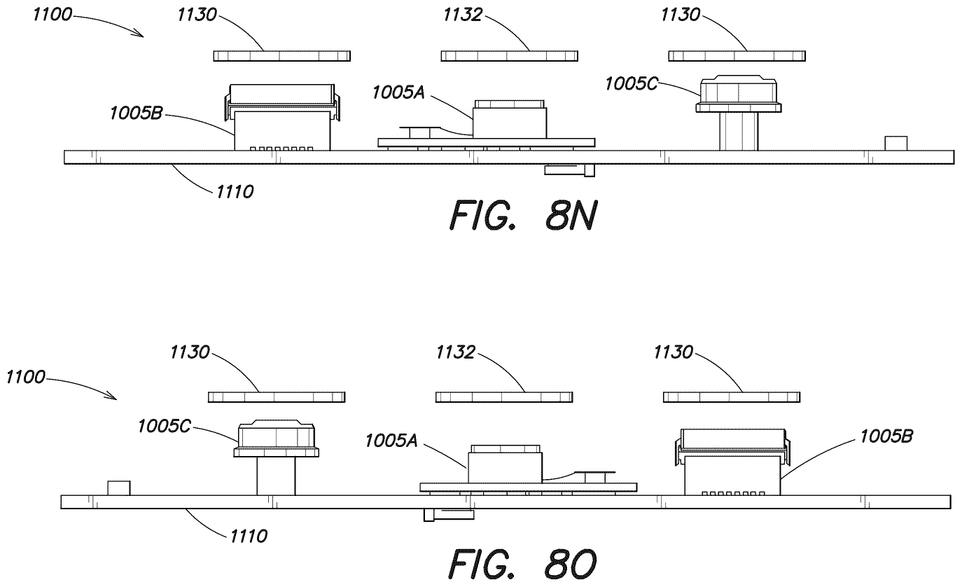

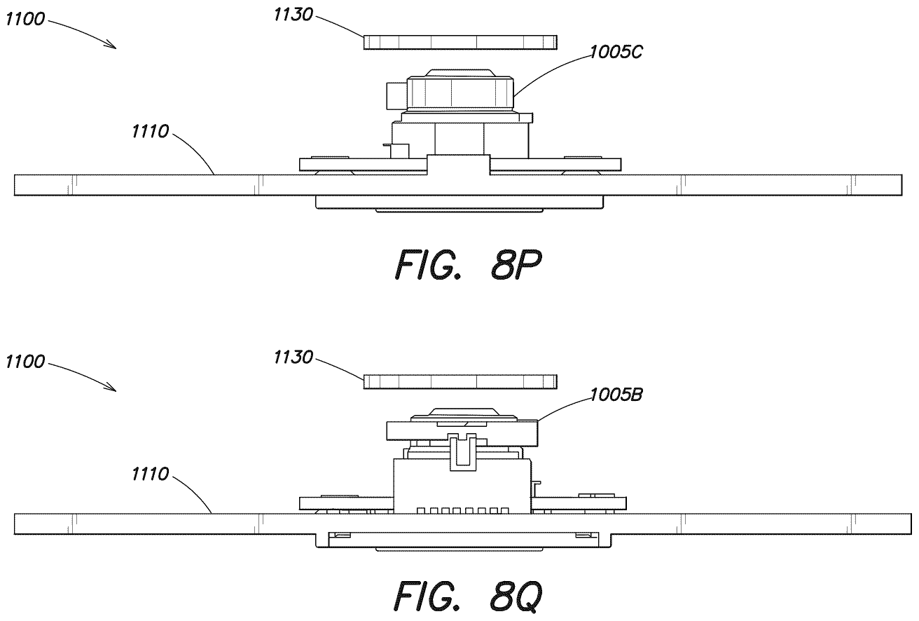

FIGS. 8A-8I and 8J-8Q show several views of the multispectral imaging system 1100 according to example inventive implementations with and without a housing 1120, respectively. As shown, the imaging system 1100 may include a circuit board 1110 that supports the cameras/sensors 1005A, 1005B and 1005C previously described. The imaging system 1100 may also include LED arrays 1140A and 1140B (collectively referred to as LED array 1140) to irradiate the plants with radiation at various wavelengths to facilitate acquisition of one or more corresponding multispectral images (in which radiation reflected or otherwise emitted by the subject plant(s) is sensed/captured by one or more of the cameras/sensors upon exposure to one or more flashes from an LED/LEDs having particular wavelength(s) of radiation). Thus, the imaging system 1100 provides both multispectral irradiation and sensing in a single, self-contained device. The imaging system 1100 may also include supplementary LED arrays 1150A and 1150B (collectively referred to as supplementary LED array 1150) to augment the LED array 1140 and/or to alter the chemical/morphological properties of the plants. The imaging system may also include a single point laser rangefinder 1170. The circuit board 1110 may include power electronic circuitry 1160 to support the operation of the LED arrays 1140 and 1150, cameras/sensors 1005, laser rangefinder 1170, and other components of the imaging system 1100. The imaging system 1100 may include the housing 1120 to protect the cameras/sensors 1005A, 1005B, and 1005C, the LED arrays 1140 and 1150, and other electronics from the surrounding environment.

The LED array 1140 may include one or more LED elements 1142. Each LED element 1142 of the array 1140 may emit radiation at a particular band of wavelengths or an essentially monochromatic wavelength and may be controlled independently from the other LED elements 1142. When one or more LED elements 1142 are operated to irradiate a desired portion of the environment (e.g., the plants below the lighting fixture 1000) with relatively narrow band or substantially monochromatic radiation, one or more of the cameras/sensors 1005 (e.g., camera 1005A) acquires a corresponding image that contains radiation reflected or otherwise emitted by the plant subjects in the field of view in response to exposure to radiation at the corresponding wavelength(s) of the operated LED element(s). Different LED elements 1142 may be activated to illuminate the desired portion of the environment with radiation at different wavelengths and the cameras/sensors 1005, in turn, may acquire corresponding images or other sensed information relating to reflected and/or emitted radiation resulting from the respective different wavelengths/wavelength bands of the activated LED elements. In some example implementations, after acquiring images and/or other information at multiple wavelengths/wavelength bands, a multispectral image may be formed by aligning and superimposing the respective acquired images onto each another. In this manner, the multispectral image may include spatial and spectral information regarding the desired portion of the environment (e.g., each pixel of the multispectral image contains corresponding spectral data).

The imaging system 1100 may generally include one or more LED arrays 1140. Each LED array 1140 may include one or more LED elements 1142. For instance, each LED array 1140 may include between about 1 to about 100 LED elements 1142. The LED elements 1142 in the LED array 1140 may be disposed proximate to each other on the circuit board 1110. The LED arrays 1140 may be arranged on the circuit board 1110 to provide a desired illumination profile. For example, the LED arrays 1140A and 1140B may include the same type of LED elements 1142, thus providing multiple radiation sources that emit radiation at the same wavelength. FIG. 8A shows the LED arrays 1140A and 1140B may be disposed on opposing sides of the camera 1005A. By irradiating the plants and/or their surroundings with radiation from opposing sides of the camera 1005A, the camera 1005A may acquire images under more uniform irradiation. Other illumination profiles may be achieved with different arrangements and/or using an optical element (e.g., shaping a portion of the housing 1120 in front of the LED array 1140, placing a separate diffuser or lens onto the LED array 1140).

The LED array 1140 may generally include LED elements 1142 that respectively emit radiation at different wavelengths. For example, the LED elements 1142 may emit radiation at wavelengths ranging between about 200 nm to about 2 μm. The number of LED elements 1142 and the wavelengths at which they emit light may be chosen, in part, based on known spectral absorption peaks of various chemical compounds associated with the plants (see FIG. 7Q) and/or other subjects of interest in the environment of the lighting fixture 1000. For example, the LED elements 1142 may be chosen to cover the absorption peaks of several different types of compounds from the UV to the NIR wavelength ranges. In some implementations, it may be preferable to use LED elements 1142 with a smaller spectral bandwidth (e.g., essentially monochromatic radiation) in order to provide greater spectral resolution when acquiring multispectral images of the plants and/or other subjects. For example, the spectral bandwidth of one or more of the LED elements 1142 considered to be essentially monochromatic may be less than about 50 nm. Other LED elements 1142 may emit radiation in a broader range of wavelengths; for example, one or more of the LED elements 1142 may be a white LED in which the generated radiation covers a band of wavelengths and may be specified as corresponding to a particular color temperature.

In some implementations, the LED elements 1142 respectively may be activated for a relatively short time period (i.e., turning on and off quickly) in succession (and optionally according to some pattern or order), thus exposing the plants to a brief “flash” of light when acquiring various information relating to reflected radiation using the camera(s)/sensor(s) 1005. For example, the LED elements 1142 may emit radiation for a duration of less than about 1 second. Activating the LED elements 1142 in this manner may have multiple benefits including, but not limited to (1) reducing the time delay between acquiring images/information at different wavelengths so that the multiple images/information acquired are representative of the same environmental conditions and (2) reducing the duration in which the plants and/or other imaging subjects are exposed to radiation. In some implementations, the camera(s)/sensor(s) 1005 may be synchronized with the LED elements 1142 such that the camera(s)/sensor(s) 1005 is/are triggered to acquire an image/information when the LED elements 1142 are activated. In this manner, a series of images/information may be collected by sequentially flashing the plants with radiation from different LED elements 1142 and capturing an image/information during each flash using the camera(s)/sensor(s) 1005. In yet other implementations, multiple LEDs having different spectral outputs may be activated together while one or more images and/or other information is acquired relating to radiation absorbed and/or reflected by the irradiated plants and/or other subjects.

In one example implementation, respective wavelengths of essentially monochromatic LED elements 1142 of the LED array 1140 may include, but are not limited to, 365 nm, 450 nm, 530 nm, 620 nm, 630 nm, 660 nm, 730 nm, 850 nm, 860 nm, 940 nm, and 950 nm. More generally, the LED elements 1142 of the LED array 1140 may have radiation wavelengths between approximately 365 nm to 540 nm, and between approximately 605 nm to 1100 nm.

In some implementations, it may be preferable for the LED elements 1142 in the LED array 1140 to emit radiation with a sufficient intensity to acquire images/information at a desired quality (e.g., the signal-to-noise ratio of the image/information is above a pre-defined threshold) without causing chemical and/or morphological changes to the plant (e.g., photomorphogenesis). In this manner, the various images/information acquired by the camera(s)/sensor(s) 1005 are representative of the plant in their non-illuminated state. For example, the LED elements 1142 may have a wattage rating less than about 6 Watts (the wattage rating may be correlated to the radiation output from the LED elements 1142).

The supplementary LED array 1150 may include additional LED elements 1152. The LED elements 1152 may have one or more of the same features as the LED elements 1142 described above. In one example, the LED elements 1152 may emit radiation at one or more of the same wavelengths as the LED elements 1142 in order to increase the overall intensity of radiation when acquiring images/information relating to the irradiated plants/other subjects (i.e., both LED elements 1142 and 1152 are activated). In some implementations, the LED elements 1152 may provide a radiation output greater than the LED elements 1142. For example, the LED elements 1152 may have a wattage rating greater than about 6 Watts. The higher radiation output provided by the LED elements 1152 may be used, in part, to intentionally induce chemical and/or morphological changes to plants in the environment. For example, the LED elements 1152 may provide a higher radiation output at 730 nm in order to alter the day/night cycle of the plants (e.g., changing when the plant blooms). In another example, the LED elements 1152 may provide UV light to ward off pests in the environment.

The housing 1120 may be used, in part, to enclose and protect the various components of the imaging system 1100 and to facilitate installation of the imaging system 1100 onto the frame 1004 of the lighting fixture 1000. For example, FIGS. 8A-8E show the housing 1120 includes multiple openings 1122 at each corner that align with a corresponding set of holes on the frame 1004 (not shown) to facilitate attachment via one or more bolts or screw fasteners, for example. In some implementations, the housing 1120 may form a substantially sealed enclosure in order to prevent moisture and/or water from contacting the various electronics, cameras, and sensors on the circuit board 1110. As shown in FIGS. 8C and 8E, the housing 1120 may include a groove along its periphery to support a gasket 1124. When the housing 1120 is coupled to the frame 1004, the gasket 1124 may deform to form a seal. In some implementations, the housing 1120 may form a substantially watertight seal with the frame 1004.

The housing 1120 may be formed from various plastic and/or ceramic materials. In some implementations, the housing 1120 may be formed from a material that is substantially transparent to light at wavelengths corresponding to at least the emission wavelengths of the LED elements 1142 and 1152. Thus, radiation emitted by the LED elements 1142 and 1152 may transmit through the housing 1120 when irradiating the plants and/or the surrounding environment. In some implementations, the housing 1120 may be shaped to redirect radiation emitted by the LED elements 1142 and 1152 along a desired direction. For example, the housing 1120 may be shaped to redirect radiation emitted at wider angles towards the plants disposed directly below the lighting fixture 1000 in order to more efficiently use the radiation for imaging/information acquisition. In some implementations, the surface finish of the housing 1120 may be altered to disperse radiation (e.g., a substantially smooth finish to provide specular illumination or a substantially rough finish to provide diffuse illumination).

In some implementations, the housing 1120 may be formed from a material that is not sufficiently transparent across the wavelength range of interest. For example, the camera 1005A may acquire imagery/information from the UV to NIR ranges while the camera 1005B may acquire imagery/information in the MIR and FIR ranges. Materials are typically not transparent across such a large wavelength range. Furthermore, in some instances parasitic absorption by the housing 1120 may affect the data collected by the camera(s)/sensor(s) 1005. In view of the foregoing, the housing 1120 may include multiple openings 1126 disposed near the camera(s)/sensor(s) 1005 that are shaped to support various optical elements tailored for the appropriate wavelength ranges of each camera/sensor 1005.

For example, FIGS. 8B and 8D show a germanium (Ge) window 1130 may be installed into the openings 1126 located directly above the camera 1005B and the sensor 1005C. The Ge window 1130 may be used, in part, as an infrared filter that substantially reduces (attenuates) the transmission of higher frequency (shorter wavelength) radiation, thus ensuring the camera 1005B and the sensor 1005C receive infrared light in the MIR and FIR ranges. Similarly, a glass window 1132 may be disposed in the opening 1126 located directly above the camera 1005A to transmit UV to NIR radiation. In some implementations, the Ge window 1130 and glass window 1132 may include an anti-reflection coating to increase the amount of light transmitted and detected by the respective camera(s)/sensor(s) 1005. It should be appreciated that the Ge window 1130 and glass window 1132 are two exemplary materials and may be substituted with other materials suitable for the respective wavelength range(s) of interest. For example, a zinc selenide (ZnSe) window may be used for the IR range. Magnesium fluoride (MgF₂), sapphire (Al₂O₃), and calcium fluoride (CaF₂) may be used for the UV and NIR ranges.

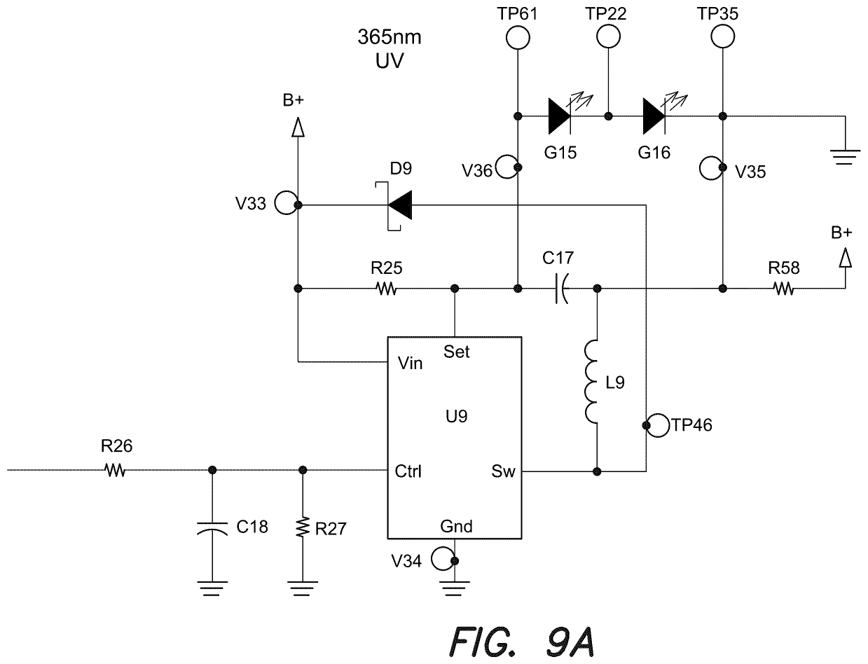

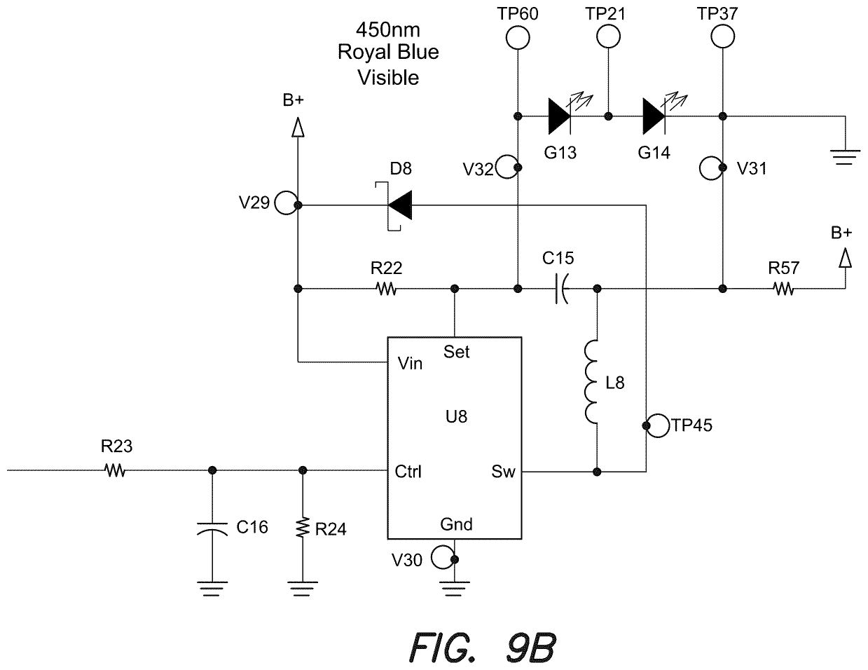

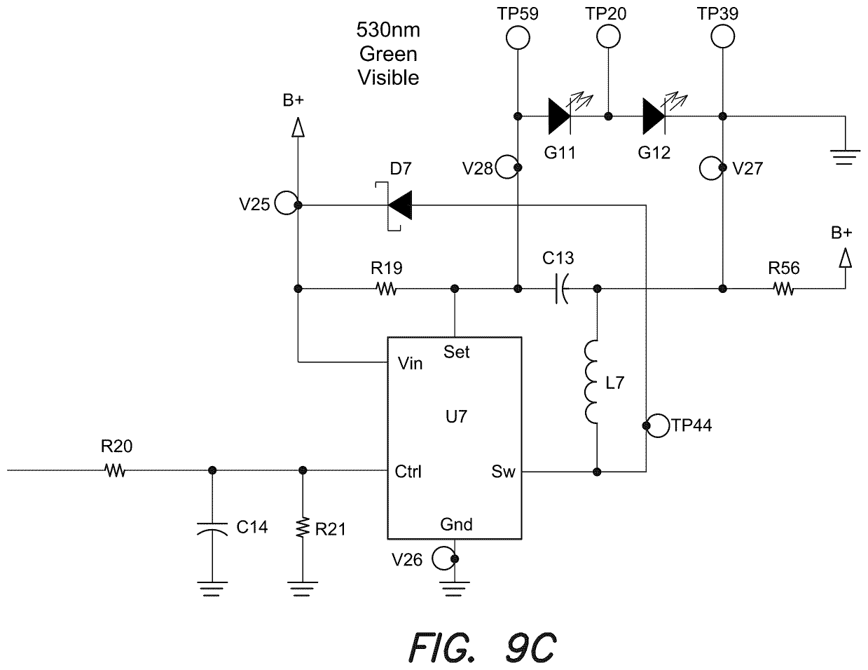

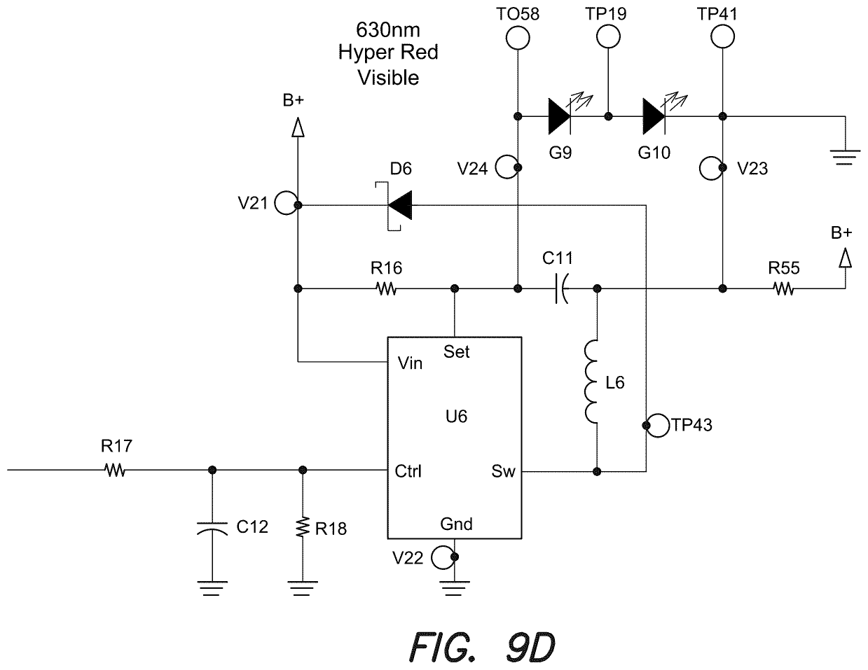

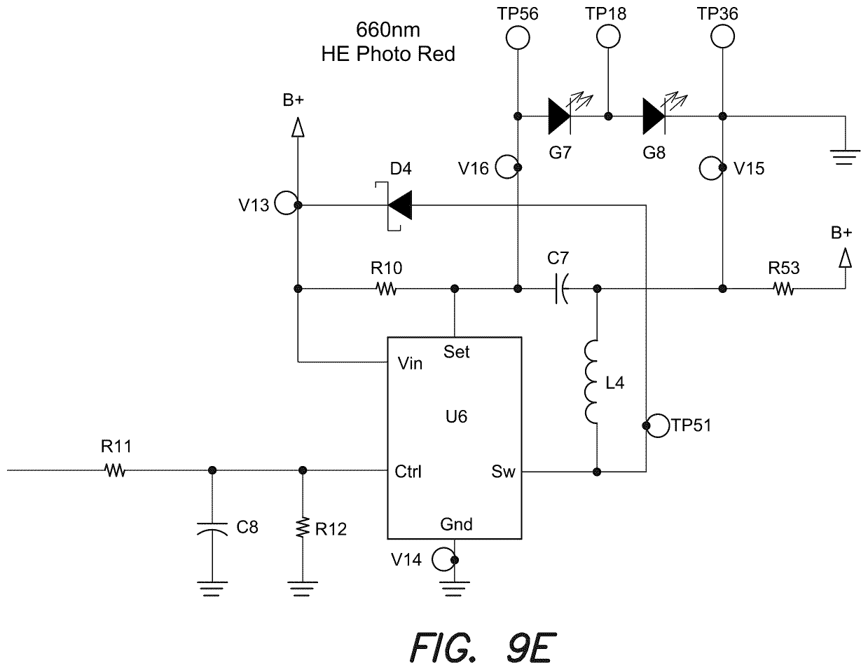

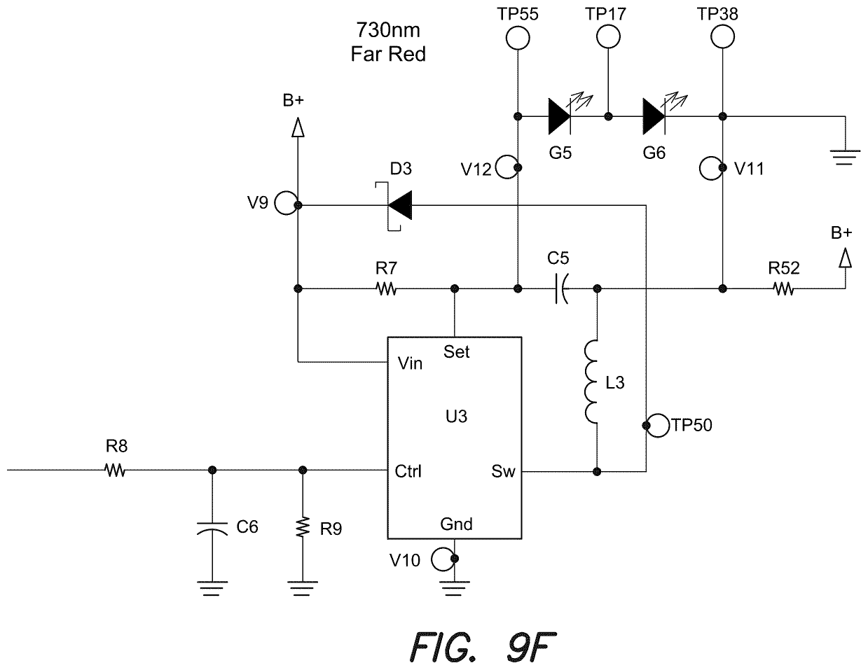

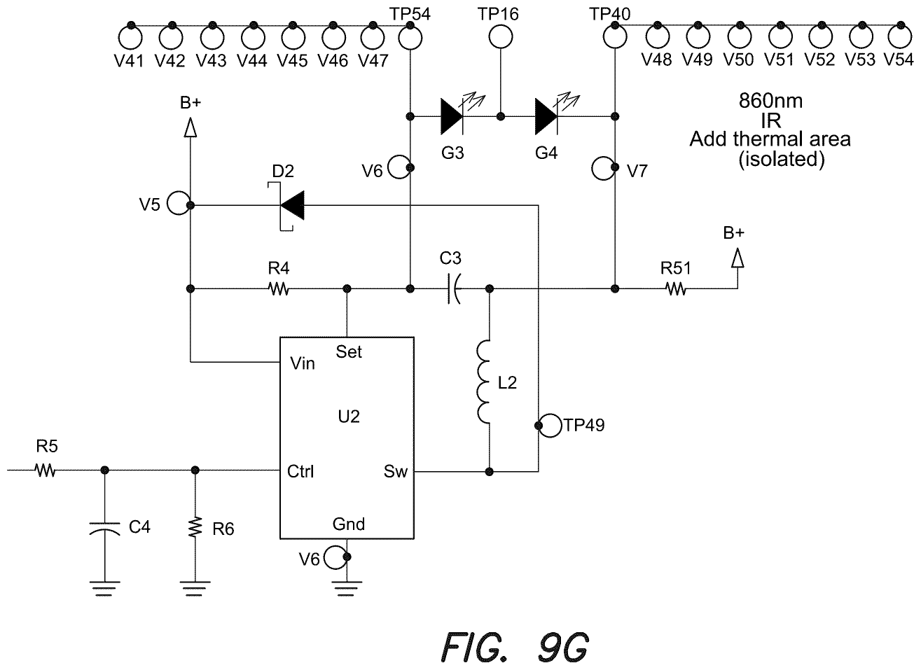

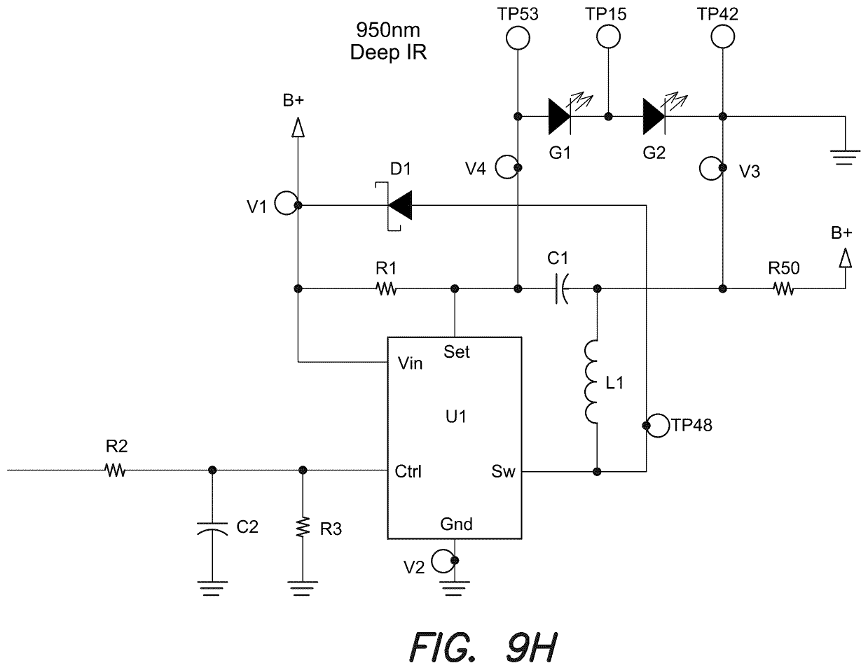

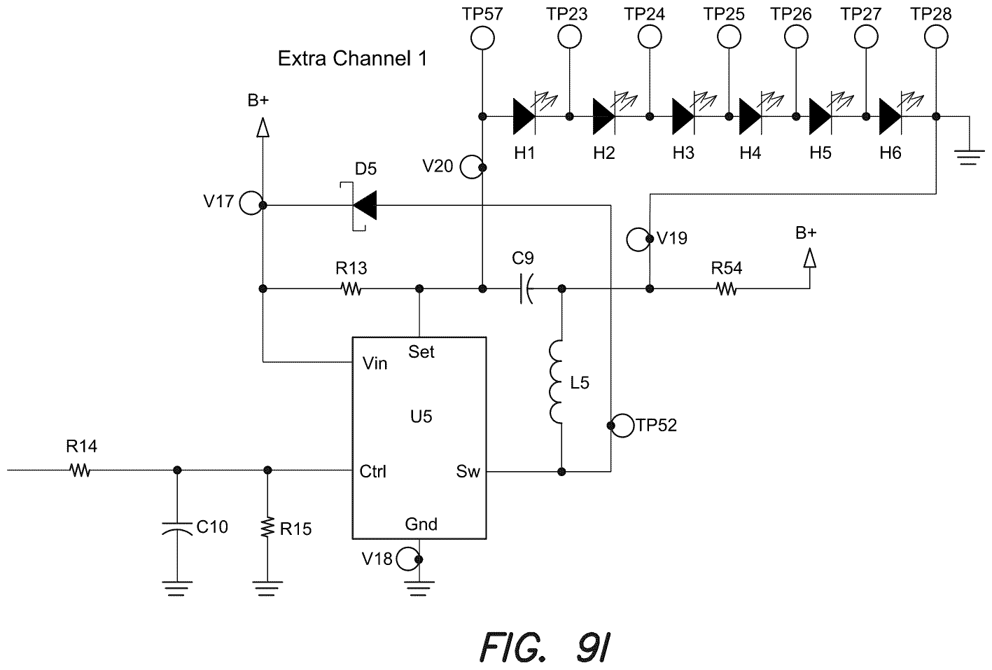

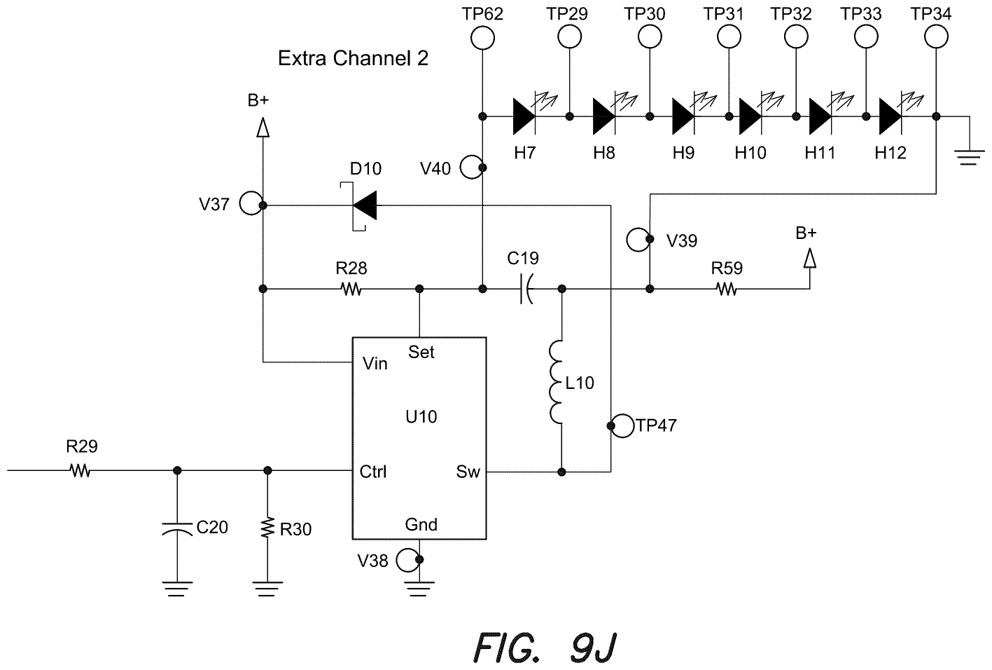

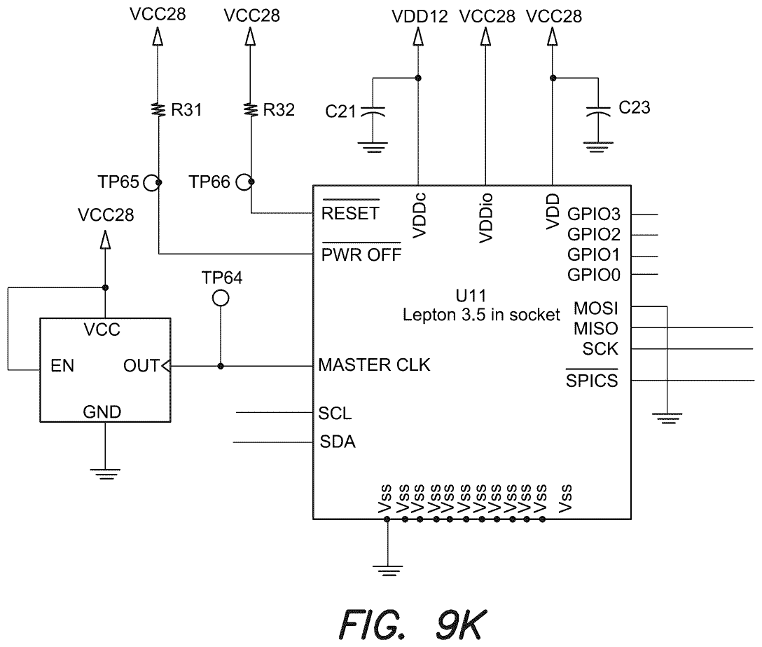

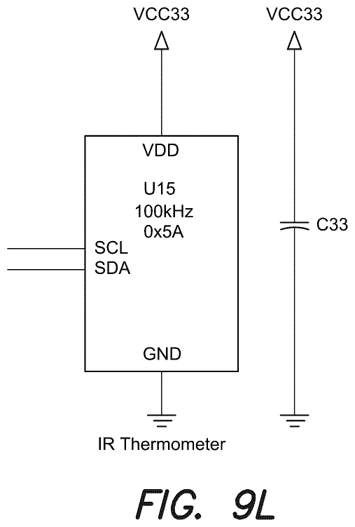

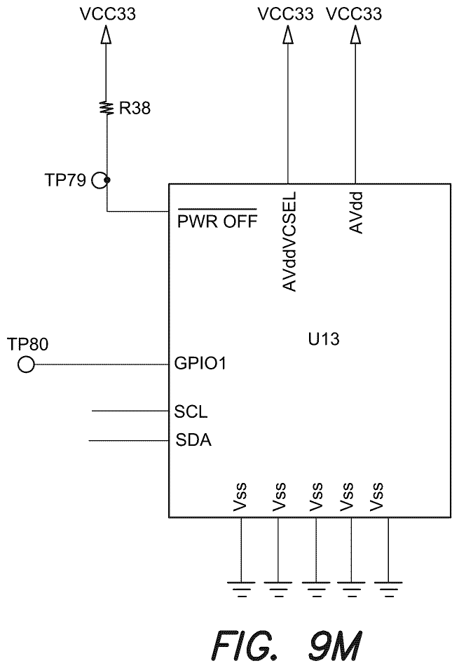

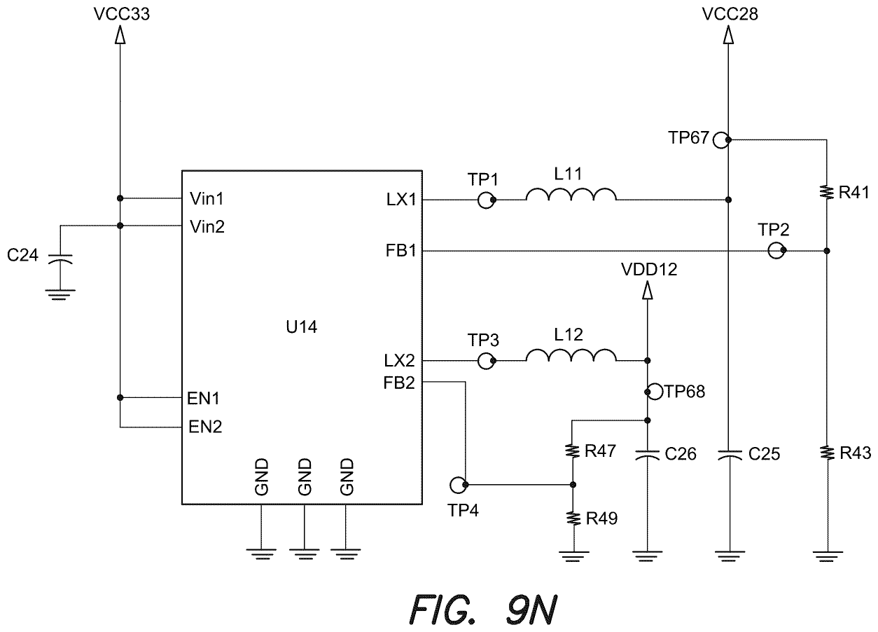

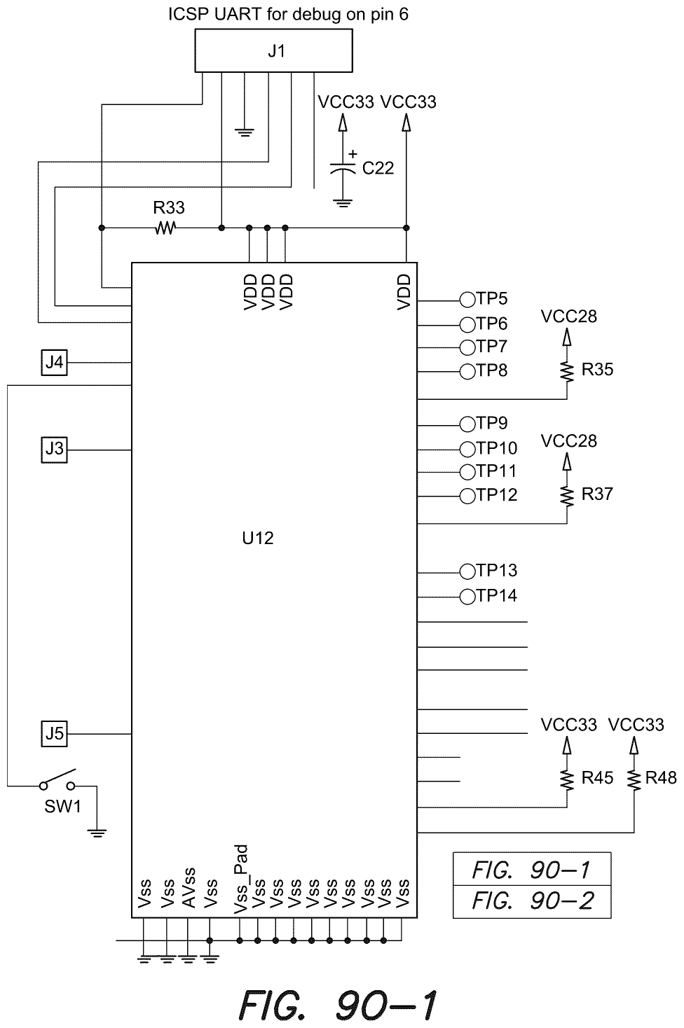

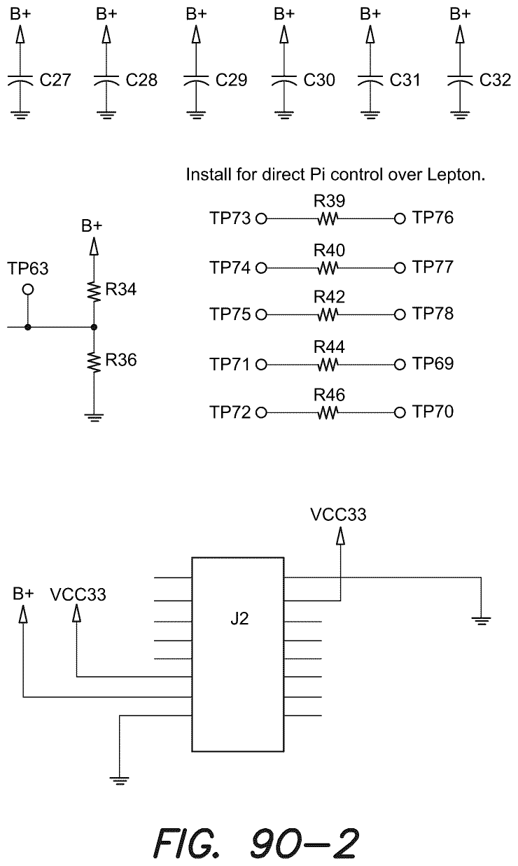

FIGS. 9A-9O-2 show circuit diagrams for various components in the imaging system 1100 according to one exemplary implementation. FIGS. 9A-9H show circuit diagrams of respective drivers for a 365 nm ultraviolet (UV) LED, a 450 nm royal blue LED, a 530 nm green LED, a 630 nm red LED, a 660 nm red LED, a 730 nm far red LED, an 860 nm infrared LED, and a 950 nm infrared LED, respectively, which form the LED array 1140. FIGS. 9I and 9J show circuit diagrams for additional channels that may be used to support extra LED elements 1142. FIG. 9K shows a circuit diagram of a Lepton 3.5 socket used for IR imaging (e.g., the camera/sensor 1005B). FIG. 9L shows a circuit diagram of an infrared thermometer (e.g., the sensor 1005C). FIG. 9M shows a circuit diagram of a VL53LIX time-of-flight proximity sensor (e.g., see the single point laser rangefinder 1170 shown in FIG. 8A). FIG. 9N shows a circuit diagram of a RT8020 pulse-width-modulated (PWM) converter. FIGS. 90-1 and 90-2 shows a circuit diagram of a digital signal converter to support the various components of the imaging system 1100.

Exemplary Lighting Systems with the Lighting Fixture

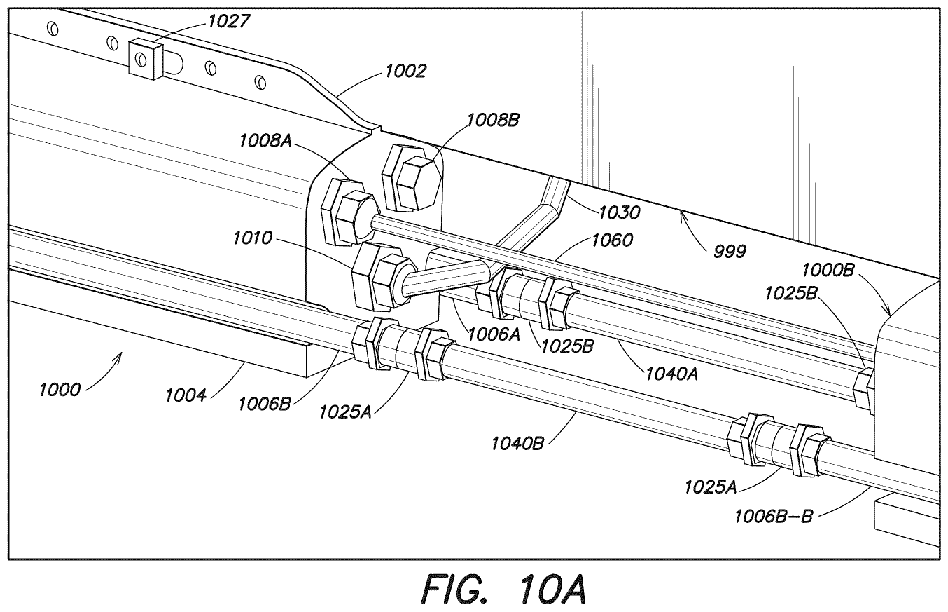

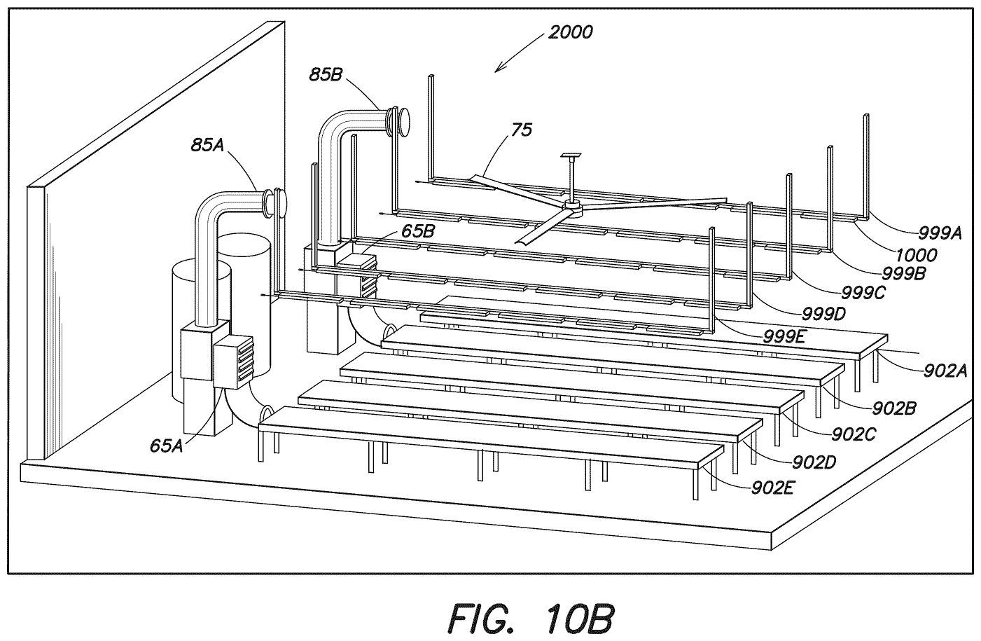

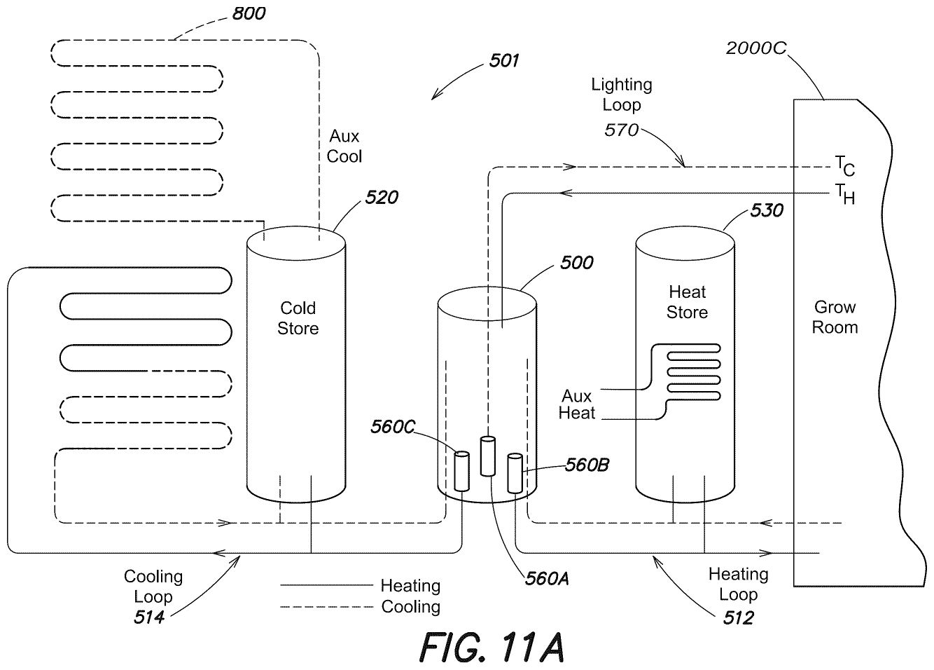

As described above, the lighting fixture 1000 may be coupled to other lighting fixtures 1000 in a daisy-chain configuration where electrical and piping connections are shared to facilitate assembly of a continuous electrical circuit and coolant circuit. For the coolant circuit, the daisy-chain configuration may be in series where the fluid coolant 800 exiting from one lighting fixture 1000 flows into a subsequent lighting fixture 1000 within the daisy-chain. The temperature of the fluid coolant 800 may increase further due to heat generated from the LED modules 400 of the subsequent lighting fixture 1000. It should be appreciated that so long as the temperature of the coolant fluid 800 is less than the temperature of the LED modules 400 in the lighting fixture 1000, the fluid coolant 800 may still capture heat from the lighting fixture 1000. Furthermore, in some implementations, heat rejection devices may be interspersed along the coolant circuit to reduce the temperature of the fluid coolant 800 and maintain sufficient heat dissipation as the fluid coolant 800 passes through multiple lighting fixtures 1000. An exemplary implementation detailing the manner in which two lighting fixtures 1000 and 1000-B may be coupled in a daisy-chain configuration is shown in FIG. 10A. In some implementations, the lighting fixture 1000 may be coupled to a support structure 999 using a bolt fastener 1027 placed through a hole in the light spine 1002 and secured to the side of the support structure 999 as shown in FIG. 10A.

The coolant pipes 1006A and 1006B of the lighting fixture 1000 may be coupled to a corresponding set of coolant pipes 1006A-B and 1006B-B from the other lighting fixture 1000-B using one or more intermediate pipes. As shown in FIG. 10A, the pair of coolant pipes 1006B and 1006B-B (1006A and 1006A-B) may be connected via a single intermediate pipe 1040B (1040A). Each intermediate pipe 1040B (1040A) may have push-to-connect fittings 1025A (1025B) disposed on both ends to facilitate connection to the coolant pipes 1006B and 1006B-B (1006A and 1006A-B). The shape of the intermediate pipe may vary depending on the desired distance and orientation between lighting fixtures 1000 and 1000-B. For example, the length of the intermediate pipe may be longer in order to space the lighting fixtures 1000 and 1000-B further apart to provide greater areal coverage or to traverse a gap separating two separate growing areas. In another example, the intermediate pipe may be curved such that the lighting fixtures 1000 and 1000-B are oriented at an angle relative to one another, e.g., 90 degrees, to accommodate variable shaped growing areas. In yet another example, the intermediate pipe may be substantially U-shaped to couple two parallel rows of lighting fixtures 1000 where the lighting fixtures 1000 and 1000-B are the last lighting fixtures 1000 in each respective row. In this manner, the coolant circuit may be continuous for multiple rows of lighting fixtures 1000.

Electrical power may be supplied to multiple lighting fixtures 1000 through a single power cable. An exemplary power cable 1030 coupled to the lighting fixture 1000 is shown in FIG. 10A. In some implementations, the power cable 1030 may be rated to support a particular electrical power and current input. For example, the power cable 1030 may be rated to supply at least 1000 W of electrical power and up to 15 A of current. Depending on the power and current requirements of the lighting fixture 1000, the power cable 1030 may be used to power multiple lighting fixtures 1000, thus reducing the amount of cabling and the number of electrical terminals (e.g., electrical outlets) that need to be installed in the controlled agricultural environment.

The lighting fixture 1000 may also be communicatively coupled to another lighting fixture 1000 to facilitate transmission of data and control signals to multiple lighting fixtures 1000. As shown in FIG. 10A, an Ethernet cable 1060 may be used to couple the PoE port 1008A of lighting fixture 1000 to the PoE port 1008C-B of lighting fixture 1000-B. Each of the lighting fixtures 1000 and 1000-B may include a processor to manage the flow of data and/or control signals. In some implementations, the lighting fixture 1000 may be used as a piggyback to facilitate the transfer of data and/or control signals to another lighting fixture 1000 located further along the daisy-chain. In this manner, multiple lighting fixtures 1000 spanning a large area may be communicatively coupled to a fewer number of network nodes (e.g., hubs, switches, routers) and without using excessive amounts of network cabling.

An exemplary arrangement of lighting fixtures 1000 in a controlled agricultural environment 2000 is shown in FIG. 10B. Multiple lighting fixtures 1000 may be arranged along a row spanning a growing area defined by the dimensions of a shelf 902A. Each lighting fixture 1000 in the row may be coupled to a support structure 999A disposed above the shelf 902A. The lighting fixtures 1000 in the row may be coupled together in a daisy chain configuration, as described above. Intermediate piping may be used to couple adjacent lighting fixtures 1000 such that fluid coolant 800 may circulate through the multiple lighting fixtures 1000 in a continuous manner from a single inlet and outlet for the row. One or more power cables may be used to supply electrical power to the lighting fixtures 1000. Ethernet cabling may be used to communicatively couple the lighting fixtures 1000 in a serial manner and to a common network node. As shown in FIG. 10B, the controlled agricultural environment 2000 may include multiple rows of lighting fixtures 1000 supported by support structures 999A-999E arranged above corresponding rows of shelves 902A-902E. The controlled agricultural environment 2000 may further include a fan 75, dehumidifiers 65A and 65B, and air conditioning ducts 85A and 85B for one or more air conditioners.

As previously shown in the exemplary controlled agricultural environments 2000A and 2000B in FIGS. 3 and 4, respectively, the lighting fixture 1000 may be incorporated into a coolant circuit 570 to facilitate the flow of fluid coolant 800 such that heat may be continuously removed from the lighting fixture 1000. In some implementations, the coolant circuit 570 may be designed to substantially remove heat from only the lighting fixture 1000 and is not intended to thermally interact with other components or regions of the controlled agricultural environment 2000A, as shown in the coolant circuit 570 in FIG. 3 for a retrofit application. In some implementations, however, the coolant circuit 570 may include additional piping subsystems designed to redistribute heat to a space near or within the controlled agricultural environment, such as the coolant circuit 570 shown in FIG. 4 for a hydronics application, and/or to store heat captured by the lighting fixture 1000 for later use.

A piping subsystem may be branched from the coolant circuit 570 such that the flow of fluid coolant 800 may be controllably adjusted (e.g., by a valve and a separate pump) without affecting the flow of fluid coolant 800 through the coolant circuit 570 and hence, without affecting the removal of heat from the lighting fixture 1000. However, in some instances, a piping subsystem may be placed in series with the coolant circuit 570 where the piping subsystem is also used on a continual basis. Some exemplary instances of a piping subsystem being used in series with the coolant circuit 570 includes, but is not limited to a heating system for a hot water system in a residential space, storing heat from the fluid coolant 800 in a thermal energy storage system, and charging a battery by converting heat from the fluid coolant 800 into electricity (e.g., using a thermoelectric device).

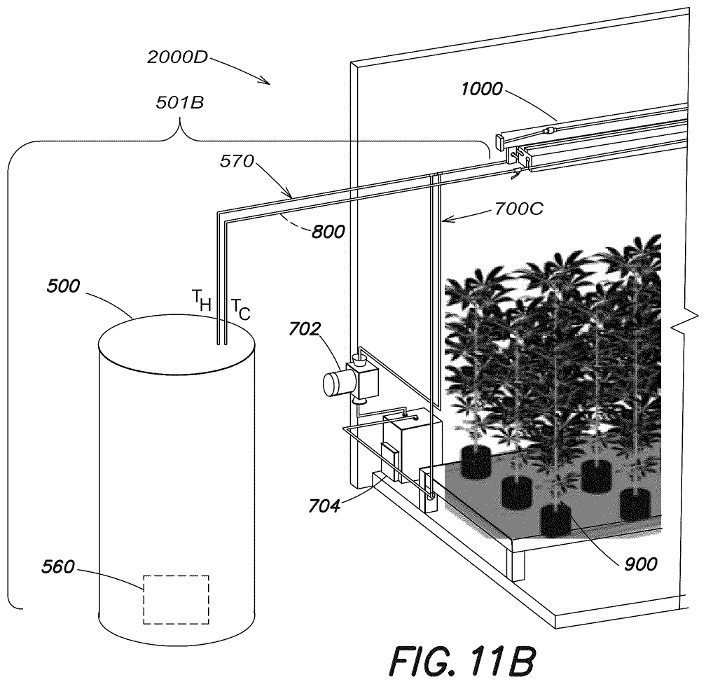

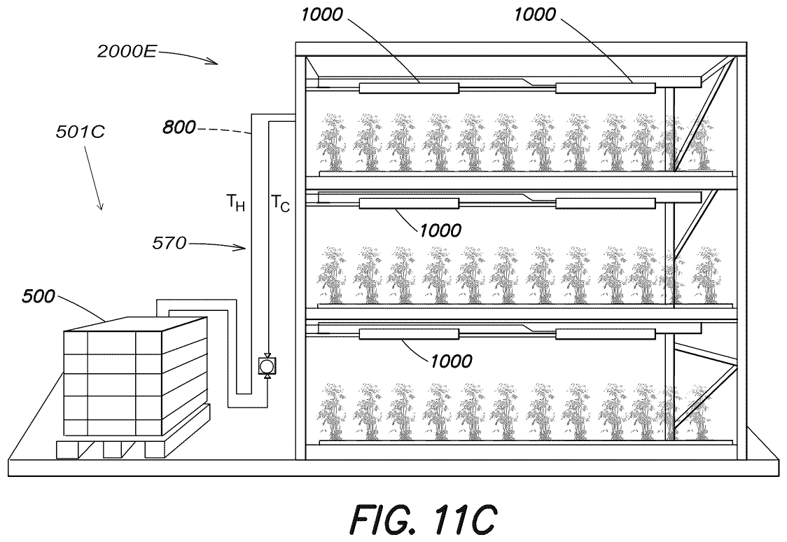

FIG. 11A shows an exemplary hydronics system 501 that may be used in connection with a coolant circuit 570 as well as in other implementations of a controlled agricultural environment where one or more lighting fixtures 1000 are used. As shown, the hydronics system 501 may include a fluid storage tank 500 to store fluid coolant 800, which may be disposed internally or externally to the controlled agricultural environment. In some implementations, the fluid storage tank 500 may include separate compartments for relatively cooler fluid coolant 800 and relatively hotter fluid coolant 800 with sufficient thermal insulation to substantially thermally isolate the compartments from one another and the surrounding environment. The fluid storage tank 500 may also be dimensioned to have a sufficiently large storage capacity such that the thermal time constant of the fluid storage tank 500 meets a desired rate of change in temperature during operation. For example, it may be desirable for the temperature of the fluid coolant 800 stored in the fluid storage tank 500 to remain substantially unchanged (e.g., 1° C. per hour) throughout the day to reduce fluctuations in the amount of heat supplied to various piping subsystems. However, if adjustments to the fluid coolant 800 temperature are desired, the amount of time needed for the adjustments to occur may be prohibitive due to the long thermal time constant. In such instances, multiple fluid storage tanks 500, each having a smaller capacity and thus a shorter thermal time constant, may be used instead.

Three submersible pumps 560A, 560B, and 560C may be disposed within the fluid storage tank 500 to pump fluid coolant 800 through three corresponding piping subsystems, namely, a lighting loop 510, a heating loop 512, and a cooling loop 514. The lighting loop 510 associated with the pump 560A is responsible for providing relatively cooler fluid coolant from the fluid storage tank 500 to one or more lighting fixtures 1000 and returning relatively hotter fluid coolant 800 from the one or more lighting fixtures 1000 to the fluid storage tank 500. In this manner, the lighting loop 510 may function as a heat source to heat fluid coolant 800 stored in the fluid storage tank 500 with heat being subsequently distributed to other piping subsystems. In some implementations, the lighting loop 510 may be used to heat at least a portion of the controlled agricultural environment 2000 via natural convection or thermal radiation to regulate and maintain temperature of the portion within a desired temperature envelope.

In some implementations, a secondary heating loop may be incorporated into the lighting loop 510 to more directly and controllably heat a portion of the controlled agricultural environment 2000 that may not be proximate to the lighting loop 510 (e.g., a growing area). For example, the secondary heating loop may include a pump, a fan, and a fan coil. The pump may generate a flow of relatively hotter fluid coolant 800 through the fan coil, thus heating the fan coil. The fan may then generate a flow of hot air, thus heating the portion of the controlled agricultural environment 2000 via forced convection. In another example, the secondary heating loop may be routed through the root zone of the growing area to heat the soil or nutrient solution to a desired temperature via a combination of convection and conduction. The secondary heating loop may include a flow controlling device (e.g., a valve) to control the amount of heat added to the portion of the controlled agricultural environment. For example, the secondary heating loop may be coupled to a thermostat that adjusts the heat added according to a day/night cycle.

The heating loop 512 associated with the pump 560B may also be used to heat a portion of the controlled agricultural environment 2000 or another space located separately to the controlled agricultural environment 2000. For example, the heating loop 512 may be coupled to a heating, ventilation, and air conditioning (HVAC) system in a building to regulate the interior climate of the building, a heating system in a manufacturing plant to offset gas or electricity consumption, or a cogeneration plant to produce electricity and high-grade heat. In some implementations, the heating loop 512 may also be coupled to a heat store 530, which may provide additional capacity to store heat for future use by the controlled agricultural environment 2000 or another space.

The cooling loop 514 associated with the pump 560C may be used to cool the fluid coolant 800 stored in the fluid storage tank 500. In this manner, the temperature of the relatively cooler fluid coolant 800 entering the lighting loop 510 may be regulated and maintained, which may reduce the effects of thermal drift over time where the temperature of the relatively cooler fluid coolant 800 increases, thus reducing the amount of heat removed from the one or more lighting fixtures 1000. In some implementations, the cooling loop 514 may be a piping subsystem that captures heat to an exterior environment via natural convection and radiation along the length of the cooling loop 514. In some implementations, a heat rejection device may be incorporated into the cooling loop 514 to facilitate cooling of the fluid coolant 800. Various types of heat rejection devices may be used including, but not limited to cooling towers, evaporative coolers, “free” coolers, chillers, dry coolers, air source coolers, ground source heat exchangers, water source heat exchangers, or any combinations of the foregoing. In some implementations, the cooling loop 514 may also be coupled to a cold store 520, which may provide additional capacity to store relatively cooler fluid coolant 800 for future use by the controlled agricultural environment 2000 or another space.

In various implementations described herein, the temperature of the fluid coolant 800 stored in the fluid storage tank 500 and flowing through the lighting loop 510, heating loop 512, cooling loop 514, and one or more secondary loops coupled to any of the lighting loop 510, heating loop 512, cooling loop 514 may vary within an appreciable temperature range. In some implementations, the temperature of the fluid coolant 800 may range from about 20° C. to about 50° C. The flow rate of the fluid coolant 800 may range from about 1 gallon per minute to about 3 gallons per minute through the lighting loop 510. Similar or significantly different (e.g., higher) flow rates may be used by the heating loop 512 and the cooling loop 514. Furthermore, the coolant circuit and the various piping subsystems (e.g., the lighting loop 510, the heating loop 512, and the coolant loop 514) may be controlled via at least one of a pump, regulator, and/or valves. The at least one of a pump, regulator, and/or valves may be operated on various time cycles (e.g., daily, weekly, monthly, seasonal, other periodicities, or any combination thereof) to regulate and maintain desired thermal conditions, which may be dynamic as a function of time, in the controlled agricultural environment 2000B.

Additionally, while three piping subsystems are shown in FIG. 11A, it should be appreciated that any number and combination of piping subsystems may be used with the coolant circuit 570. For example, one or both of the heating loop 512 and the cooling loop 514 may be used in conjunction with the lighting loop 510. It should also be appreciated that while three submersible pumps 560A-560C are shown in FIG. 11A, any number of pumps may be used for a particular piping subsystem and the pumps 560A-560C may also be disposed externally to the fluid storage tank 500. The pumps may be various types of pumps including, but not limited to piston pumps, end-suction pumps, diaphragm pumps, gear pumps, lobed pumps, flexible-vane pumps, nutating pumps, peristaltic pumps, centrifugal pumps, diffuser pumps, propeller pumps, and peripheral pumps.

An exemplary implementation of a hydronics system 501 coupled to a lighting fixture 1000 and a coolant circuit 570 in a controlled agricultural environment 2000 is shown in FIG. 11B. The hydronics system 501 may include a fluid storage tank 500 having contained therein a submersible pump 560. The submersible pump 560 is used to pump relatively cooler fluid coolant 800 into a lighting loop 510, where the fluid coolant 800 is then heated as it passes through the lighting fixture 1000. Subsequently, the relatively hotter fluid coolant 800 exits the lighting loop 510 and enters the fluid storage tank 500 for storage. It should be appreciated that so long as the temperature of the fluid coolant 800 stored in the fluid storage tank 500 is less than the temperature of the fluid coolant 800 entering the fluid storage tank 500 from the lighting loop 510, heat generated by the lighting fixture 1000 may be removed. Over time, if the temperature of the fluid coolant 800 increases, the amount of heat that may be removed may decrease due to a smaller temperature difference. Thus, a heat rejection device may need to be incorporated into the hydronics system 501 to regulate the temperature of the fluid coolant 800 stored in the fluid storage tank 500.

The hydronics system 501 shown in FIG. 11B may also include a secondary heating loop 512 coupled to the portion of the lighting loop 510 where relatively hotter fluid coolant 800 heated by the lighting fixture 1000 flows through. As shown, the secondary heating loop 512 may include a pump 704 and an electric fan with a fan coil 702. The pump 704 generates a flow of the relatively hotter fluid coolant 800 through the fan coil, thus heating the fan coil. The electric fan 702 may then blow heated air towards a plurality of plants 900 located below the lighting fixture 1000 to increase the temperature of the growing area as desired. The second heating loop 512 may be controlled using one or more controllable valves to toggle the secondary heating loop 512 and to adjust the temperature of the air blown by the electric fan 702.

Another exemplary implementation of a hydronics system 501 disposed in a controlled agricultural environment 200D is shown in FIG. 11C. As shown, the controlled agricultural environment 200D may have a vertically-stacked multiple-level growing area. Each level of the growing area may include one or more lighting fixtures 1000 coupled to a lighting loop 510. The lighting loop 510 may be coupled to a fluid storage tank 500, which may again contain therein a submersible pump. Similar to the controlled agricultural environment 2000 of FIG. 11B, the hydronics system 501 may include secondary heating loops to separately heat each growing area in each level. The portions of the lighting loop 510 corresponding to each level may be coupled using a plumbing fitting with multiple inlets and outlets. Additionally, the portion of the lighting loop 510 coupled to the fluid storage tank 500 may support a higher flow rate to account for a reduction in flow rate once the fluid coolant 800 flows into each respective level of the growing area.

In some implementations, the lighting fixture 1000 may also function as a sensor platform supporting one or more sensors used to monitor environmental conditions in the controlled agricultural environment. The processor 90 in the lighting fixture 1000 may supply and regulate electrical power to the sensor through the communication ports 1009 (e.g., a USB port and a PoE port) and/or the camera(s)/sensor(s) 1005. The processor 90 may also include electronics to convert AC power to DC power, as will be described below, thus obviating the need for a separate AC to DC converter in each sensor deployed in the controlled agricultural environment.

The processor 90 may also be used to manage data communications (e.g., wired communication via the Ethernet cables 1060 or wireless communication via the wireless device 1003), including sending control signals to the sensor and receiving sensory data measured by the sensor for processing and/or transmission to a remote device (e.g., a remote computer or server). In some implementations, the remote device may include a network hub to communicate with multiple lighting fixtures 1000. The network hub may be wired (e.g., Ethernet cables 1060 are connected to the hub), wireless (e.g., wireless signals are transmitted/received to/from the wireless device 1003), or a combination of both. In some implementations, the network hub of the remote device may be only wireless, thus allowing a simpler installation by eliminating the Ethernet cables 1060. In some implementations, the network hub of the remote device may be wired to support greater network bandwidth and/or higher security (e.g., data communications may only be accessed at the remote device).

In this manner, the lighting fixture 1000 may provide integration of one or more sensors of various types, supplementing the need for separate power and data communications systems. Furthermore, the data measured by the one or more sensors may be used to adjust and control operation of one or more lighting fixtures 1000 (e.g., adjusting the PAR output from the lighting fixture 1000), one or more coolant circuits (e.g., adjusting the fluid flow through the coolant circuit including the lighting loop, hydronics loop, and cooling loops shown in FIG. 11A), one or more fans, one or more dehumidifiers, or one or more air conditioners in the controlled agricultural environment. In some implementations, various environmental conditions are measured and controlled to provide target vapor pressure deficits in the environment.

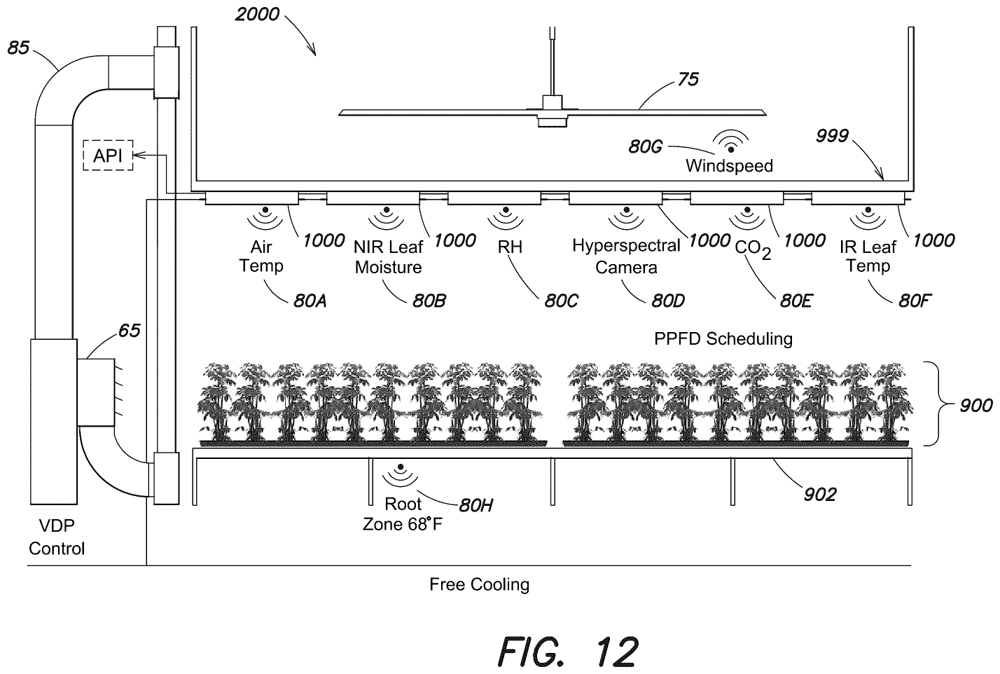

An exemplary implementation of a controlled agricultural environment 2000 detailing the integration of various sensors via multiple lighting fixtures 1000 is shown in FIG. 12. Similar to FIG. 10B, multiple lighting fixtures 1000 may be mounted to a support structure 999 disposed above a plurality of plants 900 arranged on a shelf 902. The controlled agricultural environment 2000 may include one or more dehumidifiers 65, one or more air conditioners 85, and one or more fans 75. A variety of sensors may be supported by the lighting fixture 1000 including, but not limited to an air temperature sensor 80A, a near infrared (NIR) leaf moisture sensor 80B, a relative humidity sensor 80C, a hyperspectral camera 80D, a carbon dioxide sensor 80E, an infrared (IR) leaf temperature sensor 80F, an airflow sensor 80G, a root zone temperature sensor 80H, a range-finding sensor (e.g., LIDAR, time-of-flight sensors), and a visible light sensor. The hyperspectral camera 80D refers to a type of camera that measures light within numerous energy bands (e.g., hundreds) where each band is narrower (e.g., 10 nm) than conventional imaging systems. Finite spectral cameras (also referred to as multispectral cameras) may also be used in the controlled agricultural environment 2000 to measure light using a fewer number of energy bands (e.g. 3 to 10) where each band is broader (e.g., greater than 20 nm). The cameras utilized in the controlled agricultural environment 2000 may measure light across various portions of the electromagnetic spectrum including, but not limited to ultraviolet, visible, near-infrared, mid-infrared, and far-infrared wavelengths. The lighting fixture 1000 may also be used to support other auxiliary devices including, but not limited to one or more fans, security cameras, smartphones, and multi-spectral cameras (e.g., to analyze soil moisture and nutrient content). In this manner, various auxiliary devices may be distributed in the controlled agricultural environment due to the flexible placement of communication ports 1009 on the respective lighting fixtures 1000.

### An Exemplary Electrical Design of a Lighting Fixture

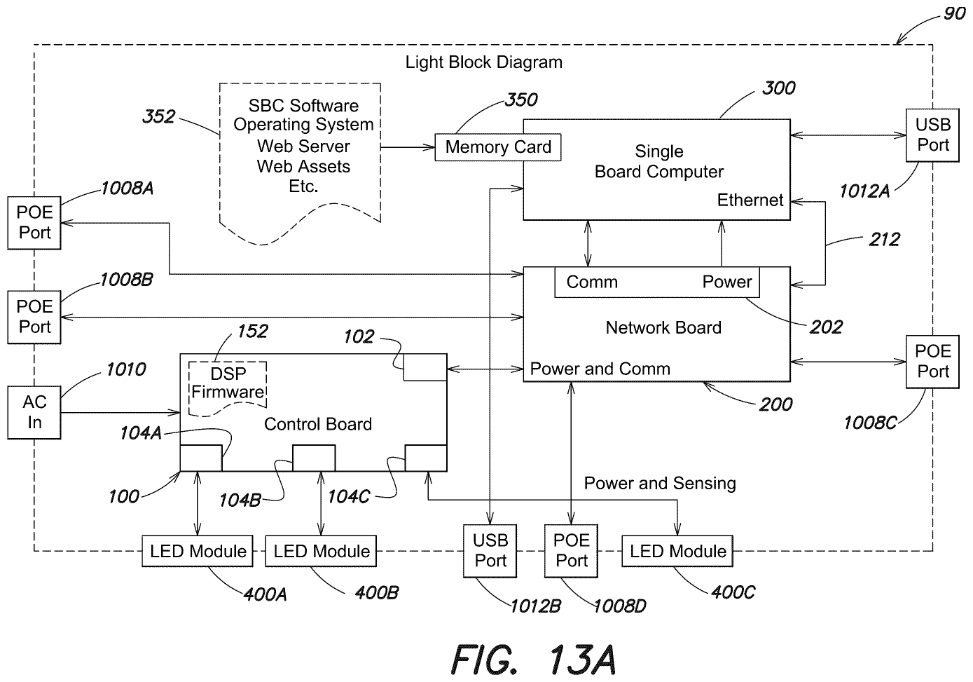

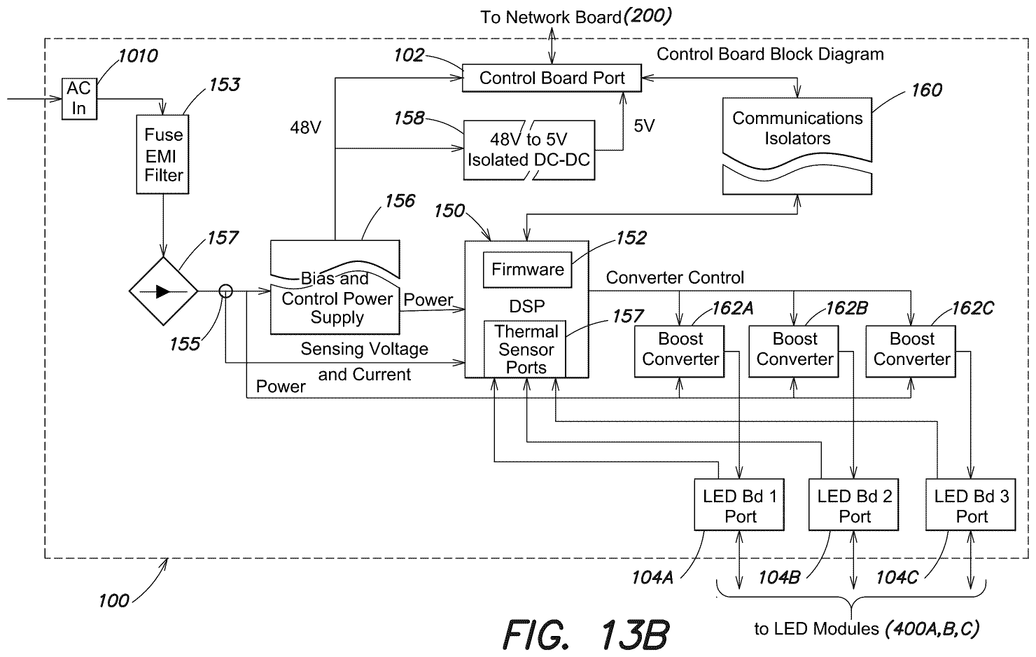

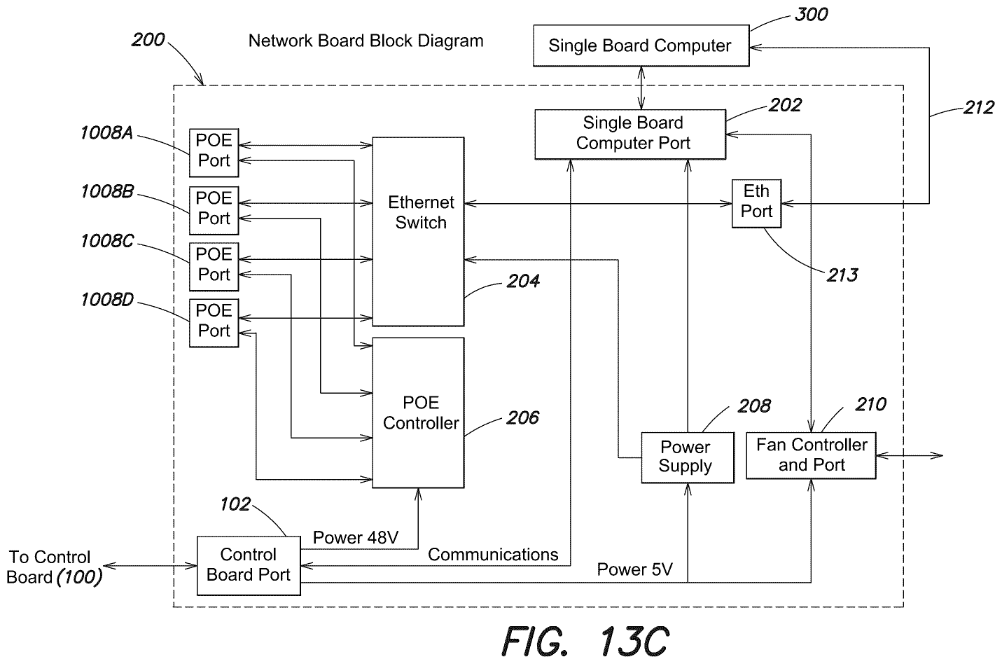

The processor 90 may be used to facilitate multiple functionalities pertinent to the operation of the lighting fixture 1000 including, but not limited to power conversion, network connectivity, and data processing in the operation of the lighting fixture 1000. In some implementations, the processor 90 may be comprised of discrete electronics assemblies that are electrically coupled together where each electronics assembly provides one or more distinct functionalities. For example, FIG. 13A shows a block diagram detailing various electronic components and circuitry in the processor 90 to meet these functionalities according to one inventive implementation. The processor 90 may include a control board 100, a network board 200, and a single board computer 300.

The control board 100 may be used to regulate and distribute electrical power to other components of the lighting fixture 1000. As shown in FIG. 13A, the control board 100 may receive AC power through an electrical power port 1010 and convert the AC power to DC power. The control board 100 may then supply DC power and other control signals to other electronics in the lighting fixture 400. For example, the control board 100 may be directly coupled to multiple LED modules 400A, 400B, and 400C via ports/connectors 104A, 104B, and 104C, respectively, on the control board 100. The control board 100 may also be coupled to the network board 200, providing both electrical power and control signals to the network board 200. The control board 100 may also include onboard memory, in which digital signal processing (DSP) firmware 152 is stored to facilitate generation of control signals as described below.

A more detailed block diagram of the control board 100 in FIG. 13A is shown in FIG. 13B. The control board 100 may include a fuse/electromagnetic interference (EMI) filter 153 to provide safety and reduce noise input into the lighting fixture 1000. A rectifier 154 may be used to convert AC power to DC power. An AC line sensor 155 may be used to monitor the voltage and current of the DC power input. DC power may then be passed directly to a bias and control power supply 156, which may be used to distribute DC power to other components of the lighting fixture 1000 including the network board 200 and a digital signal processor (DSP) 150. A DC-DC converter 158 may also be included to supply different voltage inputs to the network board 200. For example, the bias and control power supply 156 may supply 48 V and 5 V to power different circuitry on the network board 200 and the single board computer 300. The 5 V input may be down converted from the 48 V line via the DC-DC converter 158. The DSP 150 may provide control signals by executing the firmware 152 described above to various components including the network board 200, via one or more communications isolators 160. The DSP 150 may also provide control signals to one or more boost converters 162A, 162B, and 162C, which may be used to regulate electricity supplied to the corresponding LED modules 400A-400C via ports 104A-104C. The boost converters 162A-162C may receive DC power directly once converted from AC power via the rectifier 154. The DSP 150 may receive power from the bias and control power supply 156, a voltage and current measurement from the AC line sensor 155, and thermal sensor inputs via the thermal sensor ports 154, which may be used to monitor the temperature of the LED modules 400A-400C.

The network board 200 may be used to manage data communication between the lighting fixture 1000 and various devices coupled to the lighting fixture 1000 including, but not limited to other lighting fixtures 1000 and one or more auxiliary sensors coupled to the lighting fixture 1000. As shown in FIG. 13A, in some implementations, the network board 200 may control one or more PoE ports 1008A, 1008B, 1008C, and 1008D of the lighting fixture 1000. The network board 200 may receive electrical power and control signals from the control board 100 via a control board port 102. The network board 200 may also supply electrical power and control signals to the single board computer 300 via a single board computer port 202. The network board 200 may also support a dedicated Ethernet cable connection 212 through an Ethernet port 213 between the network board 200 and the single board computer 300 to manage data transfer through the PoE ports 1008A-1008D.

A more detailed block diagram of the network board 200 in FIG. 13A is shown in FIG. 13C. The control board port 102 may be used to supply electrical power at different voltages, e.g., 48 V and 5 V, to a PoE controller 206, a power supply 208, and a fan controller and port 210. The control board port 102 may also directly relay control signals from the control board 100 to the single board computer 300 via the single board computer port 202. In some implementations, the control board port 102 may be arranged as a piggyback board to the network board 200. The PoE controller 206 may be used to regulate and supply electrical power to the PoE ports 1008A-1008D. The power supply 208 may supply electrical power to the single board computer 300, through the single board computer port 202, and to an Ethernet switch 204. The Ethernet switch 204 is communicatively coupled to the PoE ports 1008A-1008D and to the single board computer 300 via the Ethernet port 213, which supports the dedicated Ethernet cable connection 212. The Ethernet switch 204 may be used to facilitate receipt and transmission of data and/or control signals to and from the PoE ports 1008A-1008D.

The single board computer 300 may provide several functions to the processor 90 including, but not limited to managing the operation of the control board 100 and the network board 200 and data processing. As shown in FIG. 13A, the single board computer 300 may also be used to support the functionality of USB ports 1012A and 1012B on the lighting fixture 1000. The single board computer 300 may include a memory card 350 that contains (has stored thereon) various data and computer executable code 352 including, but not limited to, session border controller (SBC) software, an operating system, web server software and other web server assets.

The processor 90 may be used to manage the voltage and current supplied to various components of the lighting fixture 1000, e.g., a power cable, the LED modules 400A-400C, in order to reduce the likelihood of damage under different operating conditions. For example, the lighting fixture 1000 may be operated under low voltage conditions where 1200 W may be supplied to the LED modules 400A-400C and 65 W for auxiliary sensors. The power cable used to supply electricity to the lighting fixture 1000 from an external source, e.g., a building electrical supply system, may be rated to sustain a current up to 15 A. The processor 90 may be used to limit the current through the lighting fixture 1000 to 5 A such that three lighting fixtures 400A-400C may be powered by a single power cable 1030. If the current draw of the lighting fixture 1000 approaches 5 A, the processor 90 may reduce the power draw of the lighting fixture. In this manner, the three lighting fixtures 400A-400C may collectively avoid a total current draw that exceeds 15 A, thus reducing the likelihood of damaging the power cable.

In some implementations, the processor 90 may enforce a current draw limit using an active feedback control loop. For instance, the DSP 150 of the control board 100 may be used to actively measure the voltage and current supplied to the lighting fixture 1000 via the AC line sensor 155. Depending on the magnitude and/or rate of change of the measured voltage and current, the DSP 150 may then adjust the voltage and current supplied to each of the LED modules 400A-400C such that the current drawn by the lighting fixture 1000 is maintained below the current draw limit. This process may be conducted in an iterative manner where measurements of the voltage and current supplied to the lighting fixture 1000 and subsequent adjustments to the voltage and current supplied to the LED modules 400A-400C repeatedly occur at a preset timescale. The timescale may vary from about 1 ms to about 60 s. The amount the voltage and current are varied during each increment may also vary according to the rate of change of the voltage and current supplied to the lighting fixture 1000. In some implementations, the stability of the active feedback control loop may be controlled by incorporating a proportional integral differential (PID) controller into the processor 90.

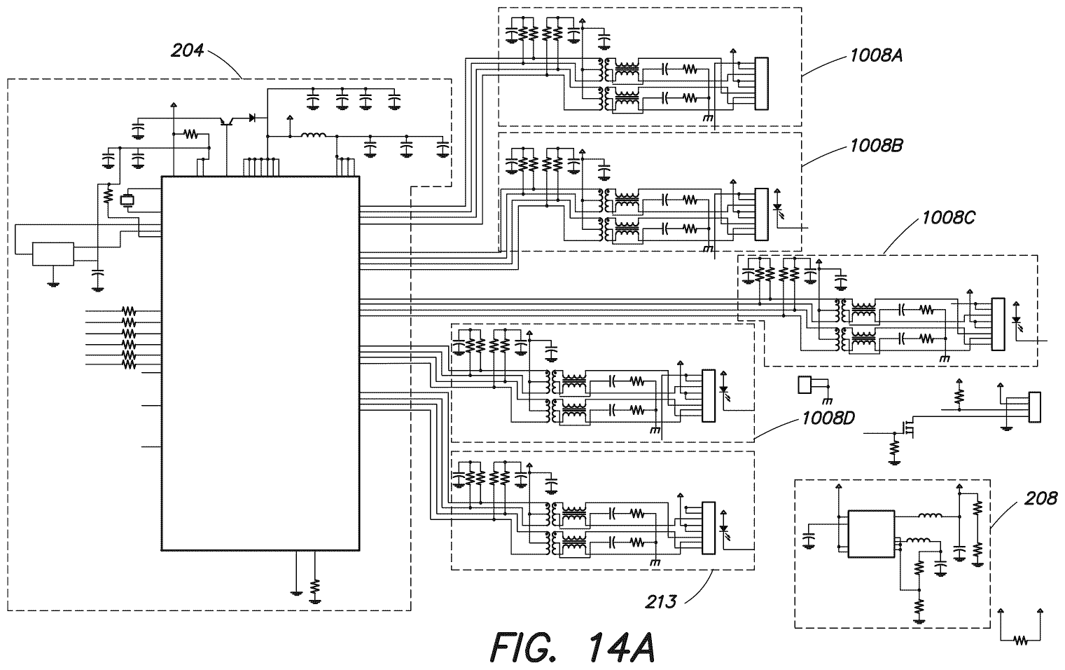

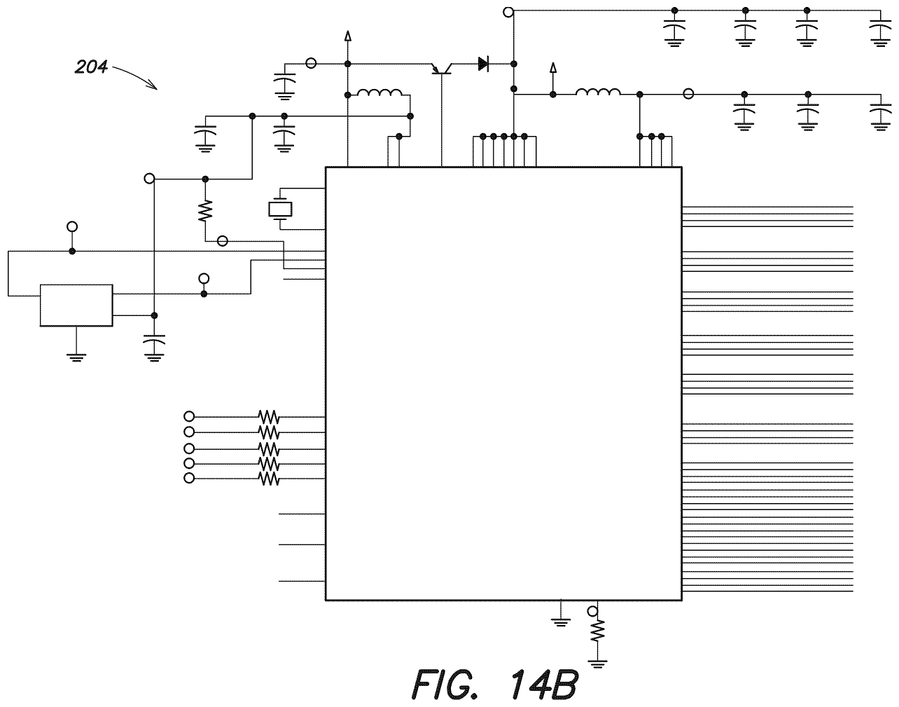

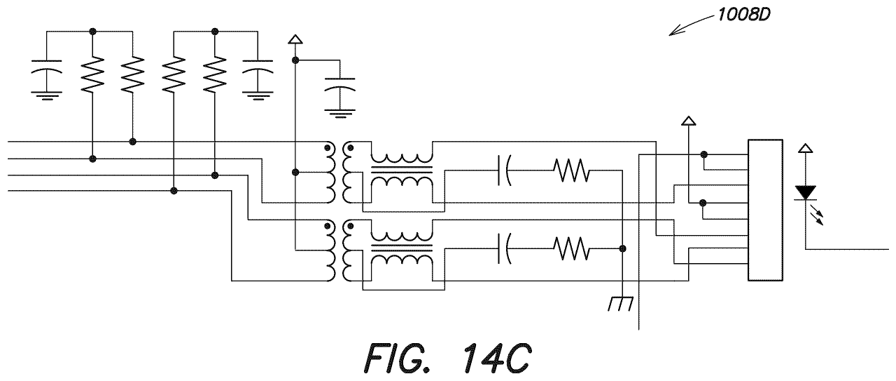

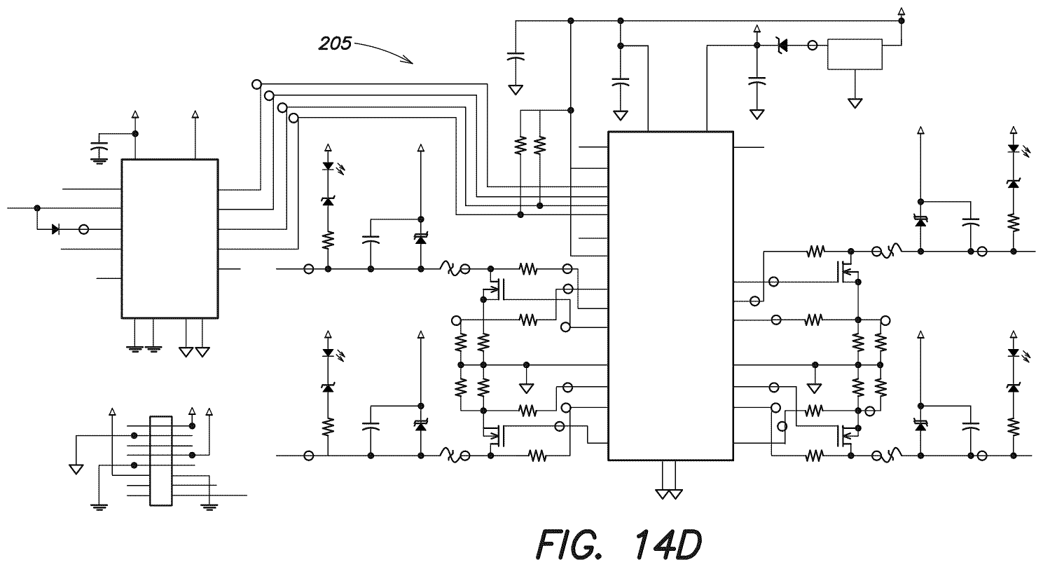

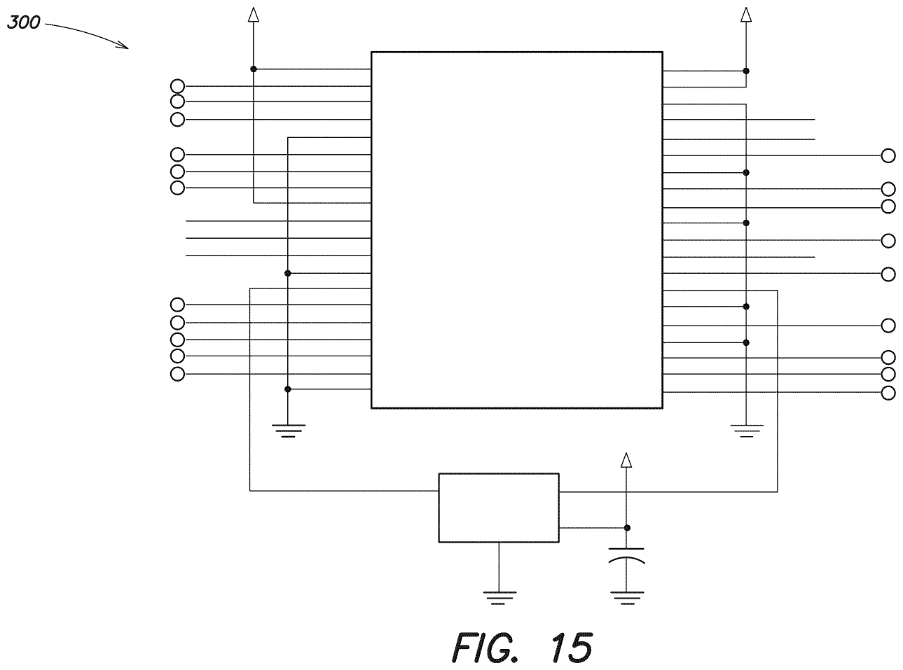

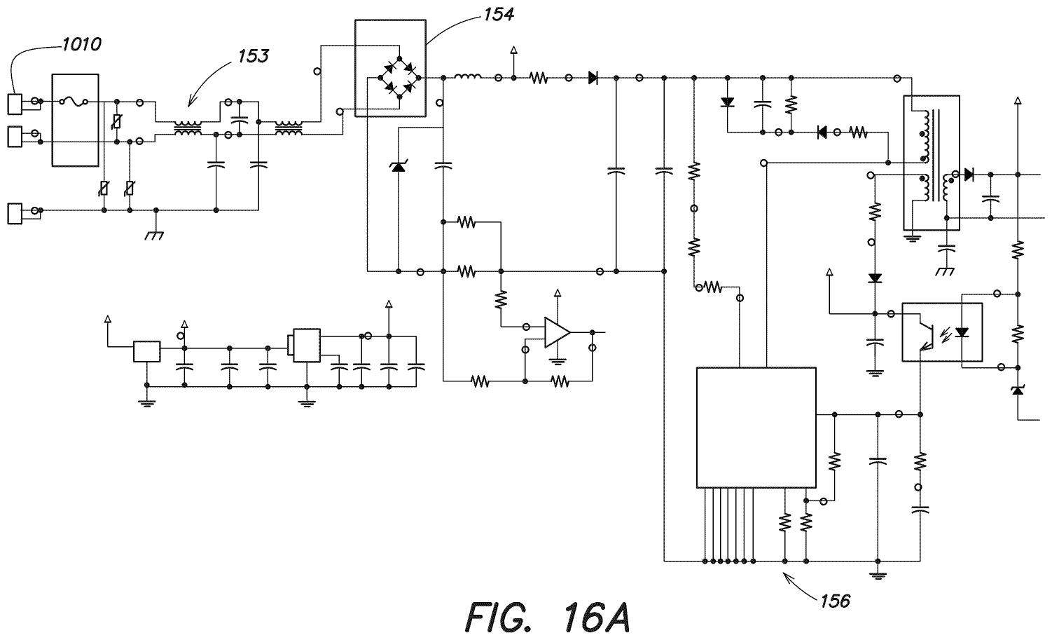

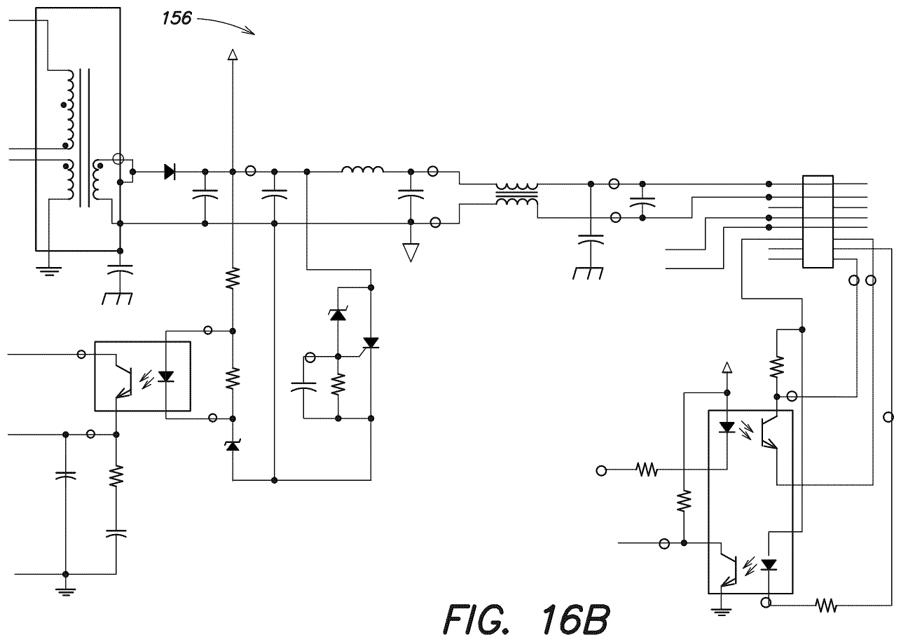

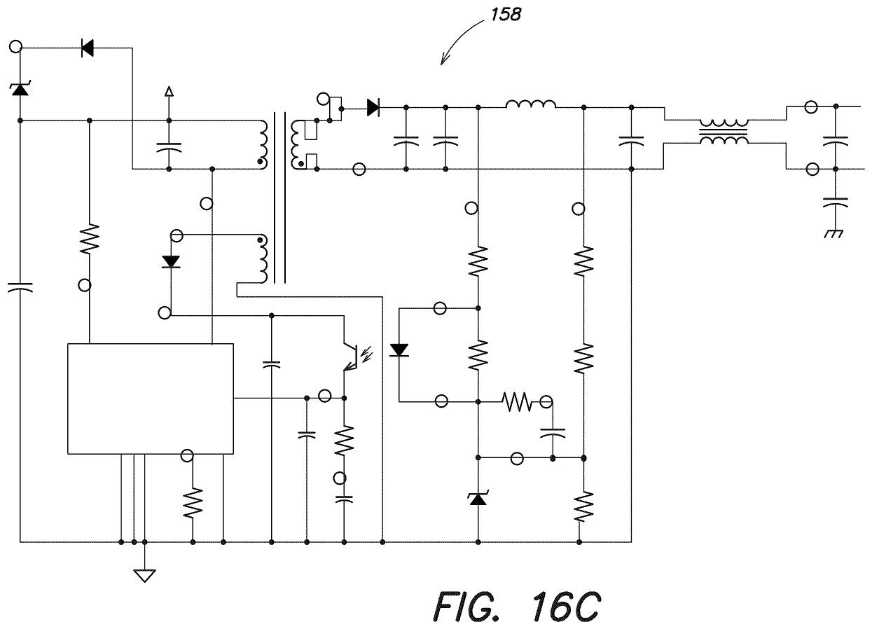

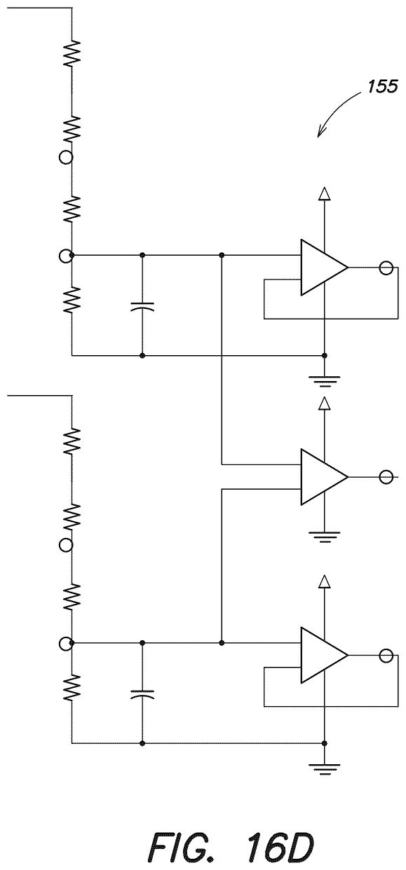

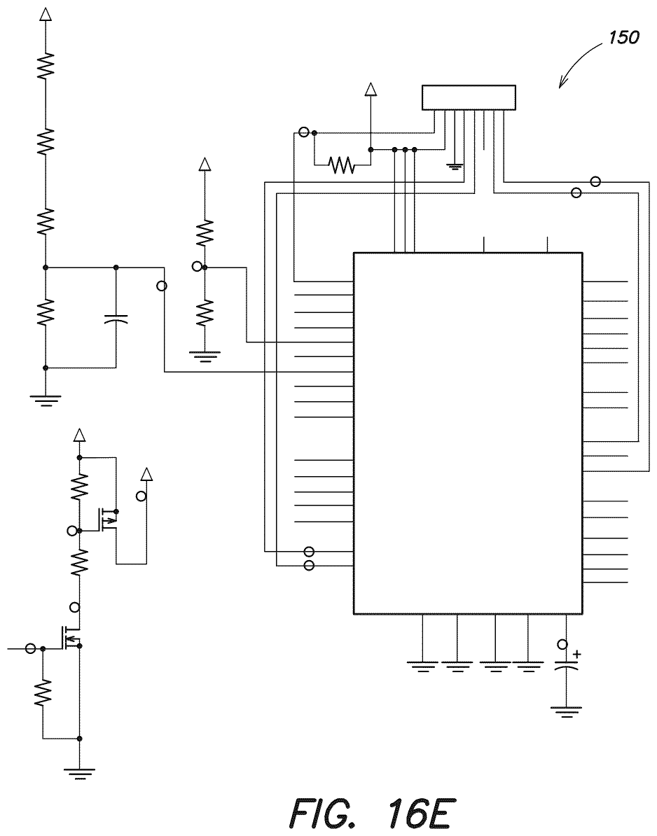

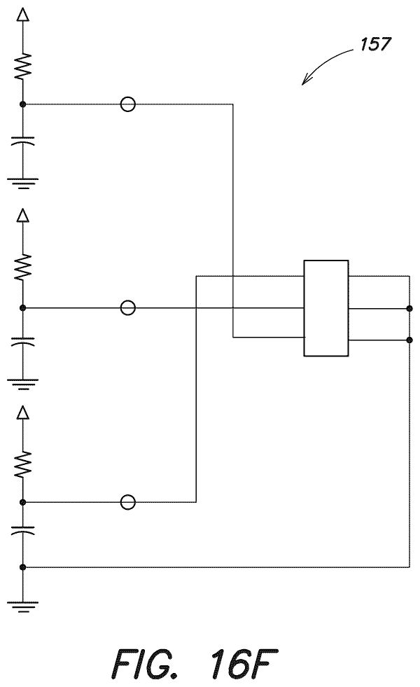

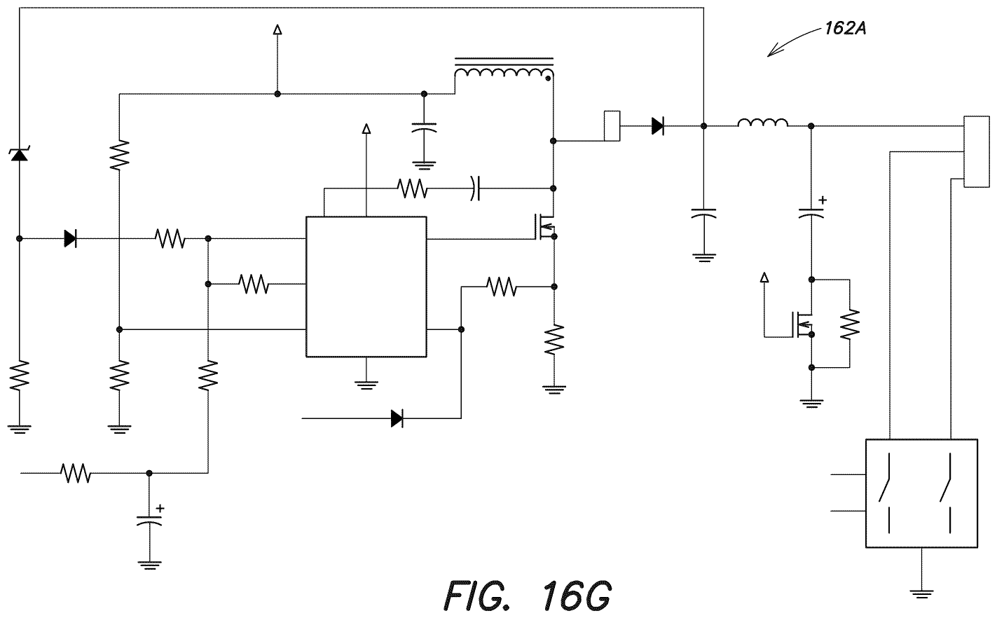

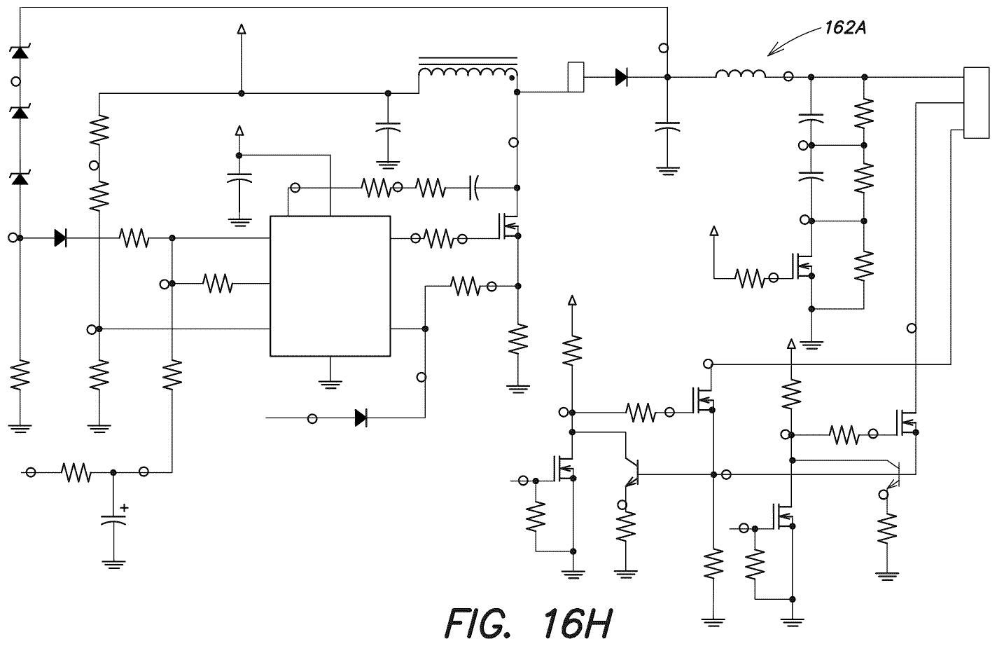

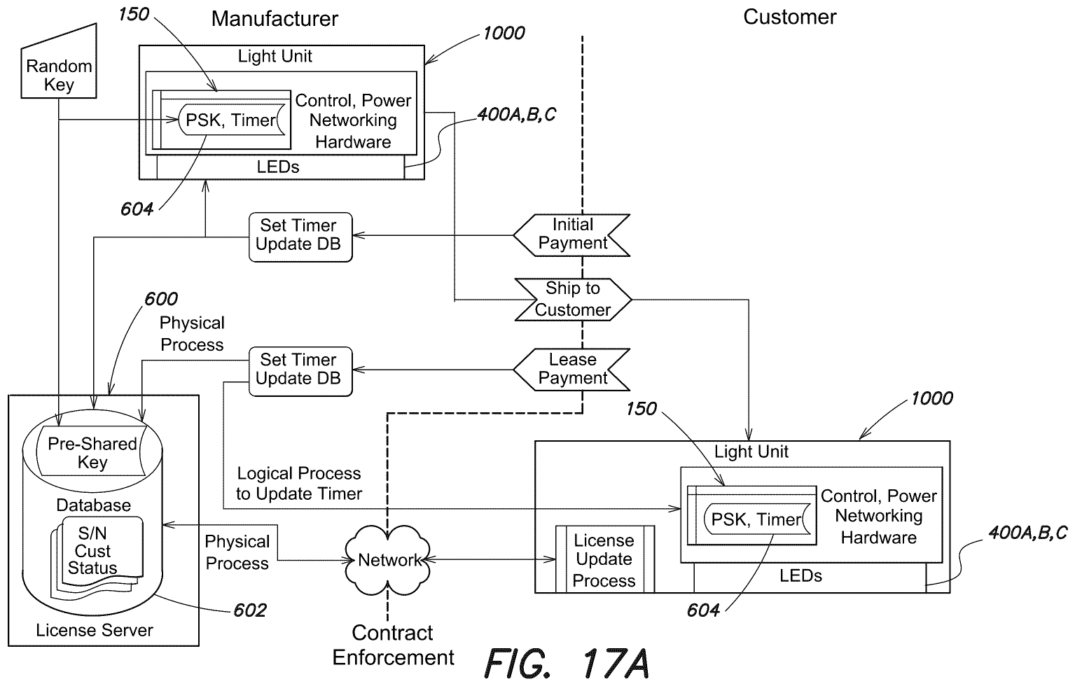

FIGS. 14A-14D, 13, 16A-16H show circuit diagrams of various electrical components of a processor 90 according to one implementation. FIG. 14A shows a circuit diagram of an Ethernet switch 204 from a network board 200 and the electrical connections to PoE ports 1008A-1008D and an Ethernet port 213 for communication to a single board computer 300. FIG. 14A also shows a circuit diagram of a power supply 208 from the network board 200. For visual clarity, FIGS. 14B and 14C show expanded views of the Ethernet switch 204 and the PoE port 1008D from FIG. 14A, respectively. FIG. 14D shows a circuit diagram of a PoE controller 206 from the network board 200. FIG. 15 shows a circuit diagram of a single board computer 300 detailing various input and output connections. FIG. 16A shows circuit diagrams for an electrical power port 1010, fuse/EMI filter 153, a rectifier 154, and a first portion of a bias and control power supply 156 from a control board 100. FIG. 16B shows a second portion of the bias and control power supply 156 shown in FIG. 16A. FIGS. 16C-16F show a DC-DC converter 158, an AC line sensor 155, a DSP 150, and thermal sensor ports 154 from the control board 100. FIGS. 16G and 16H show circuit diagrams of an exemplary boost circuit 162A from the control board 100.

### An Exemplary Leased Lighting System

The lighting fixture 1000 disclosed herein may also be utilized in a leased lighting system where a customer pays a recurring fee to rent and operate the lighting fixture 1000 (e.g., provide lighting using the lighting fixture 1000). In this system, the costs typically associated with purchasing the lighting fixture 1000 hardware and installation may be substantially reduced, thus providing substantial savings to the customer. The manufacturer providing the operation of the lighting fixture 1000 may earn a profit over time through continuing payments by the customer. In some implementations, the leased lighting system may be based on payment of a fee to operate the lighting fixture 1000 for a preset period of time. The lighting fixture 1000 may be communicatively coupled to a server via the processor 90. The server may remotely regulate operation of the lighting fixture, enabling the lighting fixture 1000 to provide lighting so long as the customer provides necessary payment to maintain the lease.

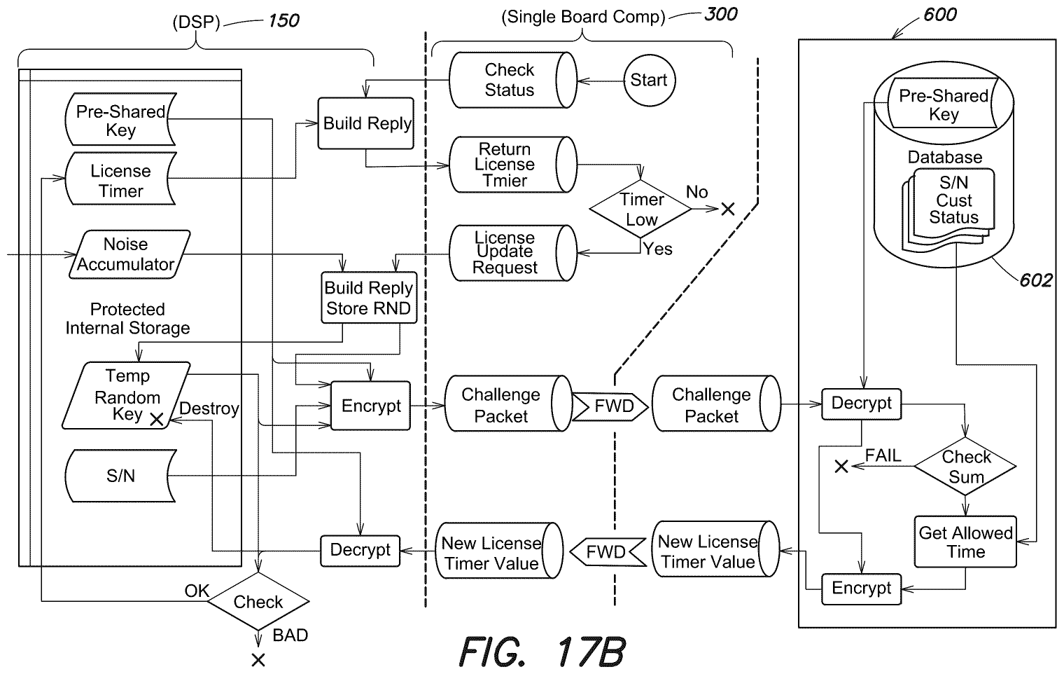

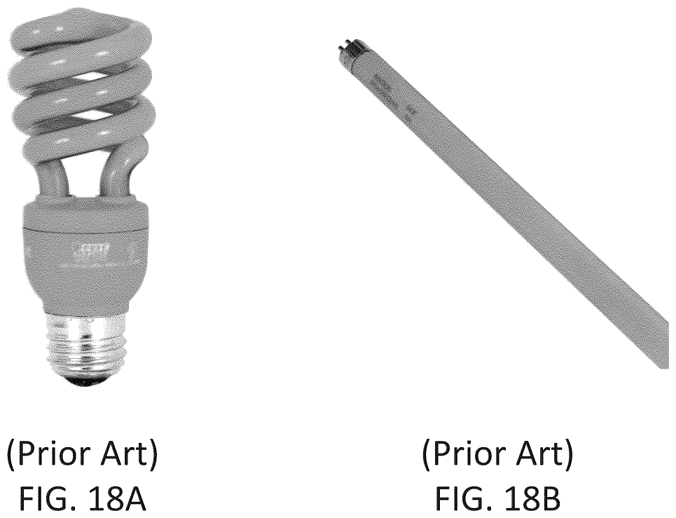

An exemplary implementation of a contract enforcement method where the lighting fixture 1000 is communicatively coupled to a license server 600 is shown in FIG. 17A. As shown, the license server 600 may include a database 602 containing information including, but not limited to a serial number for one or more lighting fixtures 1000 installed by a customer and a customer status (e.g., a payment status) for the customer to which the one or more lighting fixtures 1000 are leased. The database may also include a pre-shared key 604, which is also installed onto each lighting fixture 1000, e.g., such as in protected internal storage of the DSP 150 of the lighting fixture 1000, by the manufacturer, together with a timer, prior to shipment to the customer. Upon initial payment by the customer, the manufacturer may setup an initial timer update in the database 1000 to provide for some time period for initial lighting, after which an additional lease payment is required. Once the lighting fixture 1000 is deployed to the customer, the expiration of the timer may trigger a license update process. Once the additional lease payment is made, the manufacturer operating the license server 600 may update the database 602 with a new timer value, which is communicated to the lighting fixture 1000. Communication may occur via a proprietary communication protocol.

An exemplary implementation of a process to update a license for a leased lighting model with one or more lighting fixtures 1000 is shown in FIG. 17B. In this exemplary process, the DSP 150 and the single board computer 300 of the processor 90 may be coupled to the license server 600 and database 602 via the Internet to facilitate operation by the manufacturer of the one or more lighting fixtures 1000 or a leasing agent. As described above, the pre-shared key 604 and license timer may be stored in the protected internal storage of the DSP 150 by the manufacturer together with the serial number of the lighting fixture 1000. The single board computer 300 may periodically check the status of the license timer. Once the license timer is near expiration, the single board computer 300 may initiate with the DSP 150 a license update request. This request may include a “challenge packet” generated by the DSP 150, which is forwarded by the single board computer 300 to the license server 600. The challenge packet may include encrypted information based, at least in part, on the serial number of the lighting fixture 1000 and a temporary random key generated using a noise accumulator. The challenge packet may then be decrypted by the license server 600. If the challenge packet is found to be valid and payment is made for additional lighting, the license server 600 may then determine a new allowed timer value. The new allowed timer value may then be encrypted and sent back to the single board computer 300, which passes the encrypted timer value to the DSP 150. The DSP 150 may then decrypt the new timer value based on the pre-shared key 604. If the new timer value is found to be valid, the DSP 150 may update the license timer stored in the protected internal storage of the DSP 150.

Module with Integrated Inspection Light

The exemplary implementations of lighting fixtures disclosed herein may be equipped with supplemental light sources, inspection light sources, various cameras, and/or sensors to provide complementary sources of illumination to the LED modules 400 and to characterize a variety of environmental conditions and chemical and/or morphological properties of the plants. The sensors, cameras, and/or supplementary light sources supported by the lighting fixture may be packaged in a self-contained module and coupled to the frame of the lighting fixture. For example, the lighting fixture may include the multispectral imaging system 1100 described above to provide spectral analysis of the plants as a function of time to evaluate the plants' health and development (e.g., via kinetic finite absorbance and reflectance spectroscopy). More generally, the lighting fixture may support different modules with different combinations of sensors, cameras, inspection light sources and/or supplemental light sources depending, in part, on the plant species and the grower's needs.

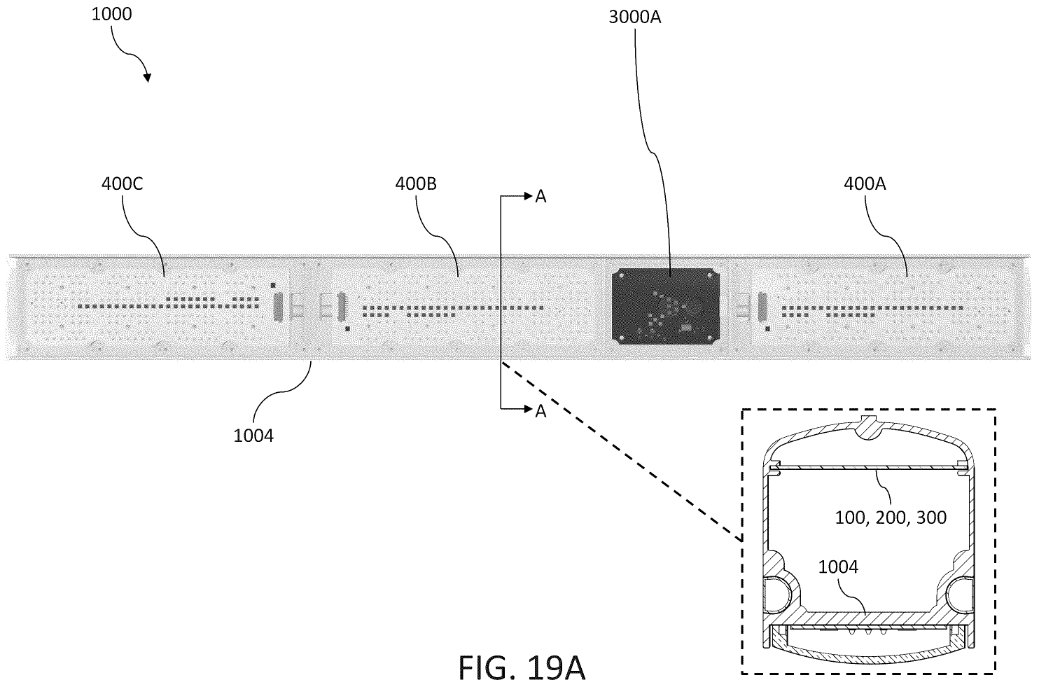

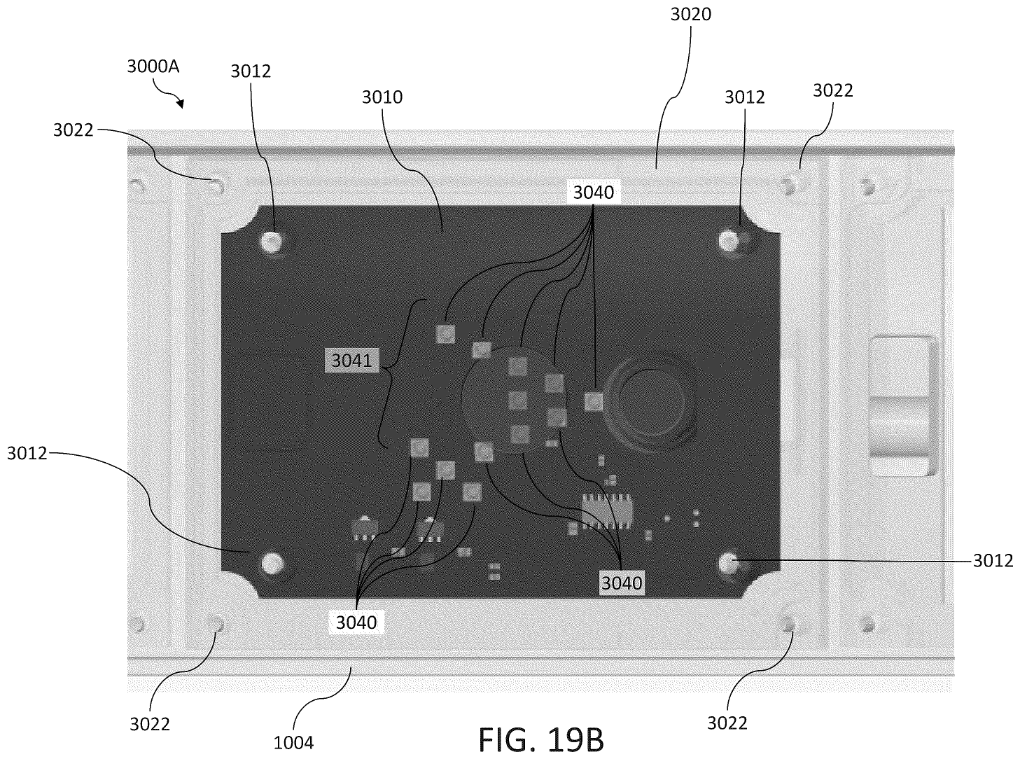

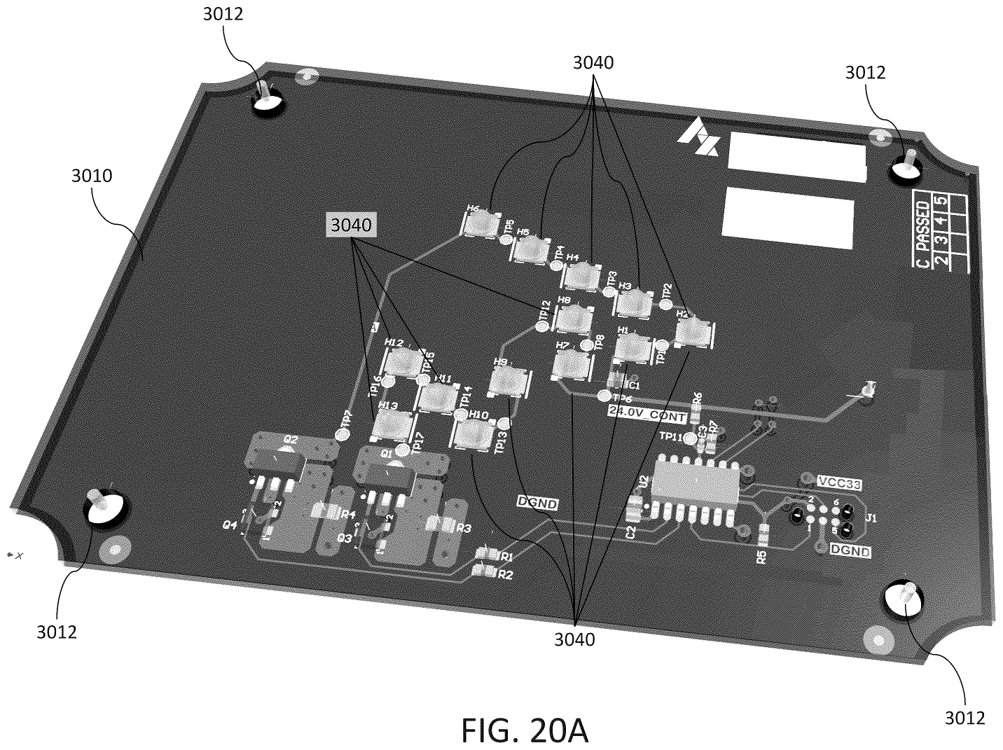

In another example, FIGS. 19A and 19B show a module 3000A with an inspection light system 3041 coupled to a lighting fixture 1000 having multiple LED sources 3040, which may be used to aid inspection of the plants. The module 3000A may be configured to activate (e.g., turn on) the inspection light system 3041 to emit light when the LED modules 400A-400C are deactivated (e.g., turned off), such as during the plants' night cycle. However, it should be appreciated that, in some implementations, the inspection light system 3041 may be turned on together with the LED modules 400A-400C and/or when the grow room is illuminated with sunlight. Herein, the light emitted by the inspection light system 3041 is also referred to as “inspection light” to differentiate the light from, for example, the radiation emitted by the LED modules 400A-400C. It should also be appreciated inspection light is not limited to visible light, but can also include radiation in other wavelength bands, such as ultraviolet radiation or near-infrared radiation.

As shown, the module 3000A is mounted to a lighting fixture 1000 between the LED modules (e.g., the LED modules 400A and 400B). In some implementations, the module 3000A may have a similar geometry and dimensions with the multispectral imaging system 1100 and may be further coupled to the lighting fixture 1000 in a similar manner as the multispectral imaging system 1100. Said in another way, the lighting fixture 1000 may provide a mechanical interface to mechanically support different modules and an and electrical interface to provide electrical power and/or communication for different modules with different combinations of sensors, cameras, and/or light sources (e.g., the module 3000A, the multispectral imaging system 1100).

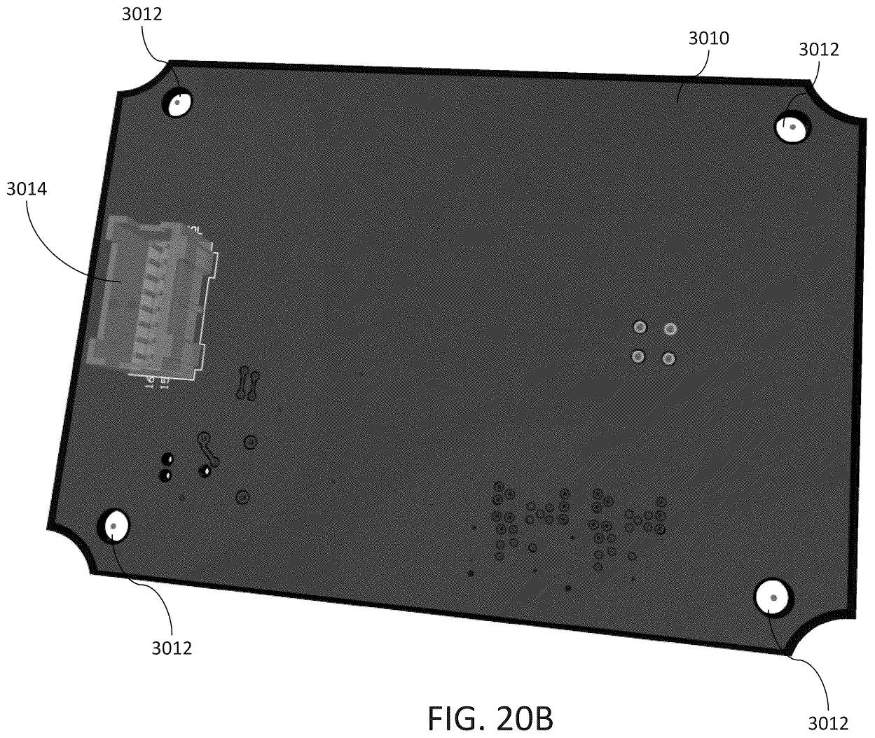

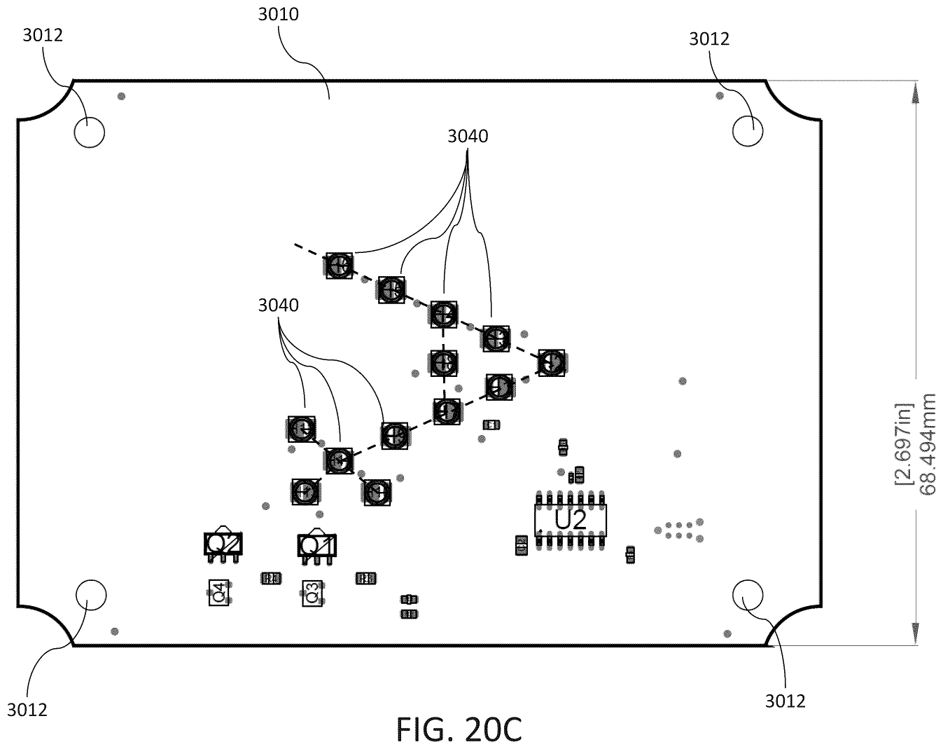

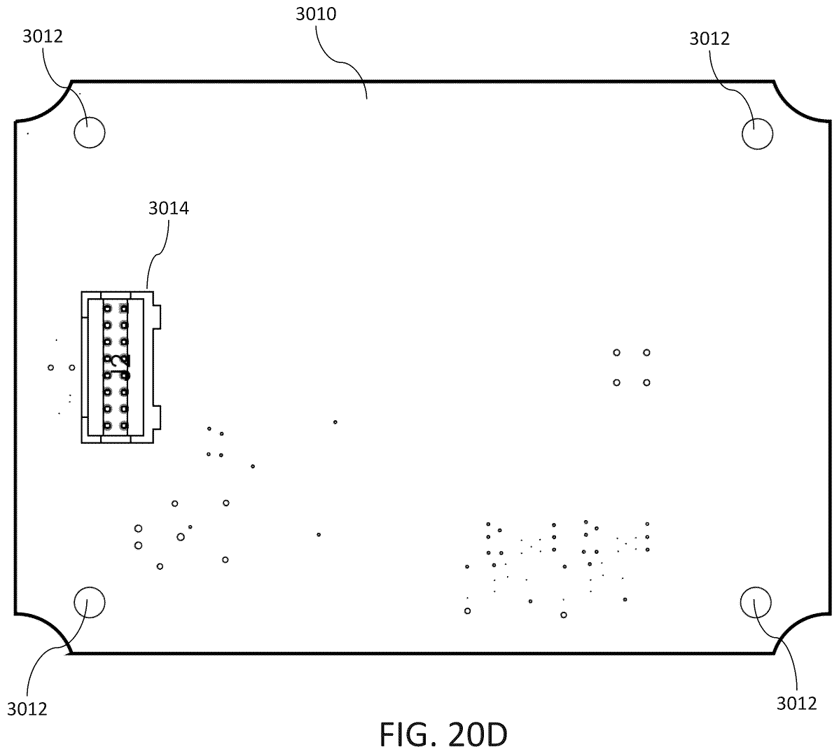

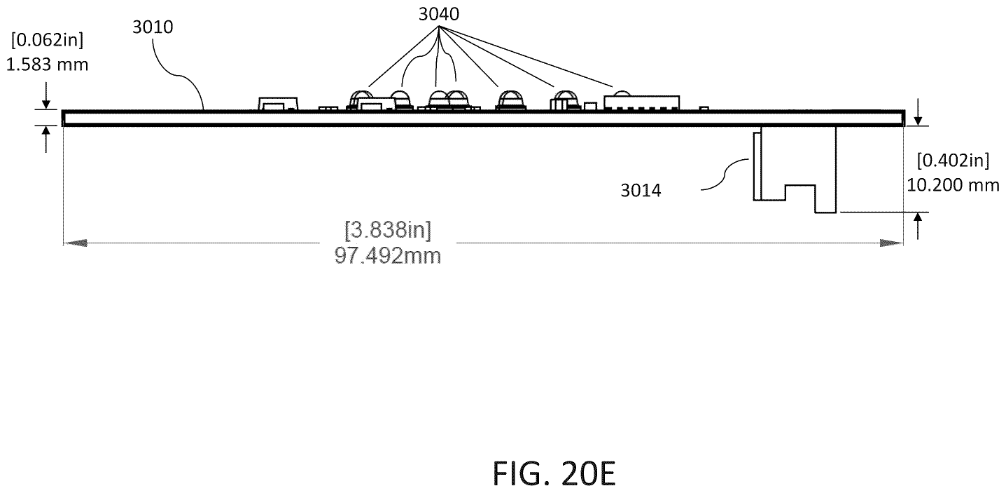

For example, FIG. 20B shows the module 3000A may include a multi-pin electrical connector 3014 to electrically couple the module 3000A to a corresponding connector (not shown) on the lighting fixture 1000 with complementary socket connectors to receive the respective pins of the multi-pin electrical connector. In some implementations, a cable may couple the multi-pin electrical connector 3014 of the module 3000A to the corresponding connector on the lighting fixture 1000. The multispectral imaging system 1100 may also include the same or similar multi-pin electrical connector. By providing a common mechanical and electrical interface, the lighting fixture 1000 may be customized by allowing the grower to readily swap out different modules as desired. For instance, a subset of the lighting fixtures in a grow room may include the multispectral imaging system 1100 and another subset of the lighting fixtures may include the module 3000a.

The module 3000A may be oriented such that the LED sources 3040 have a field of view that at least partially overlaps the field of view of the LED modules 400A, 400B, and/or 400C. Thus, the module 3000A may illuminate the same plants that are at least within the field of view of the LED modules 400A-400C to facilitate inspection of the plants. In this manner, the lighting fixture 1000 may provide both radiation to stimulate the growth of the plants (e.g., PAR) and lighting for inspection in a single platform unlike conventional CEH systems where grow lights and inspection lights are typically purchased and installed as separate systems.

The module 3000A may generally include a housing 3020 to contain the inspection light source 3041. In some implementations, the housing 3020 may be similar to the housing 1120 of the multispectral imaging system 1100. For example, the housing 3020 may include several housing fastener openings 3022 that align with corresponding openings on the frame 1004 for attachment via corresponding fasteners (not shown). Additionally, the module 3000A may include a circuit board 3010 that mechanically and electrically supports the inspection light system 3041. The circuit board 3010 may also be coupled to the housing 3020 via fasteners (not shown) inserted through corresponding PCB fastener openings 3012 on the circuit board 3010.

Additionally, the housing 3020 may form a substantially sealed enclosure to reduce or, in some instances, prevent infiltration of foreign substances (e.g., moisture, dirt, dust). The optical properties of the housing 3020 may be tailored to be substantially transparent at the emission wavelengths of the inspection light (e.g., visible light, green light at wavelengths between 500 nm and 550 nm, far red radiation at 730 nm). Alternatively, the housing 3020 may support different windows (e.g., a glass window, the windows 1130) placed within corresponding apertures formed in the housing 3020 to transmit desired bands of radiation (e.g., ultraviolet, visible light, NIR).

In some implementations, the one or more LED sources 3040 of the inspection light system 3041 in the module 3000A may emit light or, more generally, radiation that does not appreciably disrupt the plants' night cycle. This can be accomplished by providing inspection light at a suitable intensity and/or for a suitable period of time to reduce or, in some instances, prevent any undesirable effects on the plants' flower cycle. For example, the intensity of the inspection may be relatively lower compared to the intensity of the radiation emitted by the LED modules 400A-400C.

The absorptivity of plants also typically varies as a function of wavelength due, in part, to the presence of different chemical compounds that strongly or weakly absorb radiation at different wavelengths. For example, FIG. 7Q shows different chlorophyl compounds have appreciable absorption peaks at 400-500 nm and 600-700 nm. Thus, the intensity of the inspection light emitted by the LED sources 3040 may also vary as a function of wavelength to avoid unwanted disruptions to a plants' night cycle. For example, the LED sources 3040 may emit green light having a wavelength ranging between 500 nm and 550 nm or, more specifically, between 515 nm and 535 nm. More generally, the LED sources 3040 of the inspection light 3041 may emit light at various wavelengths bands including, but not limited to, ultraviolet radiation (e.g., 310 nm to 400 nm, or 365 nm), blue light, green light, yellow light, orange light, red light (e.g., 660 nm), far-red radiation (e.g., 720 nm to 740 nm, or 730 nm), or any combinations of the foregoing. It should be appreciated the spectral bandwidth of the LED sources 3040 may be equal to about +10 nm or −10 nm relative to the nominal wavelength of emission. For example, a LED source 3040 that emits radiation having a peak intensity at a wavelength of 730 nm may also emit radiation at 720 nm and 740 nm at intensities lower than the peak intensity.

In some implementations, the inspection light 3041 may include multiple LED sources 3040 that emit inspection light at different wavelengths. For example, the LED sources 3040 may emit inspection light at wavelengths including 310 nm to 400 nm, 500 nm to 550 nm, and/or 720 nm to 740 nm. For example, the LED sources 3040 may collectively (or individually) emit white light. However, it should be appreciated that, in some implementations, all the LED sources 3040 of the inspection light system 3041 emit inspection light at the same wavelength.

In some implementations, the LED sources 3040 may collectively emit light with a nominal photosynthetic photon flux (PPF) of up to approximately 7 μmol/s or equal to or less than approximately 7 μmol/s. In some implementations, the LED sources 3040 may emit a PPF that is appreciably lower than the PPF of the radiation (e.g., PAR) emitted by the LED modules 400A-400C. For example, the PPF of the PAR (or, more generally, any radiation) emitted by the LED modules 400A-400C may be greater than the PPF of the inspection light emitted by the LED sources 3040 by a factor greater than or equal to 100. The relative term “approximately,” when used to describe the nominal PPF or output intensity of each LED source 3040 or group of LED sources 3040, is intended to cover manufacturer tolerances. For example, “approximately 7 μmol/s” may correspond to 6.93 μmol/s to 7.07 μmol/s (+/−1% tolerance); 6.65 μmol/s to 7.35 μmol/s (+/−5% tolerance); 6.51 μmol/s to 7.49 μmol/s (+/−7% tolerance); or 6.3 μmol/s to 7.7 μmol/s (+/−10% tolerance). In some implementations, each LED source 3040 may operate at a forward voltage of 2.8 to 3.6 V and a driving current of 2 A. In some implementations, each of the LED sources 3040 may be a Prolight PJ2N-FFGE.

The duration the inspection light is emitted by each LED source 3040 and/or a group of LED sources 3040 may also be adjusted to accommodate the plants' sensitivity to different wavelengths of inspection light. For example, LED sources that emit red light (e.g., light at a wavelength of 660 nm) may be turned on for shorter periods of time than LED sources that emit green light. In another example, the intensity of the LED sources emitting red light may be less than the intensity of the LED sources emitting green light. In yet another example, far-red radiation at a 730 nm wavelength often have little to no effect on the plants' night cycle. Thus, LED sources that emit 730 nm radiation may kept on for longer periods of time and/or at higher intensities compared to green light (500-500 nm wavelength).

The LEDs in the module 3000A may generally be disposed on the same circuit board (e.g., the circuit board 3010) as shown in FIGS. 20A-20E. In some implementations, the LED sources 3040 in the module 3000A may be operated independently from the LED sources in the LED modules 400A-400C. For example, the LED sources 3040 of the module 3000A may be turned on or off independent of whether the LED modules 400A-400C are turned on or off. In some implementations, each LED source 3040 in the module 3000A may be further independently controllable with respect to other LED sources 3040 in the module 3000A.

In implementations where the LED sources 3040 in the module 3000A emit inspection light at the same or similar wavelengths (e.g., +/−5% of the nominal wavelength, 500-550 nm where the nominal wavelength is 525 nm), the intensity of the inspection light collectively emitted by the LED sources 3040 may be varied by changing the number of LED sources 3040 in the module 3000A that are on or off. In some implementations, the module 3000A may further include a dimmer circuit integrated onto the circuit board 3010 to controllably adjust the output intensity of each LED source 3040. For example, each LED source 3040 may emit light at a nominal intensity and the dimmer may allow the grower to adjust the intensity of each LED source 3040 between 2% and 100% of the nominal intensity. It should be appreciated, however, that the total nominal intensity of the light emitted by the LED sources 3040 (i.e., the sum of the nominal intensities of the LEDs) may be varied from 0% to 100% of the total nominal intensity using the mechanisms described above.

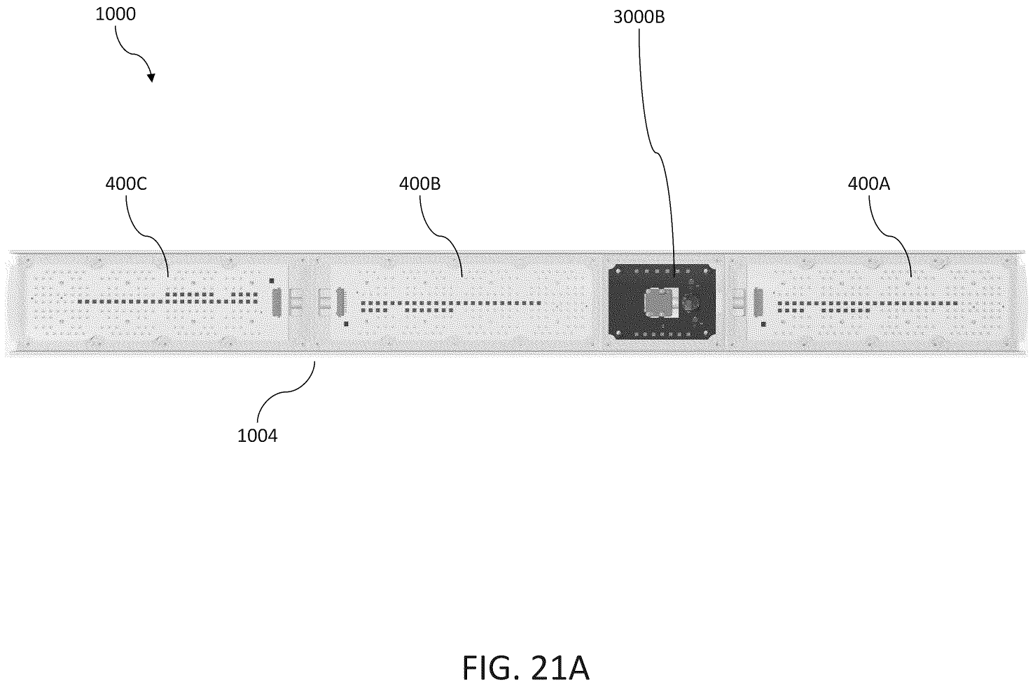

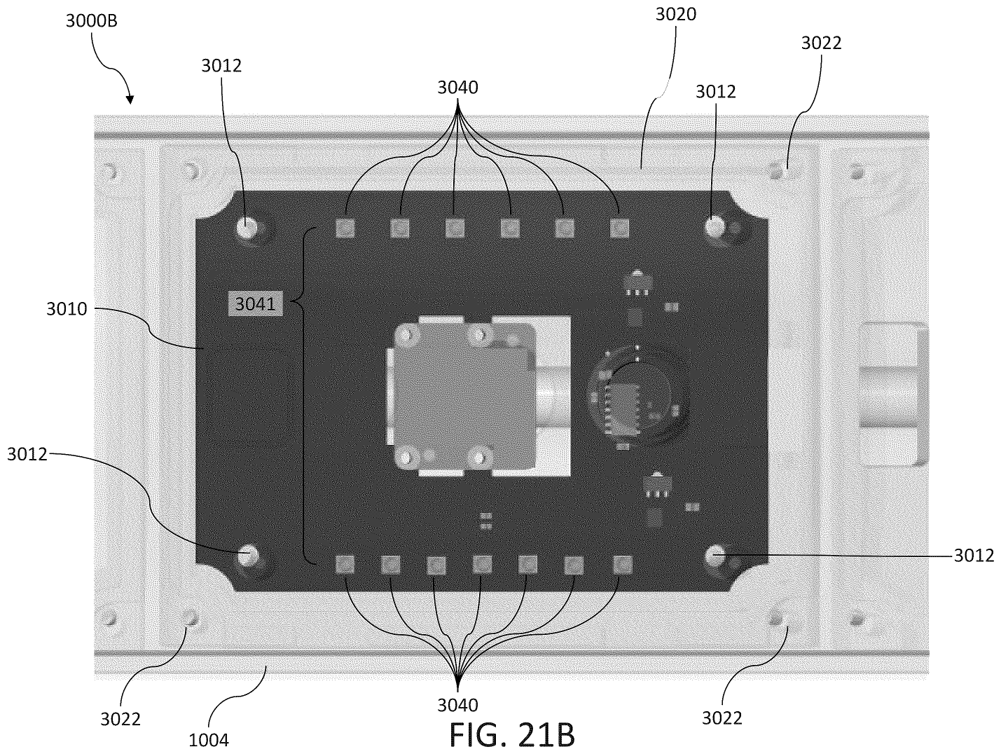

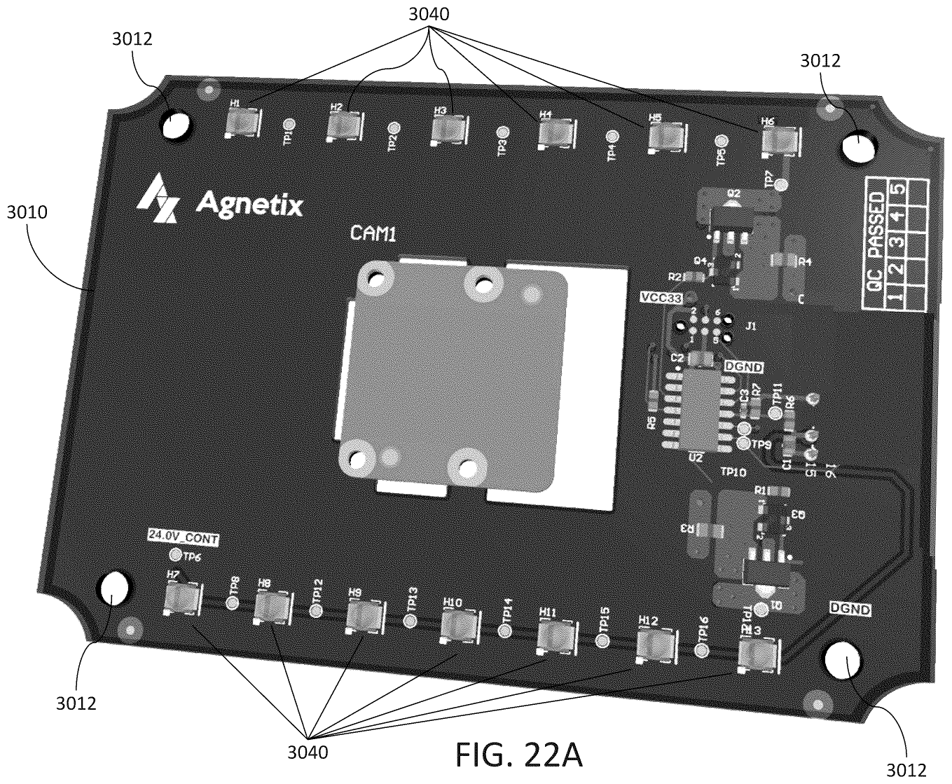

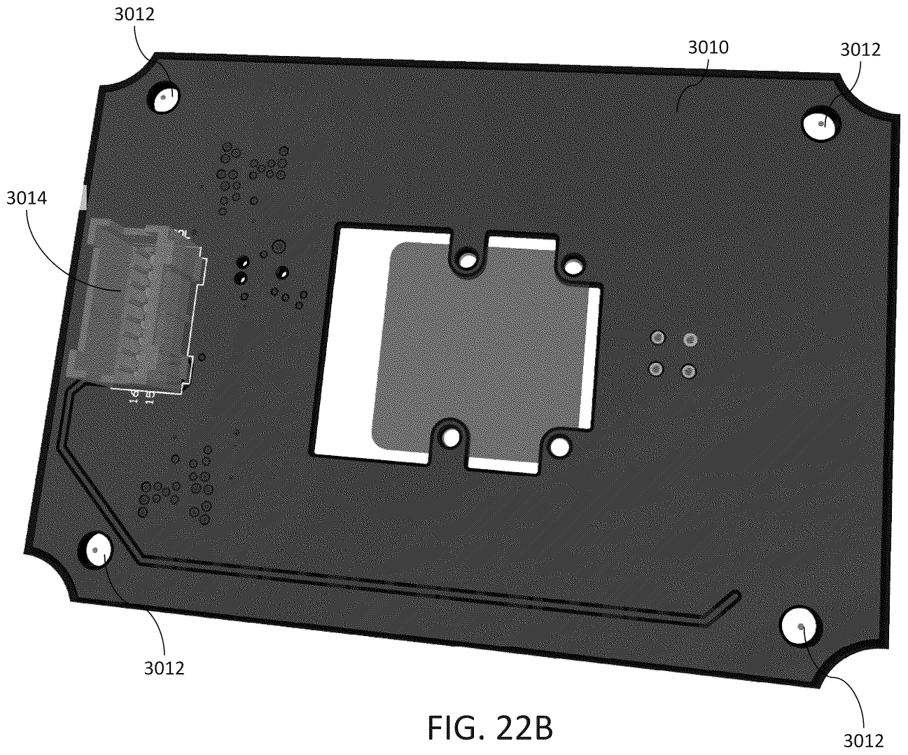

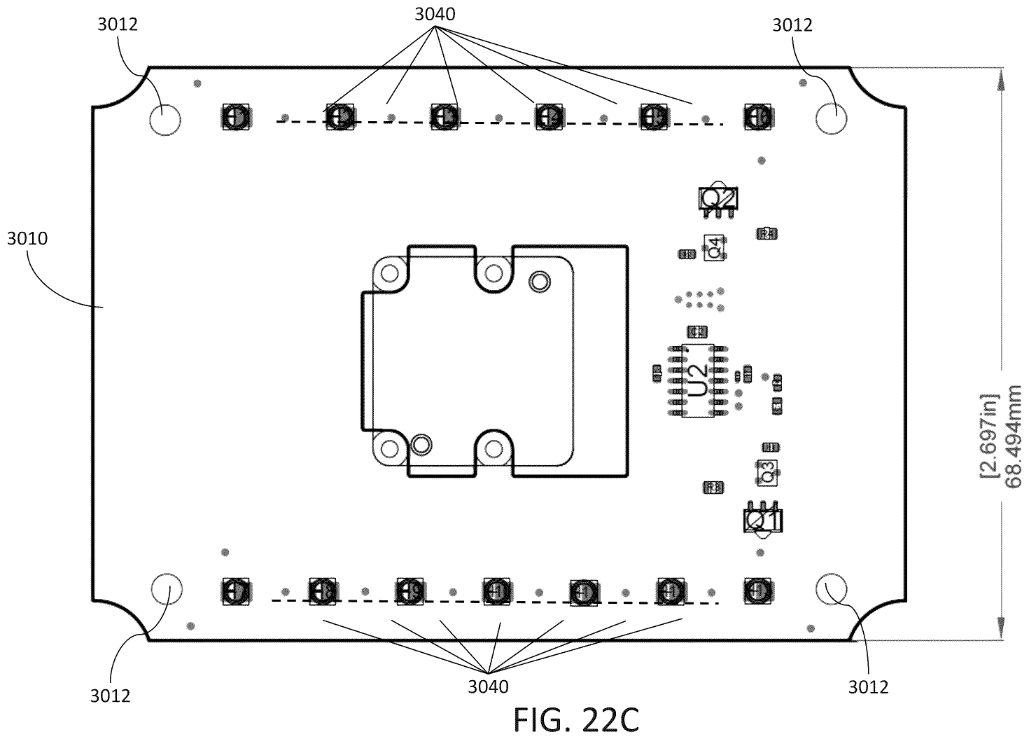

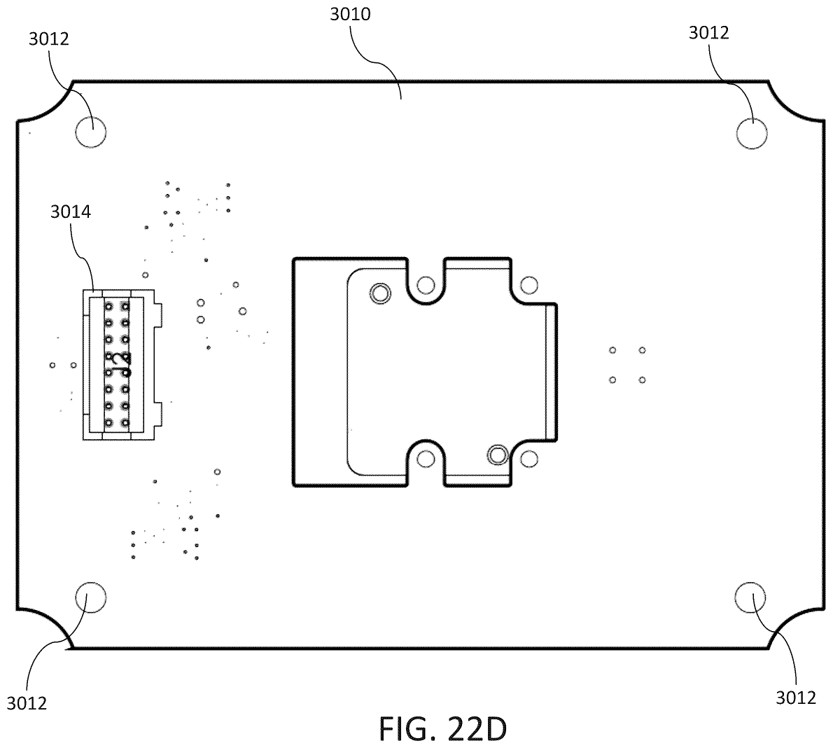

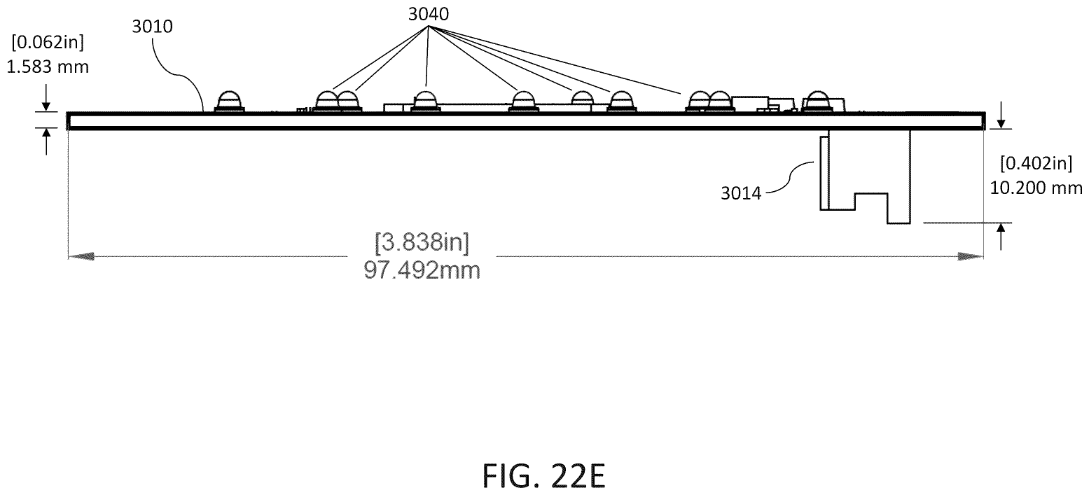

The LED sources 3040 may also have different arrangements. For example, the LED sources 3040 may be arranged to have an “Ax” geometry (see, for example, the dashed lines in FIG. 20C). FIGS. 21A and 21B show another exemplary lighting fixture 1000 with a module 3000B having an inspection light system 30401. The inspection light system 3041 includes LED sources 3040 with a different spatial arrangement compared to the module 3000A. Specifically, FIGS. 22A-22E show the LED sources 3040 may be arranged into two parallel rows (see, for example, the dashed lines in FIG. 22C). The modules 3000A and 3000A are referred to hereafter more generally as the module 3000.

FIGS. 20B and 20D also show the circuit board 3010 may include the connector 3014 to electrically and communicatively couple the module 3000A to the lighting fixture 1000. For example, the connector 3014 may be coupled to one or more of the control circuitry boards (e.g., the control circuitry boards 100, 200, or 300) of the lighting fixture 1000 such that the module 3000A is able to receive electrical power directly from the lighting fixture 1000 and/or signals generated by the lighting fixture 1000 or a control system connected to the lighting fixture 1000 to control the operation of the inspection light system 3041.

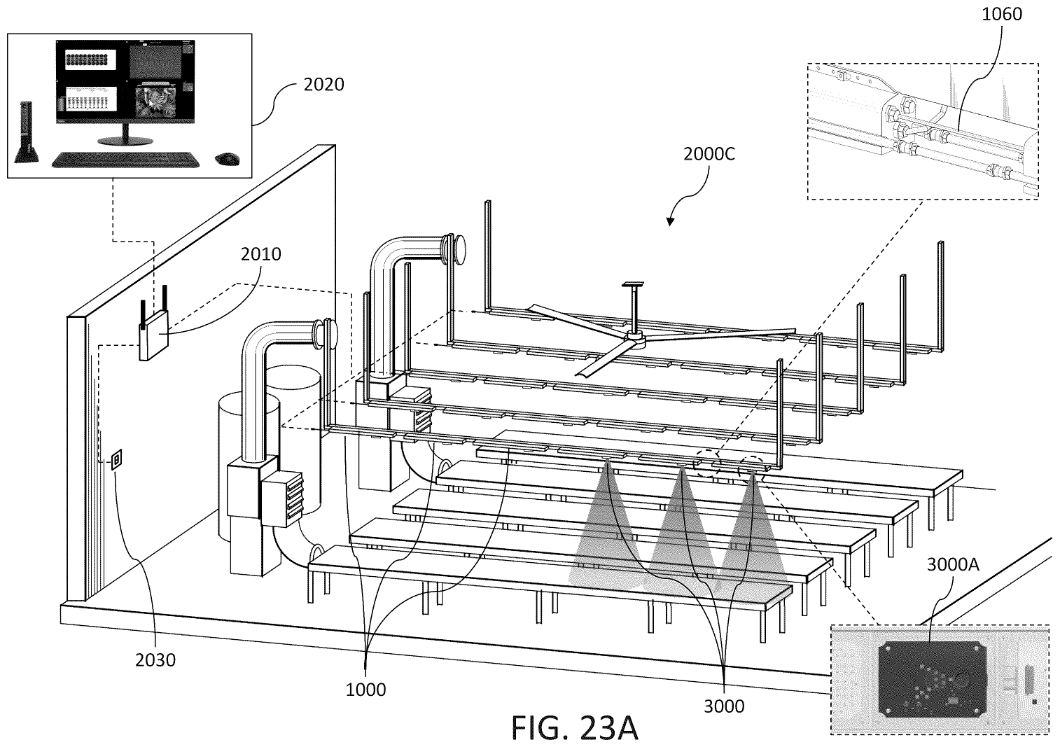

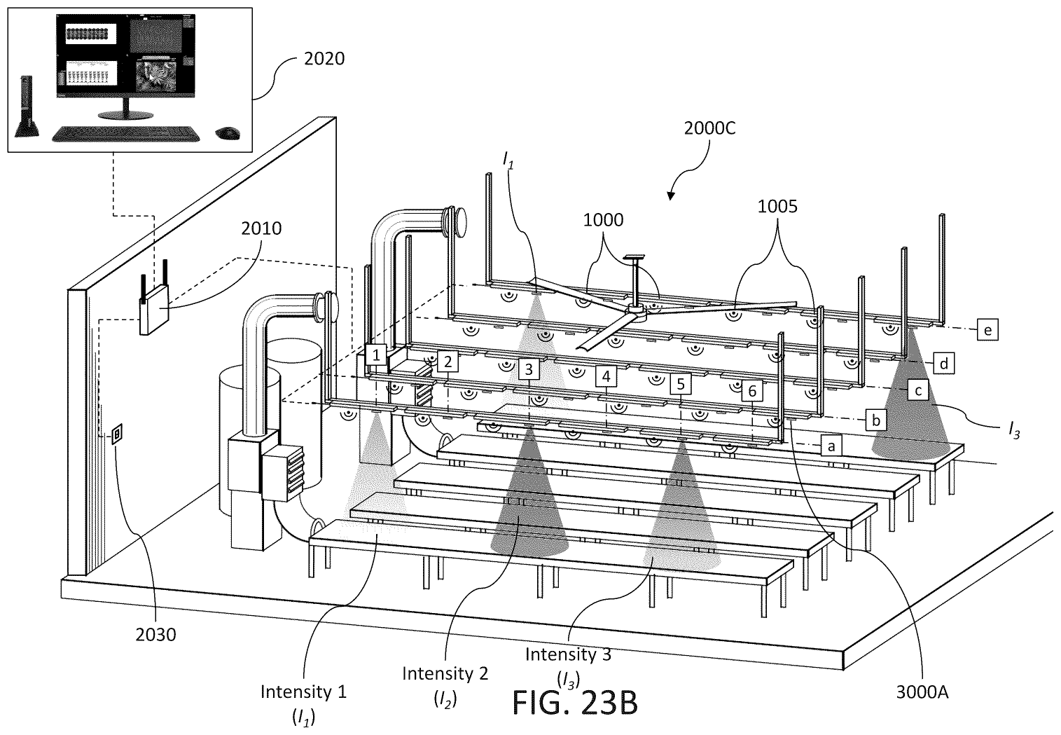

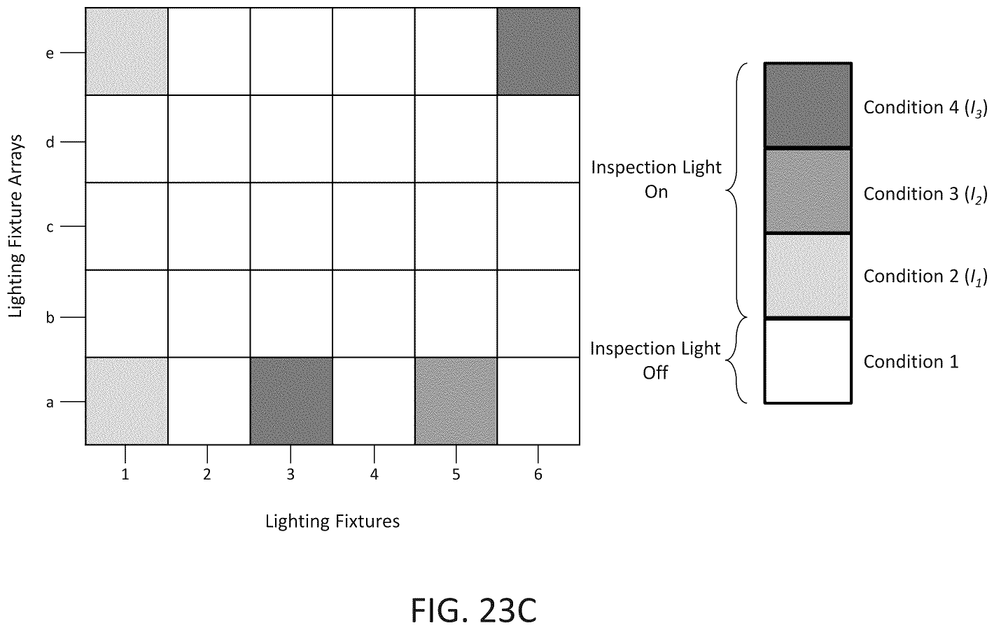

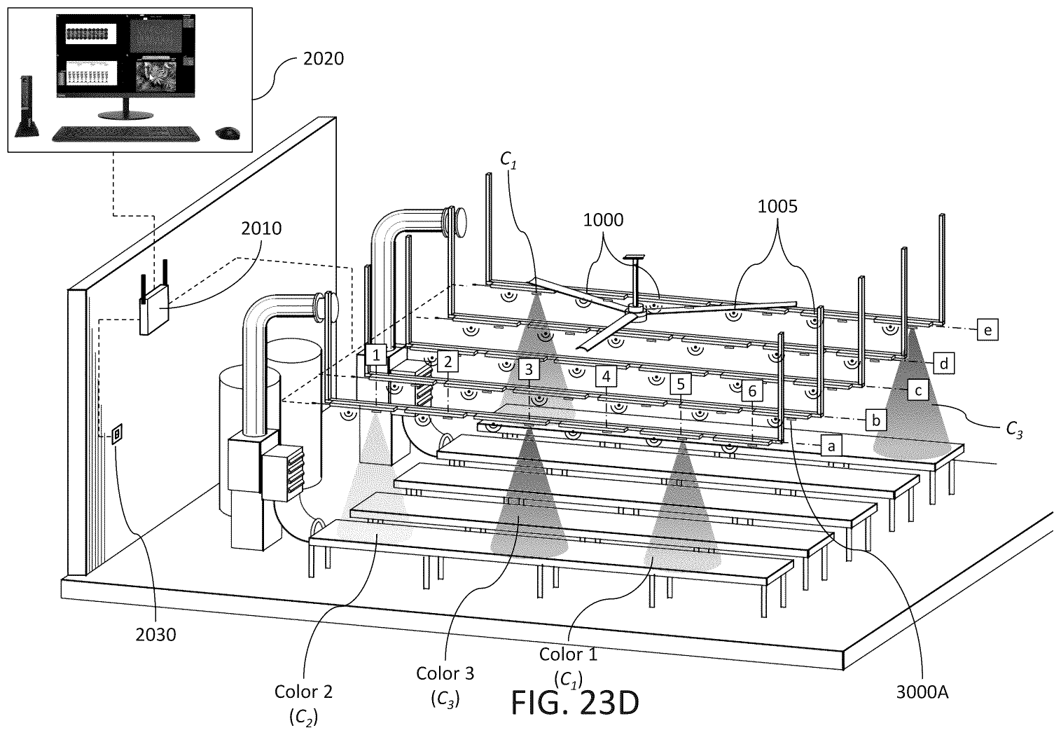

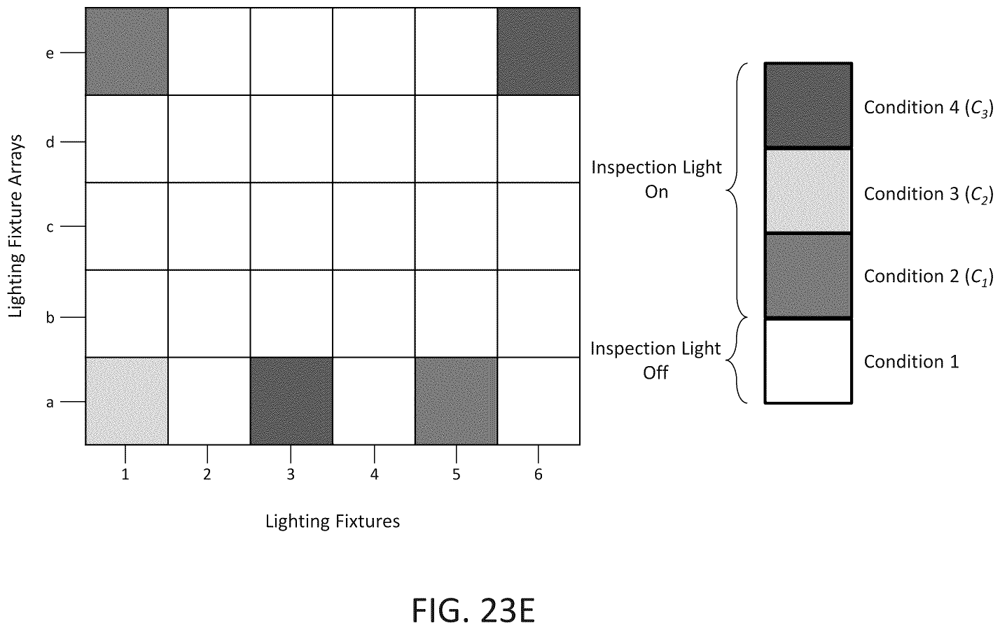

The control system may generally include a network of one or more computing devices that are communicatively coupled to one or more lighting fixtures 1000, one or more modules 3000, and/or one or more cameras/sensors deployed in the grow room. For example, FIG. 23A shows a CEH system 2000C for a single grow room with multiple lighting fixtures 1000 that each include a module 3000 with an inspection light system 3041. As shown, the modules 3000 may be communicatively coupled to a local area network (LAN) via communication cables (e.g., Ethernet cables 1060) that connect the lighting fixtures 1000 together. The lighting fixtures 1000, in turn, may be communicatively coupled to a network router 2010 via additional communication cables or a wireless transmitter.

The control system may further include a local computing device 2020 (e.g., a desktop computer, a tablet device, a smartphone) supporting a human machine interface (HMI). The HMI may allow the grower to monitor and control different aspects of the lighting fixtures 1000 and the modules 3000 as discussed in further detail below. For example, the grower may use a portable device (e.g., a tablet, a smartphone) to adjust the operating parameters of the lighting fixtures 1000 and/or the modules 3000 while the grower is in the grow room. For instance, the grower may adjust the inspection light emitted by one or more modules 3000 while inspecting the plants and/or walking through the grow room. It should be appreciated the CEH system 2000C may also support other computing devices with respective HMIs connected remotely to the LAN via the Internet.

In some implementations, the HMI may provide the grower a set of controls (e.g., a clickable button, a toggle switch, a scrubber bar) to selectively control each module 3000 or a group of modules 3000 (e.g., in a single grow room, across an entire facility with multiple grow rooms). For example, the grower may use a pointing device (e.g., a mouse, a touchpad) and/or a keyboard to select and adjust the operating parameters of specific lighting fixtures 1000 and/or modules 3000 shown on a display screen. For instance, the caregiver may click on a button in the HMI to turn the lighting fixtures 1000 on or off. The HMI may also include a scrubber bar to adjust the output intensity of the inspection light. The HMI may also show a digital representation of the lighting fixtures 1000 and/or the modules 3000 that the caregiver can select to display respective operating parameters (e.g., operating status, output light intensity).

The HMI may control the operation of the inspection light system 3041 in each module 3000 in the same manner as the LED modules 400A-400C on the lighting fixture 1000. For example, once the HMI receives a command from the caregiver (e.g., the caregiver clicks on a button on the HMI), the local computing device 2020 may generate a command signal that is then transmitted to the lighting fixture 1000 and/or the module 3000 to adjust an operating parameter of the lighting fixture or the module 3000. In some implementations, the local computing device 2020 may send signals at regular intervals to update and/or maintain an output intensity emitted by the inspection light system 3041 of each module 3000. If the signals are terminated and/or the module 3000 does not receive the signals, the inspection light system 3041 may turn off.

In some implementations, the CEH system 2000C may also provide the grower a set of physical controls 2030 (e.g., a physical switch, trigger, or button mounted to a wall near the entrance of the grow room as shown in FIG. 23A) to control the operation of each module 3000 in the same manner as the HMI. For example, the physical controls 2030 may allow the grower to turn on or off the LED modules 400A-400C of one or more lighting fixtures 1000 and/or the inspection light systems 3041 of one or more modules 3000 by flipping appropriate switches. In another example, the physical controls 2030 may allow the grower to trigger the modules to produce a flash of light emitted by the inspection light systems 3041 of one or more modules 3000 as discussed in more detail below.

The control system may generally allow the grower to change the operating state of the inspection light system 3041 in the module 3000 via the HMI or the physical controls. The operating states include, but are not limited to, turning the inspection light system 3041 on, turning the inspection light system 3041 off, adjusting the intensity of light emitted by the inspection light system 3041 using the dimmer, and/or generating a flash of light (e.g., a flash of green light) emitted by the inspection light system 3041.

For example, the inspection light system 3041 of the module 3000 may be used to acquire imagery of the plants in the environment. If the CEH system 2000C is in a night cycle, the inspection light system 3041 may be configured to produce a flash of light. In other words, the LED sources 3040 may be turned on and then off after a short period of time (e.g., 1-10 milliseconds). The module 3000 may be further communicatively coupled to one or more cameras deployed near the plants (e.g., a handheld camera, a track-mounted scanning camera, a fixed-point camera, a single point remote sensor, a WiFi camera, a USB camera, a PoE camera). The camera(s) may acquire the imagery of the plants when the inspection LED sources 3040 produce the flash of light. In this manner, the grower may acquire imagery of the plants, which can then be used to evaluate the plants' health and/or development while reducing the exposure of the plants to light to reduce any undesirable effects on the plant's growth cycle. In some implementations, the control system may provide the grower a remote trigger (e.g., a button on the HMI in the local computing device 2020, a physical switch 2030 on the wall outside the grow room), which when activated, causes the inspection light system 3041 in the module 3000 to generate a flash of light and the camera(s) to acquire images of the plants during the flash.

If the CEH system includes multiple modules 3000 deployed across one or more grow rooms within a single facility, the control system may allow the grower to control each module 3000 individually, a subset of the modules 3000 in the facility (e.g., the modules 3000 deployed in a single grow room), or all the modules 3000 together at the same time. For example, the grower may only turn on the inspection light systems 3041 of the modules 3000 in one grow room while keeping the inspection light systems 3041 of other modules 3000 off in other grow rooms to avoid exposing the plants in the other grow rooms to light when the grower is not present. FIG. 23A shows another example where only a few inspection light systems 3041 are turned on within one grow room. For instance, the grower may only want to inspect the plants located in one portion of the grow room. In yet another example, the grower may adjust the intensity of the light emitted by different modules 3000 when the modules 3000 are turned on. For instance, a vertical rack grow system may include different plant species or plants at different stages of development at different levels of the vertical rack. Thus, the grower may adjust the intensity of the light at each rack level according to the species of the plant or the growth stage of the plant to reduce disruptions to the plants' night cycle.

In some implementations, the control system may also provide the grower several options to autonomously control the modules 3000. For example, the control system may allow the grower to schedule when the inspection light systems 3041 of the modules 3000 are turned on (or off) and the duration the inspection light systems 3041 are on (or off). The grower may define a different schedule for each module 3000, a common schedule for a subset of the modules 3000 in the facility (e.g., the modules 3000 deployed in a single grow room), or the same schedule for all the modules 3000 in the facility. For a facility with multiple grow rooms, the grower may schedule the modules 3000 in one grow room to turn the respective inspection light systems 3041 on for a set period of time. Once the time period expires, the modules 3000 of the grow room may turn off the respective inspection light systems 3041 and the modules 3000 in another grow room may then turn on their respective inspection light systems 3041 Additionally, the grower may define an upper limit on the duration the inspection light systems 3041 are kept on during each inspection period (e.g., each day and night cycle may include one or inspection periods) as well as the intensity of the inspection light emitted, which may vary based on the plant species, the growth stage of the plants, and/or the plants' sensitivity to different wavelengths of light.

In another example, the inspection light systems 3041 of the modules 3000 may automatically turn on or off based on measurements from one or more sensors in the grow room (e.g., the sensors/cameras 1005, the sensors 80A-80H). In some implementations, at least one sensor (e.g., a proximity sensor) may be deployed proximate to or on a lighting fixture 1000 (e.g., integrated onto the frame 1004) with a module 3000 to trigger the inspection light system 3041 in the module 3000 to turn on when the grower is near the module 3000 (i.e., within a threshold distance from the sensor). For example, the threshold distance may be less than 5 meters from the lighting fixture, less than 10 meters from the lighting fixture, less than 15 meters from the lighting fixture and/or turn off when the grower is far away from the module 3000 greater than 5 meters from the lighting fixture, greater than 10 meters from the lighting fixture, greater than 15 meters from the lighting fixture. More generally, the threshold distance may range between 5 meters and 10 meters. Thus, the inspection light systems 3041 of the modules 3000 may automatically turn on and off as the grower walks through the grow room. In some implementations, each grow room may have a single sensor to trigger all the inspection light systems 3041 on or off depending on whether the grower enters or exits the grow room (e.g., a sensor may be deployed near the entrance of the grow room). The sensors may generally be any of the sensors described above including, but not limited to, the sensors associated with the lighting fixture 1000 and the multispectral imaging system 1100.

The inspection light may also be used to communicate various conditions to the grower. For example, FIG. 23B shows the CEH system 2000C of FIG. 23A where some of the inspection light system 3041 are turned on to emit inspection light at different intensities (e.g., intensities I₁, I₂, and I₃) according to different conditions (or intervals). FIG. 23C shows a representative heat map of the lighting fixtures 1000 indicating (1) the modules 3000 that have the inspection light system 3041 on or off, (2) the output intensity of the light emitted by the inspection light systems 3041 that are on, and (3) the corresponding conditions (e.g., conditions 1-4). As shown, the array of lighting fixtures 1000 may be indexed according to a particular row (e.g., rows a-e) and a particular location within each row (e.g., fixtures 1-6). In some implementations, the inspection light systems 3041 may also emit different colors (e.g., colors C₁, C₂, and C₃) to communicate different conditions and/or intervals. For example, FIG. 23D shows the inspection light systems 3041 may emit green, yellow, and red light and FIG. 23E shows a corresponding heat map of (1) the modules 3000 that have the inspection light system 3041 on or off, (2) the output color of the light emitted by the inspection light systems 3041 that are on, and (3) the corresponding conditions (e.g., conditions 1-4).

In some implementations, the conditions may be qualitative. For example, the inspection light system 3041 may function as a visual indicator to inform the grower to check the lighting fixture 1000, the module 3000 coupled to the lighting fixture 1000, or the area of the grow room near the lighting fixture 1000 (e.g., the plants illuminated by the lighting fixture 1000). In this manner, the inspection light system 3041 may help the grower identify the specific areas of the grow room to check during an inspection period, which, in turn, may reduce the time to perform an inspection.

For instance, if the lighting fixture 1000 or the module 3000 encounters a problem, the inspection light system 3041 may be turned on (e.g., condition 4) to alert the grower that a problem is present. Otherwise, the inspection light system 3041 may remain off (e.g., condition 1) if, for example, the lighting fixture 1000 and/or the module 3000 are operating normally. The inspection light system 3041 may be turned on when the lighting fixture 1000 or module 3000, for example, loses communication with the control system, the LED modules 400A-400C in the lighting fixture 1000 exceed a threshold temperature (i.e., overheat), or the sensors associated with a particular lighting fixture 1000 detect a problem with the plants in the grow room near the lighting fixture 1000 (e.g., the ambient or leaf temperature is too high or low, the relative humidity is too high or low).

Other qualitative conditions (e.g., conditions 2 and 3) may also be shown by the inspection light systems 3041 and visually distinguished from one another by varying the output intensity, modulating the LED sources 3040 to flash repeatedly at preset intervals, or changing the color of the inspection light emitted by the inspection light system 3041 (e.g., red, yellow, green light). Additional qualitative conditions include, but are not limited to, informing the grower that plants are ready to be harvested and distinguishing the portion of the grow room that has and has not been inspected by the grower during a particular inspection period (e.g., the inspection light systems 3041 turns off once the grower finishes inspection in one area of the grow room).

In some implementations, the conditions may be quantitative. For example, FIG. 23B shows the CEH system 2000C may include multiple sensors 1005 in the grow room. The sensors 1005 may form an array of sensors of the same type that are deployed at or near each lighting fixture 1000 to measure an environmental parameter. Thus, spatial variations in the environmental parameter may be shown visually to the grower by turning on or off the inspection light system 3041 of the module 3000 associated with each lighting fixture 1000 and/or varying the intensity the inspection light. For example, the CEH system 2000C may include an array of ambient temperature sensors. The inspection light system 3041 may turn on when the ambient temperature exceeds a threshold temperature and the intensity and/or the color of the inspection light may be varied to show the relative value of the ambient temperature above the threshold temperature. In other words, conditions 1-4 may represent intervals of progressively higher ambient temperatures. Thus, the inspection light systems 3041 emitting the most intense light and/or a particular color (e.g., red light) may provide a visual indication to the grower which areas of the grow room have the highest ambient temperatures.

More generally, each of the inspection light systems 3041 may be turned on to communicate the relative values of an environmental parameter to the grower and the intensity of the light emitted by each inspection light system 3041 may be varied according to relative values of the ‘On’ conditions (e.g., conditions/intervals 2-4). The number of conditions and/or intervals may also vary depending, in part, on the number of different messages to convey to the grower and/or the desired resolution of the data being displayed (e.g., the resolution of the ambient temperature). Generally, the intensity and/or the color of the inspection light emitted may be varied according to two or more conditions and/or intervals. In some implementations, the intensity and/or the color of the emitted inspection light may be varied according to 10 or more conditions/intervals, 100 or more conditions/intervals, or 1000 or more conditions/intervals. It should also be appreciated the spatial variation of other environmental parameters may be shown in a similar manner, such as variations in air speed, CO₂ concentrations, relative humidity, leaf temperature. In some implementations, the grower may also toggle the inspection light systems 3041 to show different qualitative and quantitative conditions by using the HMI or the physical controls described above.

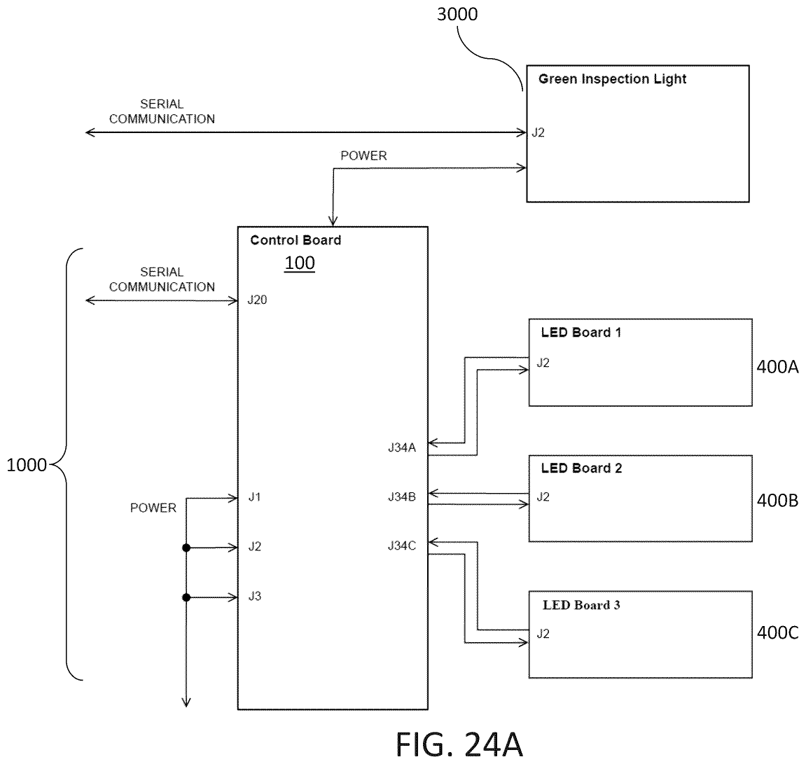

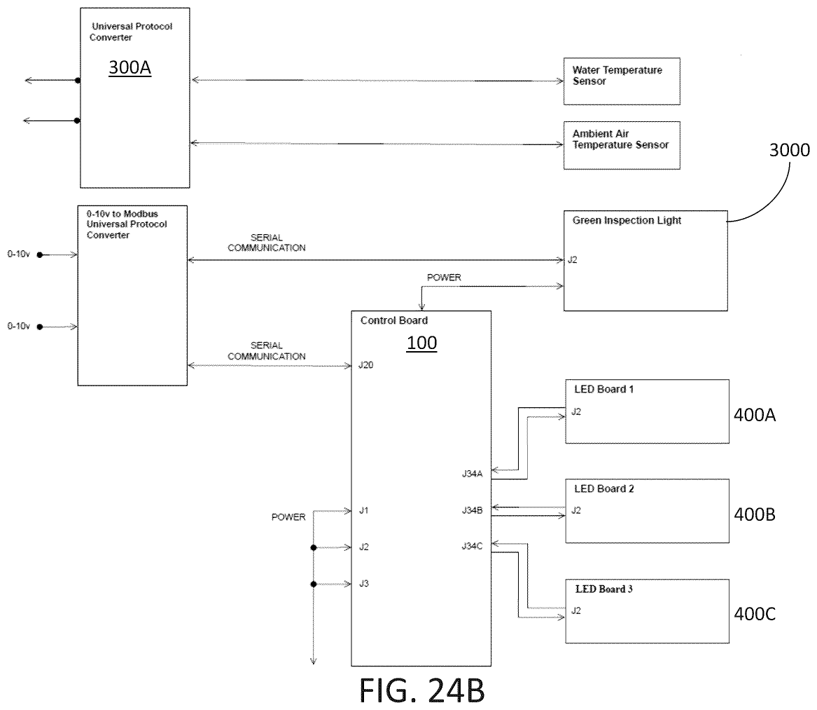

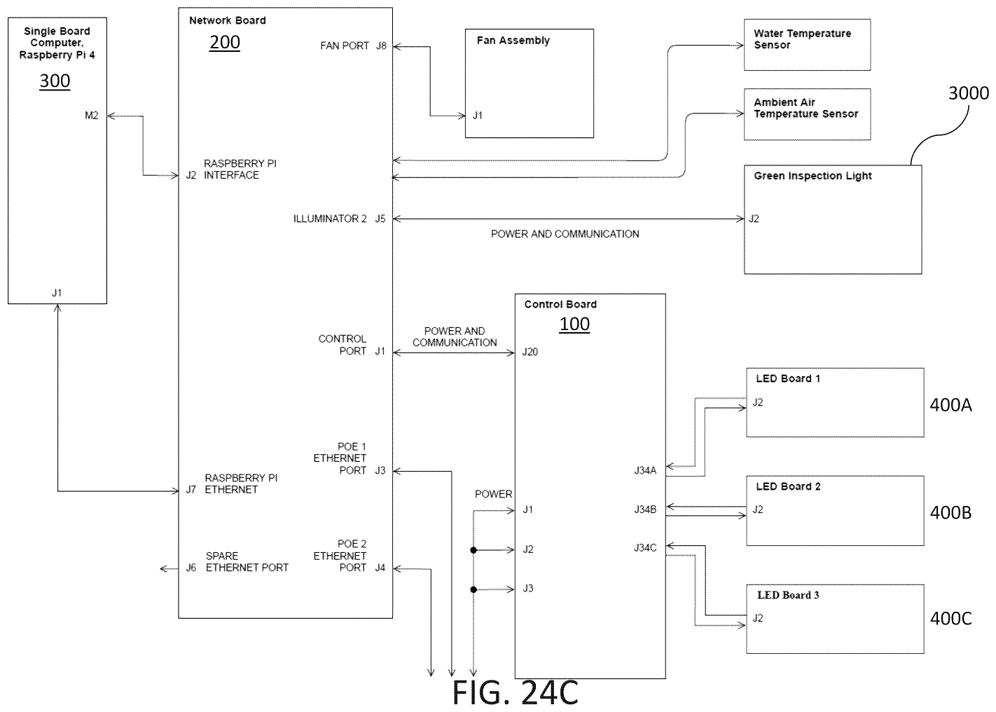

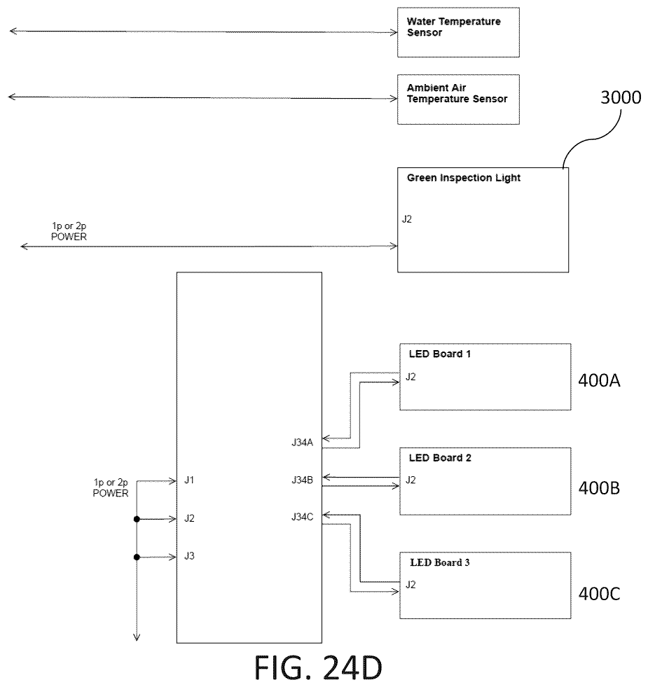

FIG. 24A shows an exemplary system block diagram of the lighting fixture 1000 and the module 3000. In some implementations, the lighting fixture 1000 may include an onboard control board 100 to receive electrical power from an external power source (e.g., AC power from the building mains) and data communication signals from one or more single board computers (not shown) that manage and control the operation of the various components of the lighting fixture 1000 (e.g., the LED modules 400A-400C). In some implementations, the single board computer may be onboard the lighting fixture 1000. In some implementations, the single board computer may form part of a control system that is physically separate from the lighting fixture 1000. The lighting fixture 1000 may also include one or more LED modules 400A-400C that each have a separate LED board (e.g., LED boards 1-3) to support one or more LEDs. As shown, the control board 100 may provide both electrical power (e.g., DC power) and data communication signals to each of the LED modules 400A-400C during operation.

FIG. 24A also shows the module 3000, when installed onto the lighting fixture 1000, may receive electrical power from the control board 100. In some implementations, the module 3000 may receive data communication signals directly from the single board computer(s) controlling the LED modules 400A-400C. For example, FIG. 24B shows one exemplary implementation that includes a single board computer 300A disposed onboard or offboard the lighting fixture 1000 and communicatively coupled to the control board 100 and the module 3000. As shown, the single board computer 300A may be a Universal Protocol Converter (UPC). The UPC may generally receive an analog signal (e.g., 0-10V input) and output a digital signal (e.g., I²C signals) to the control board 100 and/or the module 3000. It should be appreciated that, in some implementations, the module 3000 may receive data communication signals from a separate, dedicated single board computer that is not communicatively coupled to the control board 100 or the LED modules 400A-400C (see FIG. 24D).

FIG. 24C shows another exemplary implementation where the lighting fixture 1000 includes an onboard single board computer 300 (e.g., a Raspberry Pi 4) and a network board 200. As shown, the single board computer 300 may be electrically coupled to the network board 200. The network board 200, in turn, may be electrically coupled to various components of the lighting fixture 1000 including, but not limited to, the module 3000, the control board 100, other auxiliary devices (e.g., an onboard fan for cooling), and an external control system via a communication port (e.g., an Ethernet port). As shown, the control board 100 may receive electrical power from an external power source as described above. The control board 100 may transmit electrical power to the network board 200 in addition to receiving data communication signals from the network board 200. The network board 200, in turn, may provide electrical power (e.g., DC power) to the single board computer 300, the module 3000, and/or other auxiliary devices (e.g., the fan). In this manner, the network board 200 may transmit both electrical power and data communication signals. It should be appreciated that, in some implementations, the single board computer 300 may be offboard the lighting fixture 1000; thus, data communication signals from the single board computer 300 may be transmitted to the network board 200 via one or more of the communication ports.

In some implementations, the module 3000 may be electrically coupled to the network board 200 via a cable when installed onto the lighting fixture 1000. Thus, the cable may carry both electrical power (e.g., DC power) originating from the control board 100 and data communication signals (e.g., I²C signals) originating from the single board computer 300 to facilitate operation of the module 3000. For the module 3000, the data communication signals may be various signals including, but not limited to, instructions to adjust the operating state of the LED sources 3040 of the inspection light system 3041 as described above and data response from various components of the module 3000 (e.g., onboard sensors, operating status of the module 3000).

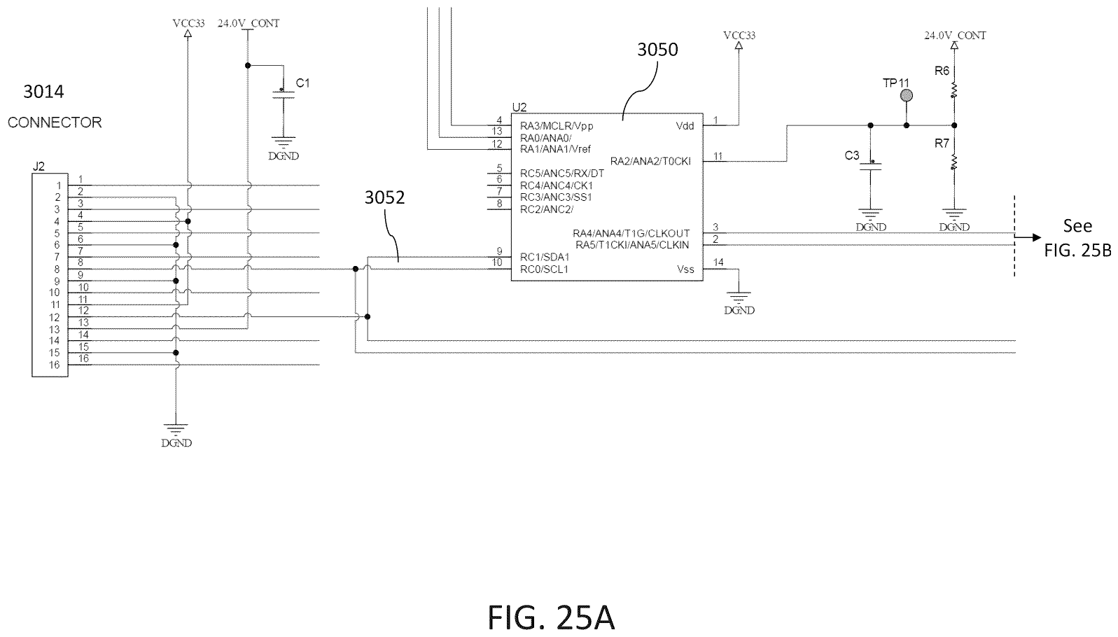

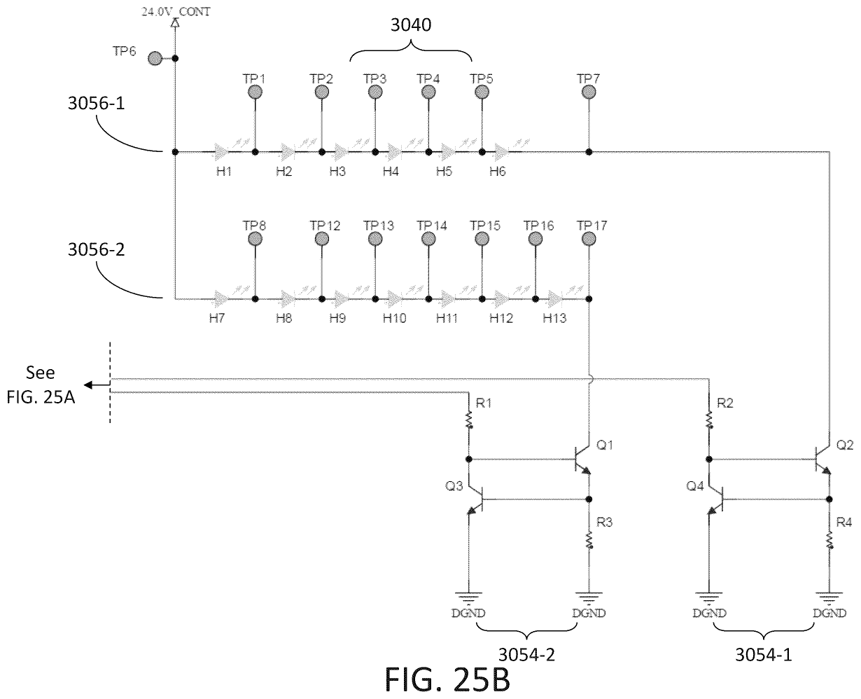

FIGS. 25A and 25B show an exemplary circuit diagram for the module 3000 with circuitry related specifically to the operation of the LED sources 3040 of the inspection light system 3041. As shown, the module 3000 may transmit and/or receive multiple data communication signals from the network board 200 (e.g., via the cable) including, but not limited to, I²C signals 3052 (e.g., a data signal, a clock signal). The module 3000 may also include a processor 3050 to receive the I²C signals 3052 and, in turn, relay the control signals originating from the single board computer 300 to the LED sources 3040 of the inspection light system 3041.

Specifically, FIG. 25B shows the module 3000 may include a pair of channels 3056-1 and 3056-2 that each include multiple LED sources 3040. The channels 3056-1 and 3056-2 may further include respective current mirrors 3054-1 and 3054-2 (i.e., a pair of transistors) to regulate the current input for the LED sources 3040 in each channel. The LED sources 3040 in each channel may be collectively turned on or off and/or dimmed to the same light output. As shown in FIG. 25B, the module 3000 may include two channels. Thus, in some implementations, the light output from the module 3000 may vary from 0% (no LEDs turned on), 50% (one channel of LEDs is turned on), or 100% (both channels of LEDs are turned on). More generally, the intensity of the combined light output from the LED sources 3040 may be varied 0% to 100% as described above.

It should be appreciated the module 3000, in some implementations, may include one channel or three or more channels of LED sources 3040. In some implementations, the LED sources 3040 in each channel may be identical and/or configured to receive the same voltage and/or current for operation. In some implementations, the LED sources 3040 in different channels may correspond to different types of LED sources 3040 differentiated, for example, by the light output (e.g., high power LEDs, low power LEDs) and/or the color or wavelength of emitted light. For example, the module 3000 may include multiple channels where each channel includes LED sources 3040 that emit light at the same or similar wavelengths (e.g., +/−5% of the nominal wavelength). In implementations where the lighting fixture 1000 is configured to receive analog inputs to control the module 3000 (see, for example, the UPC 300A in FIG. 24B), each channel of LED sources 3040 may have a corresponding 0-10 V input. In other words, each 0-10 V input to the UPC 300A may control the output intensity of the inspection light at one wavelength or a narrowband of wavelengths corresponding to a particular color (e.g., green, yellow, red).

### CONCLUSION

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

The above-described embodiments can be implemented in multiple ways. For example, embodiments may be implemented using hardware, software or a combination thereof. When implemented in software, the software code can be executed on a suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in a suitable form, including a local area network or a wide area network, such as an enterprise network, an intelligent network (IN) or the Internet. Such networks may be based on a suitable technology, may operate according to a suitable protocol, and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Some implementations may specifically employ one or more of a particular operating system or platform and a particular programming language and/or scripting tool to facilitate execution.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An LED-based lighting fixture for Controlled Environment Horticulture (CEH) of one or more plants having respective day cycles and respective night cycles, the lighting fixture comprising:
a frame;
a first LED source, mechanically supported by the frame, configured to emit photosynthetically active radiation (PAR) towards the one or more plants;
a second LED source, mechanically supported by the frame, configured to emit inspection light towards the one or more plants to facilitate inspection of the one or more plants; and
control circuitry, mechanically supported by the frame, to receive AC power and supply DC power to at least the first and second LED sources,
wherein:
the first LED source is deactivated during the respective night cycles of the one or more plants;
the second LED source is activated to emit the inspection light only when the first LED source is deactivated;
the first LED source emits the PAR at a first intensity and the second LED source emits the inspection light at a second intensity less than the first intensity so as not to disrupt the respective night cycles of the one or more plants; and
the second intensity varies depending on a wavelength of the inspection light.

2. The lighting fixture of claim 1, wherein the second LED source is independently controllable with respect to the first LED source.

3. The lighting fixture of claim 1, wherein the second LED source is disposed within a housing that separates the second LED source from the first LED source, the housing being mechanically coupled to the frame.

4. The lighting fixture of claim 1, wherein:
the second LED source is communicatively coupled to a remote trigger;
when the remote trigger is activated, the second LED source emits a flash of light to illuminate the one or more plants; and
the lighting fixture further comprises:
a camera, communicatively coupled to the control circuitry, configured to acquire imagery of the one or more plants when the remote trigger is activated.

5. (canceled)

6. The lighting fixture of claim 1, wherein:
the frame is formed of aluminum and includes a channel formed therein;
the lighting fixture further comprises:
a coolant pipe, disposed in the channel of the frame to establish a thermal connection between the coolant pipe and the frame, to carry a fluid coolant to extract heat generated by at least one of the first LED source or the second LED source during operation of the lighting fixture; and
the coolant pipe is formed of copper and press-fit into the channel of the frame.

7. (canceled)

8. The lighting fixture of claim 1, wherein the first LED source emits the PAR at a first photosynthetic photon flux (PPF) and the second LED source emits the inspection light at a second PPF, the first PPF being greater than the second PPF by a factor greater than or equal to 100.

9. The lighting fixture of claim 1, wherein the second LED source emits the inspection light at a photosynthetic photon flux (PPF) equal to or less than approximately 7 μmol per second.

10. The lighting fixture of claim 1, wherein:
the second LED source comprises a plurality of LEDs, each LED of the plurality of LEDs being independently controllable from another LED of the plurality of LEDs; and
the plurality of LEDs comprises:
a first LED that emits first light at a first wavelength; and
a second LED that emits second light at second wavelength different from the first wavelength, the inspection light comprising the first light and the second light.

11. (canceled)

12. The lighting fixture of claim 1, wherein the wavelength of the inspection light ranges between at least one of:
310 nm and 400 nm;
500 nm and 550 nm; or
720 nm and 740 nm.

13. (canceled)

14. (canceled)

15. (canceled)

16. (canceled)

17. The lighting fixture of claim 1, wherein the inspection light is white light.

18. A lighting system, comprising:
the lighting fixture of claim 1; and
a sensor, communicatively coupled to the control circuitry of the lighting fixture and disposed proximate to the second LED source of the lighting fixture, configured to detect a person within a threshold distance from the lighting fixture,
wherein:
the second LED source is activated and emits the inspection light when the sensor detects the person is within the threshold distance;
the second LED source is deactivated when the sensor does not detect the person is within the threshold distance; and
the threshold distance ranges between 5 meters and 15 meters.

19. (canceled)

20. (canceled)

21. A lighting system, comprising:
a plurality of lighting fixtures, each lighting fixture of the plurality of lighting fixtures corresponding to the lighting fixture of claim 1; and
a plurality of sensors to respectively measure at least one environmental parameter, each sensor of the plurality of sensors being disposed proximate to one lighting fixture of the plurality of lighting fixtures and communicatively coupled to the control circuitry of the one lighting fixture,
wherein for each one lighting fixture of the plurality of lighting fixtures, at least one of the second intensity or the wavelength of the inspection light emitted by the second LED source is dependent on a value of the at least one environmental parameter measured by a corresponding sensor communicatively coupled to the one lighting fixture.

22. The lighting system of claim 21, wherein the at least one environmental parameter is one of an ambient temperature, an air speed, a CO₂ concentration, a relative humidity, or a leaf temperature.

23. An LED-based lighting fixture for Controlled Environment Horticulture (CEH) of one or more plants, the lighting fixture comprising:
a frame;
a first LED source, mechanically supported by the frame, configured to emit photosynthetically active radiation (PAR) towards the one or more plants;
a second LED source, mechanically supported by the frame, configured to emit inspection light towards the one or more plants to facilitate inspection of the one or more plants, the inspection light having a first photosynthetic photon flux (PPF) equal to or less than approximately 7 μmol per second; and
control circuitry, mechanically supported by the frame, to receive AC power and supply DC power to at least the first LED source and the second LED source.

24. The lighting fixture of claim 23, wherein:
the first LED source is deactivated during respective night cycles of the one or more plants; and
the second LED source is activated to emit the inspection light only when the first LED source is deactivated.

25. (canceled)

26. (canceled)

27. A lighting system, comprising:
the lighting fixture of claim 23; and
a sensor, communicatively coupled to the control circuitry of the lighting fixture and disposed proximate to the second LED source of the lighting fixture, configured to detect a person near the lighting fixture,
wherein:
the second LED source is activated and emits the inspection light when the sensor detects the person is near the lighting fixture; and
the second LED source is deactivated when the sensor does not detect the person is near the lighting fixture.

28. (canceled)

29. (canceled)

30. An LED-based lighting fixture for Controlled Environment Horticulture (CEH) in a grow room, the lighting fixture comprising:
a frame;
a first LED source, mechanically supported by the frame, to illuminate a plant with photosynthetically active radiation (PAR);
a second LED source, mechanically supported by the frame, to illuminate the plant with light for inspection of the plant;
control circuitry, mechanically supported by the frame, to receive AC power and to control the first LED source and the second LED source; and
a sensor, communicatively coupled to the control circuitry and disposed proximate to the second LED source, configured to detect a person within a threshold distance from the lighting fixture,
wherein the second LED source is turned on to illuminate the plant with the light for inspection of the plant when the person is detected within the threshold distance.

31. The lighting fixture of claim 30, wherein;
the second LED source is turned off when the sensor does not detect the person is within the threshold distance; and
the threshold distance ranges between 5 meters and 15 meters.

32. (canceled)

33. The lighting fixture of claim 30, wherein:
the first LED source is turned off during a night cycle of the plant; and
the second LED source is turned on to emit the light for inspection of the plant only when the first LED source is off.

34. The lighting fixture of claim 30, wherein the first LED source emits the PAR at a first photosynthetic photon flux (PPF) and the second LED source emits the inspection light at a second PPF less than the first PPF so as not to disrupt a night cycle of the plant.

35. (canceled)

36. (canceled)
